(19) United States
(12) Patent Application Publication
(10) Pub. No.: US 2006/0230579 A1
(43) Pub. Date: Oct. 19, 2006

(54) Hinge assembly and a portable terminal having the same

(76) Inventors: Ho-Seong Ko, Gyeonggi-do (KR); Yoong-Yeul Kim, Incheon (KR); Si-Wan Kim, Gyeonggi-do (KR); Byung-Kyu Son, Seoul (KR)

Correspondence Address: RATNERPRESTIA, P O BOX 980, VALLEY FORGE, PA, 19482-0980, US

(21) Appl. No.: 10/548,285

(22) PCT Filed: Dec. 12, 2003
(86) PCT No.: PCT/KR03/02724

§ 371 Date: Jun. 23, 2006

(30) Foreign Application Priority Data
Mar. 3, 2003 (KR) 10-2003-00113033
Mar. 13, 2003 (KR) 20-2003-007515
Apr. 12, 2003 (KR) 10-2003-0023176
Jun. 7, 2003 (KR) 10-2003-0036577
Jul. 18, 2003 (KR) 10-20030049350
Aug. 8, 2003 (KR) 10-2003-0054875
Aug. 28, 2003 (KR) 10-2003-0059843

(51) Int. Cl. E05D 11/10

(52) U.S. Cl. 16/330

(57) ABSTRACT

Disclosed hinge assemblies and portable terminals having the same. According to a first embodiment of the present invention, a hinge assembly, a first member is fixed to a side of one article so as to support the one article to horizontally rotate with respect to the other article. A second member is fixed to a side of the other article and engaged with the first member in order to support the other article so that the one article can rotate with respect to the other article. A third member provides the second member with elasticity in order for the first member is tightly engaged with the second member.

### TECHNICAL FIELD

The present invention relates to a hinge assembly and a portable terminal having the same, and more particularly to a hinge assembly capable of coupling separate articles together and rotating or pivoting one article against the other article, and to portable terminal capable of rotating or pivoting a folder or a flip against a main body with the aid of the hinge assembly mounted thereto such as a cellular phone, a PCS phone or a PDA.

### BACKGROUND ART

Generally, it is well known that a hinge assembly is adapted to couple separate articles together and to rotate or pivot one article against the other article. Thus the hinge device has been used in the electric home appliances such as a refrigerator, in the office machine such as a duplicator, in the computer appliances such as a notebook monitor and a LCD monitor, in the telecommunication appliances such as a PCS phone and a PDA.

Recently, the cellular phone, the PCS phone or the PDA has been miniaturized and therefore a folder-type terminal having a folder, which can be open or closed, has come into wide use with the object to protect a keypad and a display of them.

A hinge device for further miniaturizing the portable terminal and the portable terminal by using the same are described in, for example, copending, commonly assigned, U.S. Laid-Open Patent Publication No. 2003/0162509 A1 by Jong-keun BAE and Seong-seon PARK, filed on Nov. 4, 2002, and laid-open published on Aug. 28, 2003, the entire disclosure of which is incorporated by reference herein.

FIG. 1 is an exploded view of the hinge device according to the U.S. Laid-Open Patent Publication as described above, and FIG. 2 is a partial sectional view of the portable terminal having the hinge device shown in FIG. 1 mounted thereto.

As shown in FIGS. 1 and 2, the hinge device 10 according to the U.S. Laid-Open Patent Publication as described above includes a cylindrical housing 12 having an open end 12a, a close end 12b and a suspended block 12c; a hinge shaft 14 having a disc 14a and a block 14b protruding from the disc 14a and being arranged according to the hinge axis; a hinge cam 16 being disposed outside the hinge housing 12 and having a compressed block 16a disposed according to the hinge axis opposing to the block 14b of the hinge shaft 14; and a compressed coil spring 18 for pressing the hinge shaft 14 against the hinge cam 16, the coil spring 18 being disposed between the close end 12b of the hinge housing 12 and the disc 14a of the hinge shaft 14.

The hinge device 10 having the housing 12, the hinge shaft 14, the hinge cam 16 and the coil spring 18 is fixed by inserting a guide pin 20 through individual elements and into a portable terminal 30.

The suspended block 1c protrudes from the peripheral surface of the hinge housing 12 and then longitudinally extends between the open end 12a and the close end 12b of the hinge housing 12.

The disc 14a is disposed in the hinge housing 12. The block 14b protrudes through the open end 12a of the hinge housing 12.

In the hinge device according to the U.S. Laid-Open Patent Publication as described above, the spring is easily compressed so that it is possible to reduce a space required for assembling the hinge device.

In addition, when the hinge housing has been assembled with the folder of the portable terminal, the hinge cam is combined to the main body of the fordable portable terminal. If the hinge housing is engaged with the folder and the hinge cam is coupled to the main body, there is no need for setting the hinge axis of the hinge cam for coupling the hinge cam to the main body.

Accordingly, it is possible to miniaturize the hinge device and the portable terminal employing the same.

However, there is a problem in that the folder cannot be horizontally rotated with respect to the main body.

### DISCLOSURE OF INVENTION

The present invention is contrived to overcome above-described problem.

It is a first object of the present invention to provide a hinge assembly capable of coupling articles and horizontally rotating the articles with each other.

It is a second object of the present invention to provide a hinge assembly capable of coupling articles and horizontally freely rotating one article against the other article with centering on a longitudinal axis of the other article.

It is a third object of the present invention to provide a portable terminal, which has a hinge assembly capable of coupling a main body with a folder and horizontally rotating the folder with respect to the main body.

It is a fourth object of the present invention to provide a portable terminal, which has a hinge assembly capable of coupling a main body with a folder and horizontally freely rotating the folder with respect to the main body centering on a longitudinal axis of the folder.

It is a fifth object of the present invention to provide a portable terminal, which has a hinge assembly capable of horizontally rotating a display of the folder with respect to the folder.

To achieve the first object, there is provided a hinge assembly according to a first aspect of the present invention comprises:

a first means for horizontally rotating a second article with respect to a first article, the first means being coupled with an end of the first article;

a second means for horizontally rotating the first article with respect to the second article, the second means being coupled with an end of the second article and engaged with the first means; and

a third means providing the second means with an elastic force so that the first means is firmly engaged with the second means.

According to the first aspect of the present invention, the hinge assembly further comprises a housing being inserted into a side of the other article for receiving the second member and the third member.

The first member includes a cylindrical hinge shaft, on the outer peripheral surface of which projections are formed opposing each other.

The second member includes a cylindrical cam, on the outer peripheral surface of which projections are formed longitudinally opposing each other.

The third member is a coil spring.

The housing includes a guide recess for receiving the projection of the cylindrical cam so that the cylindrical cam can be moved glidingly along an axis of the housing.

The cam and the coil spring are disposed on the outer peripheral surface of the cylindrical hinge shaft, and the cylindrical hinge shaft having the cam and the coil spring extends through the housing for the cam to be moved glidingly.

An end of the cylindrical hinge shaft has an annular ring for supporting the coil spring and a snap ring for preventing the coil spring and the annular ring from deviating from the hinge shaft.

A stopper for limiting the rotation of the cylindrical hinge shaft is movably installed at an end of the housing.

To achieve the second object, there is provided a hinge assembly according to a second aspect of the present invention comprises:

a first means for supporting a folder, the first means being mounted to the main body so that it can rotate against one surface of the main body in the horizontal direction; and

a second means for rotating the folder against the main body with centering on an axial line that is perpendicular to a rotational axis of the first means mounted to the main body, the second member being mounted to the folder so that it can rotate with centering on the axial line that is perpendicular to the rotational axis of the first means.

The first means includes a cylindrical rotation body of which hollow projections are formed opposite with each other at an outer peripheral surface of the rotation body, in which the second means is rotatably coupled to one projection among the projections.

The second means comprises a housing, a driving cam arranged inside of the housing, which its one end is firmly coupled with the hollow projection of the main body, a driven cam, which is arranged inside of the housing, and engaged with the driving cam, pluralities balls disposed between the driving cam and the driven cam so as to make the driving cam to rotate against the driven cam, at least coil springs for elastically supporting the driven cam within the housing, and a cover for preventing the above elements from being obviated from the housing.

The pluralities balls are fixedly and attached to the driven cam.

A semi-sphere shaped groove having a radius of curvature that is corresponding to a rounded surface of the balls attached to the driven cam.

To achieve the third object, there is provided a portable terminal according to another aspect of the present invention comprises:

a main body mounted with a key pad, a mike phone and a battery;

a folder mounted to be rotatable with respect to the main body horizontally and vertically and having a speaker phone and a display panel; and

a hinge assembly to rotate the folder with respect to the main body horizontally and vertically, the hinge assembly.

The hinge assembly includes a first means for horizontally rotating a folder against a main body, the first means being engaged with a one side of the folder; a second means for rotatably supporting the folder against the main body by engaging with the first means, the second means being engaged with a one side of the main body; and a third means for providing the second means with an elastic force so that the first means is firmly engaged with the second means.

The portable terminal further comprises a housing for receiving the first and the third means, the housing being inserted into the one side of the main body.

The first means includes a cylindrical hinge shaft of which projections are formed at an outer peripheral surface of the hinge shaft with opposing with each other.

The second means includes a cylindrical cam of which projections are formed at an outer peripheral surface of the cylindrical cam with opposing with each other in the longitudinal direction.

The third means comprises a coil spring. Guide grooves for receiving the cylindrical projections are formed at an inner peripheral surface of the housing so that the cylindrical projections can slideably move along the axis line of the housing.

The cam and the coil spring are disposed at the outer peripheral surface of the cylindrical hinge shaft, in which the cylindrical hinge shaft having the cam and the coil spring passes through the housing so that the cam is slideably disposed therein.

An annular ring for supporting the coil spring and a snap ring for preventing the coil spring and the annular ring from deviating from the hinge shaft are mounted to a end of the cylindrical hinge shaft.

A stopper for restraining the rotation of the cylindrical hinge shaft is moveably installed at one end of the housing.

To achieve the fourth object, there is provided a portable terminal according to another aspect of the present invention comprises:

a main body mounted with a key pad, a mike phone and a battery;

a folder mounted to be rotatable with respect to the main body horizontally and vertically and having a speaker phone and a display panel; and

a hinge assembly to rotate the folder with respect to the main body horizontally and vertically, the hinge assembly.

The hinge assembly includes a first means for supporting a folder, the first means being mounted to the main body so that it can rotate against one surface of the main body in the horizontal direction; and a second means for rotating the folder against the main body with centering on an axial line that is perpendicular to a rotational axis of the first means mounted to the main body, the second means being mounted to the folder so that it can rotate with centering on the axial line that is perpendicular to the rotational axis of the first means.

The first means includes a fist hinge and a coupling member coupled with the first hinge to connect the main body to the folder.

The first hinge includes a housing, a plurality of elastic members accommodated by the housing, a cam disc disposed inside of the housing to be moved glidingly inside of the housing, and a hinge shaft fixed to the one article and extending through the cam disc, the elastic member, and the housing, a driving cam being formed at the hinge shaft.

The coupling member has a cylindrical shape of which one end is closed, in which projections for coupling the main body with the folder by being inserted into the folder are formed at an outer peripheral surface of the coupling member.

The coupling member is engaged with the housing of the first hinge by means of the screw.

The elastic member of the fist hinge includes a first coil spring, a second coil spring and a third coil spring.

The diameter of the second coil spring is smaller than that of the fist coil spring and the diameter of the second coil spring is greater than that of the third coil spring.

The second means comprises a second hinge, in which the second hinge includes a housing, which is mounted to the folder, a driving cam, which is arranged inside of the housing, which its one end is firmly coupled with one of the projections of the coupling member and it's the other end is provided with a cam, a driven cam, which is arranged inside of the housing and engaged with the driving cam, and at least one elastic members for elastically supporting the driven cam within the housing, the elastic members being disposed between the driving cam and one wall of the housing.

To achieve the fourth object, there is provided a portable terminal according to another aspect of the present invention comprises:

a main body mounted with a key pad, a mike phone and a battery;

a folder for horizontally rotatably supporting a display panel, the folder being rotatably mounted to the main body;

a first hinge assembly to rotate the folder with respect to the main body; and

a second hinge assembly for coupling the display panel to the folder, and for horizontally rotatably supporting the display panel with respect to the folder.

The hinge assembly includes a housing mounted to the folder, a driving cam disposed inside of the housing and having one end firmly fixed to the main body and the other end with a cam, a driven cam disposed inside of the housing and engaged with the driving cam, and one or more elastic member disposed between the driven cam and one wall of the housing in the housing and supporting the driven cam elastically.

The elastic member comprises a coil spring.

The second hinge assembly includes a first means for horizontally rotating a display panel against a folder, the first means being engaged with a one side of the folder; a second means for rotatably supporting the display panel against the folder by engaging with the first means, the second means being engaged with the display panel; and a third means for providing the second means with an elastic force so that the first means is firmly engaged with the second means.

The first means includes the driving cam having a circular plate shaped body and a cylindrical shaft vertically extending from one surface of the main body.

The second means includes a circular plate shape driven cam and a fixing shaft fixedly coupled to the display panel, in which the fixing shaft passes through the driven cam and is threadly engaged with the cylindrical shaft of the driving cam, and the driven cam is mounted to the with the cylindrical shaft of the driving cam so that it is opposing to the circular plate shape body of the driving cam.

The portable terminal further comprises pluralities balls for pushing the driven cam to a distance with the respect to the driving cam, the pluralities balls being disposed between the driving cam and the driven cam.

The portable terminal further comprises pluralities elastic members for elastically the driven cam with respect to the display panel.

The pluralities elastic members comprise disc spring.

A stopper for restraining the rotation of the driven cam is formed at one end adjacent to the cylindrical shaft contacted with the main body of the driving am.

A guide groove for receiving the stopper is formed at one surface of the driven cam so that the stopper formed at the cylindrical shaft of the driving cam can slideably move along the guide groove.

### BRIEF DESCRIPTION OF DRAWINGS

Other features and advantages of the present invention will become more apparent from the following description taken in connection with the accompanying drawings, wherein:

FIG. 1 is an exploded perspective view of a hinge device according to the conventional art;

FIG. 2 is a partial sectional view of a portable terminal on which the hinge device according to the conventional art, shown in FIG. 1 is mounted;

FIG. 3 is an exploded perspective view of a hinge assembly according to a first embodiment of the present invention;

FIG. 4 is a perspective view of a housing of the hinge assembly according to a first embodiment of the present invention;

FIG. 5 is a perspective view of a hinge shaft of the hinge assembly according to the first embodiment of the present invention, for showing one of projections having a function as a cam;

FIG. 6 is a perspective view of a hinge shaft of the hinge assembly according to the first embodiment of the present invention, for showing the other of projections having a function as a cam;

FIG. 7 is a front view of a cylindrical cam of the hinge assembly according to the first embodiment of the present invention;

FIG. 8 is a rear view of the cylindrical cam of the hinge assembly according to the first embodiment of the present invention;

FIG. 9 is a sectional view the cylindrical cam of the hinge assembly according to the first embodiment of the present invention, taken along line A-A′ of the FIG. 7;

FIG. 10 is an exploded perspective view of a portable terminal on which the hinge assembly according to the first embodiment of the present invention is mounted;

FIG. 11 is a perspective view of the portable terminal on which the hinge assembly according to the first embodiment of the present invention is mounted, for showing the close state of a folder;

FIG. 12 is a perspective view of the portable terminal on which the hinge assembly according to the first embodiment of the present invention is mounted, for showing the open state of a folder;

FIG. 13 is a cross-sectional view of the portable terminal as shown in FIG. 11;

FIG. 14 is a longitudinal sectional view of the portable terminal as shown in FIG. 11;

FIG. 15 is a cross-sectional view of the portable terminal as shown in FIG. 12;

FIG. 16 is a longitudinal sectional view of the portable terminal as shown in FIG. 12;

FIG. 17 is an exploded perspective view of a hinge assembly according to the second embodiment of the present invention;

FIG. 18 is a cross-sectional view of a portable terminal on which the hinge assembly according to the second embodiment of the present invention is mounted, for showing the close state of a folder;

FIG. 19 is a longitudinal sectional view of the portable terminal on which the hinge assembly according to the second embodiment of the present invention is mounted, for showing the open state of a folder;

FIG. 20 is an exploded perspective view of a hinge assembly according to the third embodiment of the present invention;

FIG. 21 is a longitudinal sectional view of the hinge assembly according to the third embodiment of the present invention, for showing the state that the hinge shaft does not rotate;

FIG. 22 is a longitudinal sectional view of the hinge assembly according to the third embodiment of the present invention, for showing the state that the hinge shaft has been rotated at a predetermined rotational angle;

FIG. 23 is an exploded perspective view of the portable terminal on which the hinge assembly according to the third embodiment of the present invention is mounted;

FIG. 24 is an exploded perspective view of a hinge assembly according to the fourth embodiment of the present invention;

FIG. 25 is a partial sectional view of a portable terminal on which the hinge assembly according to the fourth embodiment of the present invention is mounted, for showing the close state of a folder;

FIG. 26 is a partial sectional view of a portable terminal on which the hinge assembly according to the fourth embodiment of the present invention is mounted, for showing the state that the folder has been rotated against a main body at a predetermined rotational angle;

FIG. 27 is a side view of the portable terminal on which the hinge assembly according to the fourth embodiment of the present invention is mounted, for showing the state that the folder has been rotated against the main body at 180°;

FIG. 28 is a side view of the portable terminal on which the hinge assembly according to the fourth embodiment of the present invention is mounted, for showing the state that the folder has been rotated against the main body at 90°;

FIG. 29 is a top plan view of the portable terminal on which the hinge assembly according to the fourth embodiment of the present invention is mounted, for showing the state that the folder has been rotated upright against the main body at 90° with centering on the longitudinal axis line of the main body;

FIG. 30 is a top plan view of the portable terminal on which the hinge assembly according to the fourth embodiment of the present invention is mounted, for showing the state that the folder has been horizontally rotated against the main body at 90° with centering on the longitudinal axis line of the main body;

FIG. 31 is an exploded perspective view of a hinge assembly according to the fifth embodiment of the present invention, for showing a driving cam of the hinge shaft;

FIG. 32 is an exploded perspective view of the hinge assembly according to the fifth embodiment of the present invention, for showing an inner surface of the housing in a state that the hinge assembly as shown in FIG. 31 has been rotated against at 180°;

FIG. 33 is an exploded perspective view of a portable terminal on which the hinge assembly according to the fifth embodiment of the present invention is mounted;

FIG. 34 is a cross sectional view of the portable terminal on which the hinge assembly according to the fifth embodiment of the present invention is mounted;

FIG. 35 is a longitudinal sectional view of the portable terminal on which the hinge assembly according to the fifth embodiment of the present invention is mounted, for showing the close state of a folder;

FIG. 36 is a longitudinal sectional view of the portable terminal on which the hinge assembly according to the fifth embodiment of the present invention is mounted, for showing the open state of the folder;

FIG. 37 is a cross-sectional view of the portable terminal on which the hinge assembly according to the fifth embodiment of the present invention is mounted, for showing the state that the folder has been rotated against the main body at 90°;

FIG. 38 is a perspective view of the portable terminal on which the hinge assembly according to the fifth embodiment of the present invention is mounted, for showing the close state of the folder;

FIG. 39 is a perspective view of the portable terminal on which the hinge assembly according to the fifth embodiment of the present invention is mounted, for showing the close state of the folder after it rotating against the main body at 180°;

FIG. 40 is a perspective view of the portable terminal on which the hinge assembly according to the fifth embodiment of the present invention is mounted, for showing the open state of the folder after it rotating against the main body at 180°;

FIG. 41 is an exploded perspective view of a hinge assembly according to the sixth embodiment of the present invention;

FIG. 42 is an exploded perspective view of the portable terminal on which the hinge assembly according to the sixth embodiment of the present invention is mounted;

FIG. 43 is a cross-sectional view of a portable terminal on which the hinge assembly according to the sixth embodiment of the present invention is mounted;

FIG. 44 is a cross-sectional view of the portable terminal on which the hinge assembly according to the sixth embodiment of the present invention is mounted, for showing the state that the folder has been rotated upright against the main body at 90° with centering on the longitudinal axis line of the main body;

FIG. 45 is a cross-sectional view of the portable terminal on which the hinge assembly according to the sixth embodiment of the present invention is mounted, for showing the state that the folder stands erect against the main body;

FIG. 46 is a perspective view of the portable terminal on which the hinge assembly according to the sixth embodiment of the present invention is mounted, for showing the open state of the folder;

FIG. 47 is a perspective view of the portable terminal on which the hinge assembly according to the sixth embodiment of the present invention is mounted, for showing the state that a display panel is exposed by rotating the folder against the main body at 180°;

FIG. 48 is an exploded perspective view of a hinge assembly according to the seventh embodiment of the present invention;

FIG. 49 is an exploded perspective view of the portable terminal on which the hinge assembly according to the seventh embodiment of the present invention is mounted;

FIG. 50 is a perspective view of the portable terminal on which the hinge assembly according to the seventh embodiment of the present invention is mounted, for showing the close state of the folder;

FIG. 51 is a perspective view of the portable terminal on which the hinge assembly according to the seventh embodiment of the present invention is mounted, for showing the open state of the folder;

FIG. 52 is a longitudinal sectional view of the portable terminal on which the hinge assembly according to the seventh embodiment of the present invention is mounted, for showing the close state of the folder;

FIG. 53 is a longitudinal sectional view of the portable terminal on which the hinge assembly according to the seventh embodiment of the present invention is mounted, for showing the open state of the folder;

FIG. 54 is a cross-sectional view of the portable terminal on which the hinge assembly according to the seventh embodiment of the present invention is mounted, for showing the close state of the folder;

FIG. 55 is a cross-sectional view of the portable terminal on which the hinge assembly according to the seventh embodiment of the present invention is mounted, for showing the open state of the folder;

FIG. 56 is an exploded perspective view of a hinge assembly according to the eighth embodiment of the present invention;

FIG. 57 is a longitudinal sectional view of the portable terminal on which the hinge assembly according to the eighth embodiment of the present invention is mounted, for showing the close state of the folder;

FIG. 58 is a perspective view of the portable terminal on which the hinge assembly according to the eighth embodiment of the present invention is mounted, for showing the open state of the folder;

FIG. 59 is a perspective view of the portable terminal on which the hinge assembly according to the eighth embodiment of the present invention is mounted, for showing the state that a display panel horizontally rotates at 90° while the folder is open;

FIG. 60 is an exploded perspective view of a hinge assembly according to the ninth embodiment of the present invention;

FIG. 61 is a longitudinal sectional view of the portable terminal on which the hinge assembly according to the ninth embodiment of the present invention is mounted, and a display panel;

FIG. 62 is a cross sectional view of the portable terminal on which the hinge assembly according to the ninth embodiment of the present invention is mounted, and the display panel;

FIG. 63 is a top plan view of the portable terminal on which the hinge assembly according to the ninth embodiment of the present invention is mounted; and

FIG. 64 is a top plan view of the portable terminal on which the hinge assembly according to the ninth embodiment of the present invention is mounted, for showing the state that the display panel horizontally rotates against the folder at 90°.

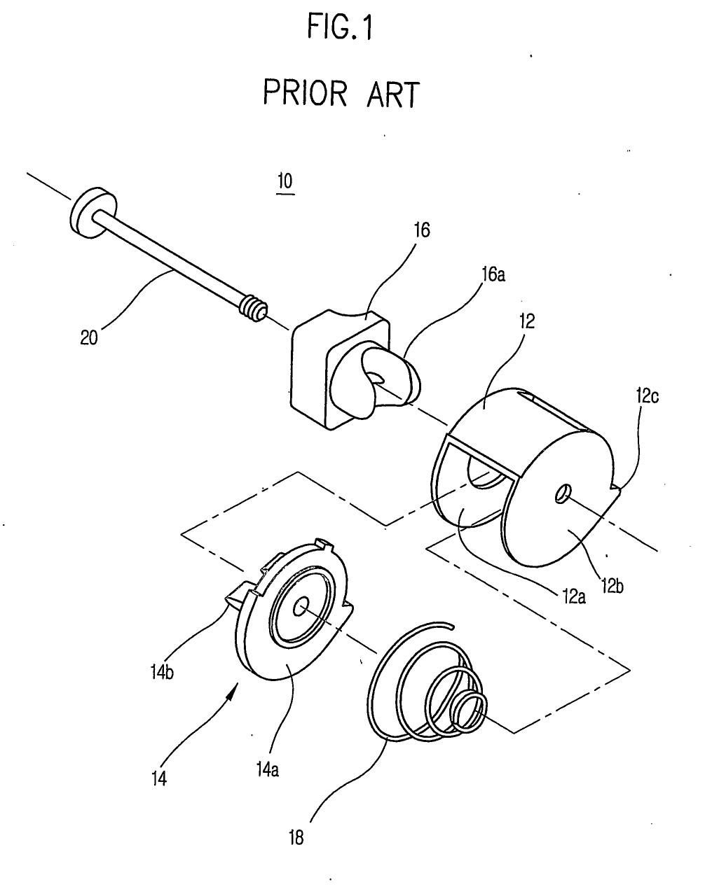

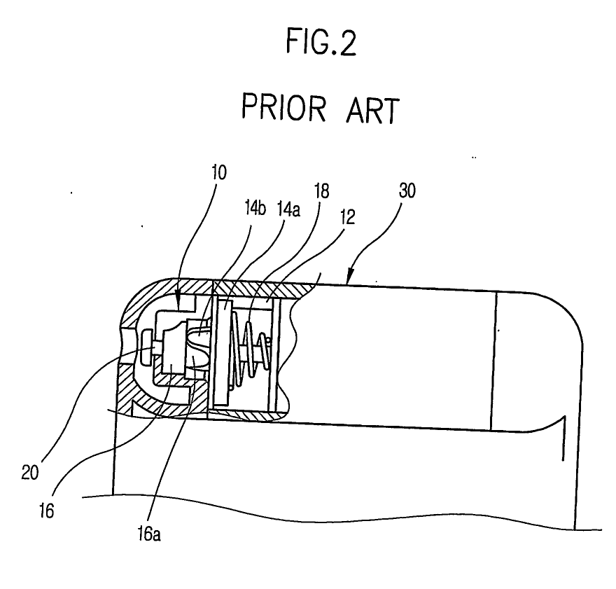

### BEST MODE FOR CARRYING OUT INVENTION

Hereinafter, the hinge assemblies according to the preferred embodiments of the present invention will be described in detail referring to the accompanying drawings.

Hereinafter, the hinge assembly according to the preferred embodiment of the present invention will be explained in more detail with reference to the accompanying drawings.

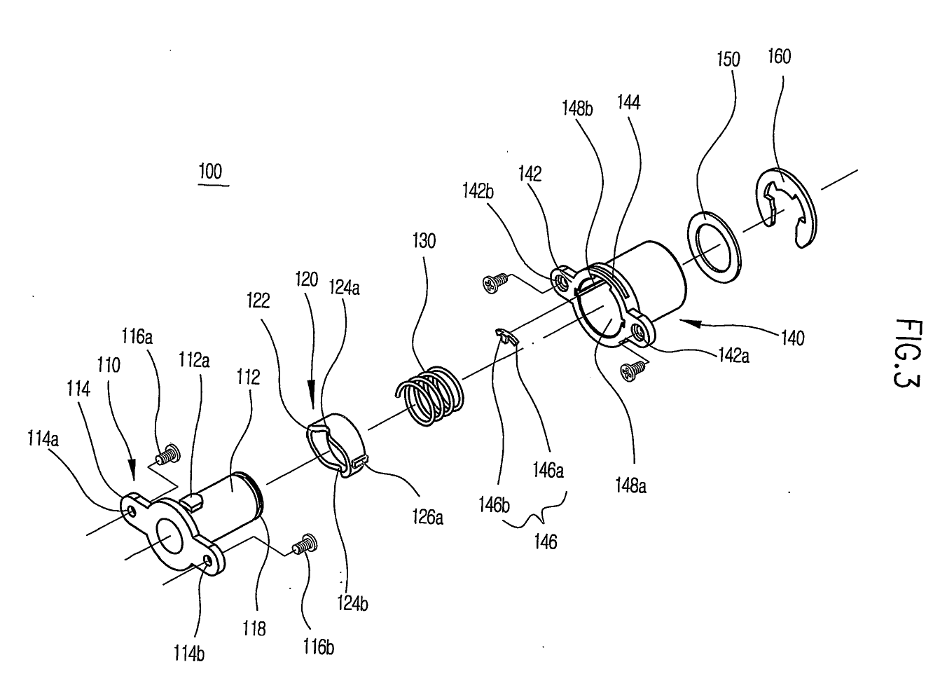

FIG. 3 is an exploded perspective view of the hinge assembly 100 according to the preferred embodiment of the present invention.

As shown in FIG. 3, the hinge assembly 100 according to the preferred embodiment of the present invention comprises a first member 110, a second member 120 and a third member 130. The first member 110 is coupled with an end of one article (not shown) to support the one article so that the one article can horizontally rotate with respect to the other article. The second member 120 is coupled with an end of the other article and is engaged with the first member to support the one other article so that the one article can rotate with respect to the other article. The third member 130 provides the second member 120 with elasticity so that the first member 110 is firmly engaged with the second member 120.

The hinge assembly 100 according to the preferred embodiment of the present invention further comprises a housing 140 that is inserted into a side of the other article for receiving the second member 120 and the third member 130.

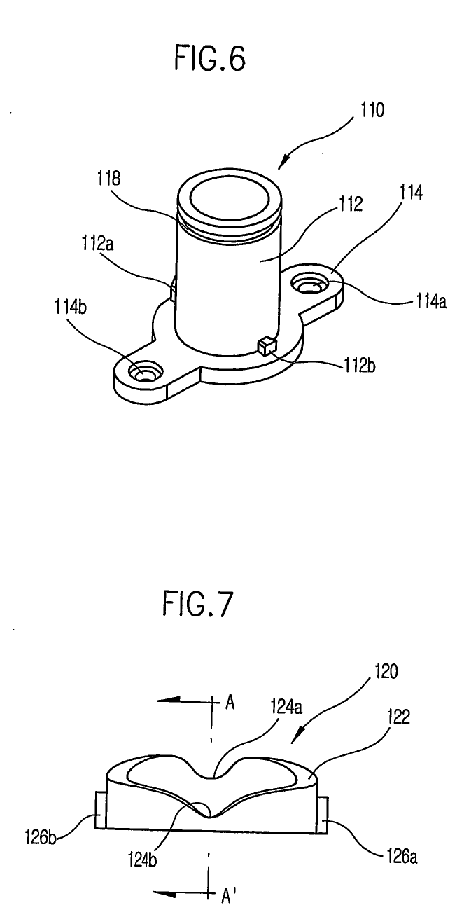

As shown in FIG. 3, FIG. 5 and FIG. 6, the first member 110 includes a cylindrical hinge shaft 112, on the outer peripheral surface of which projections are formed opposing each other.

A flange 114 is formed at one end of the cylindrical hinge shaft 112. Screw holes 114a,114b for fixing the first member 110 to the one article are formed through the hinge shaft 112. Accordingly, it is possible to fix the first member 110 to the one article by using the screws 116a,116b.

Meanwhile, an annular groove 118 is formed at the other end of the hinge shaft 112 of the first member 110. A snap ring 160 is mounted in the annular groove 118 of the hinge shaft 112 to the housing, which will be described herein below.

A pair of projections 112a,112b are formed opposing each other at an outer peripheral surface of the hinge shaft 112 of the first member 110. One of the projections is spaced from the flange 114 of the hinge shaft 112 at a predetermined distance, and the other of the projections is contacted with the flange 114 and is integrally formed with the flange 114.

One 112a of the projections 112a,112b formed at the outer peripheral surface of the hinge shaft 112 has a function of the cam, and the other 112b has a function of the stopper so that it prevents the hinge shaft 112 from being further rotated after rotating of the hinge shaft 112 at 180°.

The sizes of the projections 112a,112b, which has the functions of the cam and the stopper, are different with each other. A front end surface of one 112a has the same radius curvature as that of a first cam receiving groove 124a formed at one end surface of the second member 120. The size of the other projection 112b of the projections 112a,112b is smaller than that of the one projection 112a and is coupled with the stopper 146 mounted to the housing 140 so as to limit the rotation of the hinge shaft 110.

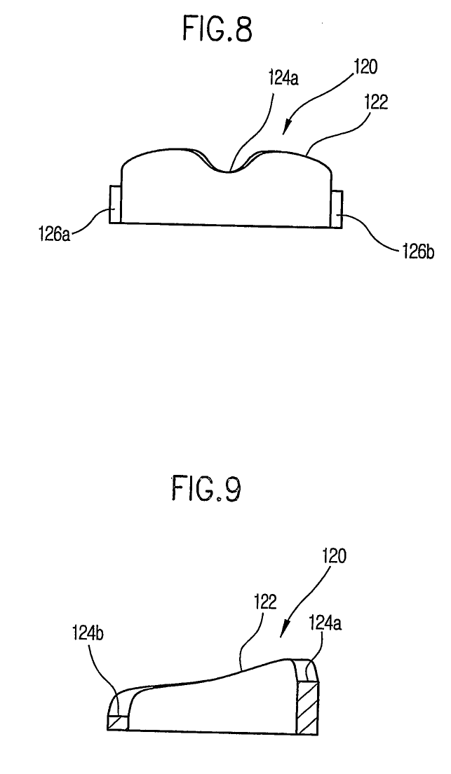

The second member 120 has a cylindrical shape and a predetermined shape of cam 122 is formed at the one end surface thereof, as shown in FIGS. 3 and 7 to 9.

As shown in FIGS. 7 and 9, the cam 122 of the second member 120 is slanted over its entire portion. A first cam receiving groove 124a is formed between two apexes of the cam 122 and a second cam receiving groove 124b is formed at a lower portion of the cam 122.

As shown in FIGS. 3, 7 and 9, a pair of projections 126a,126b are formed opposing each other in the longitudinal direction of the second member 120 at an outer peripheral surface of the second member 120.

The projections 126a,126b formed at the outer peripheral surface of the second member 120 are arranged at 90° against the first and the second cam receiving grooves 124a,124b formed at the cam 122. The second member 120 is disposed within the housing 140, the projections 126a,126b are received in guide groove 148a,148b formed at an inner peripheral surface of the housing 140 so that the second member 120 can smoothly move within the housing 140 in the horizontal direction.

Referring to FIG. 3 again, the third member 130 comprises a compressed coil spring. When the hinge assembly 100 has been assembled, the third member 130 is disposed between snap rings 160 mounted in the annular grooves 118, which are formed at the second member 120 and the other end of the hinge shaft 112 of the first member 110.

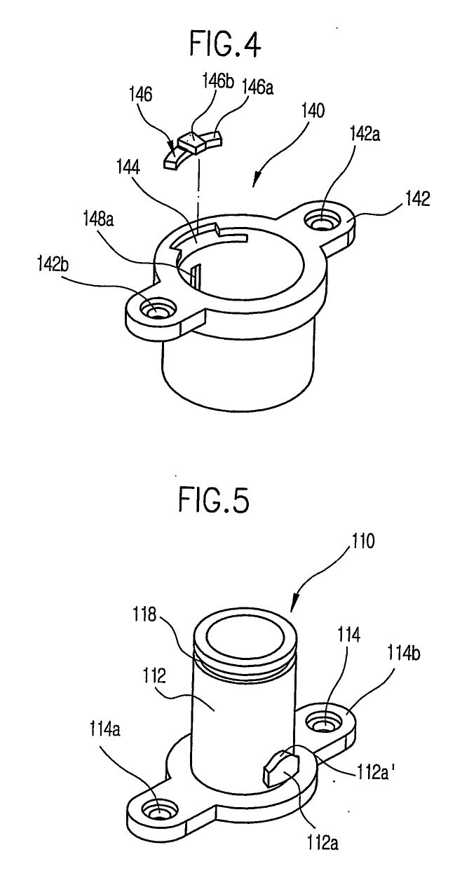

As shown in FIGS. 3 and 4, the housing 140 has a cylindrical shape and is provided with a flange for coupling the housing 140 with one article, on its one end.

A pair of screw holes 142a,142b for fixing the housing 140 to the one article are formed through the flange 142. Accordingly, it is possible to fix the housing 140 to the one article by using the screws.

A sliding groove 144 for receiving the stopper 146 is formed at the flange 142, which is formed at the one end of the housing 140. The sliding groove 144 is formed as an arc shape having a predetermined length and is defined by a neck portion so as to limit the movement of the stopper 146 so that the stopper 146 moves at a predetermined angle range.

The stopper 146 includes a main body 146a and a projection 146b sliding together with the main body 146a between the neck portions for defining the sliding groove 144. At this time, the main body 146a is slideably disposed within the sliding groove 144 and the projection 146b is integrally formed with the main body 146a.

The hinge shaft 112 of the first member 110 rotates at a predetermined rotating angle such as 180°, the stopper 146 is engaged with the projection 112b integrally formed with the flange 114 on the outer peripheral surface of the hinge shaft 112 of the first member 110 and then slides within the sliding groove 144 of the housing 140.

After moving along the sliding groove 144 at a predetermined distance, the neck portion for defining the sliding groove 144 hinders the movement of the projection 146b. As a result, the hinge shaft 112 and the projection 112b cannot further rotate and then may be stop due to engagement with the projection 146b of the stopper 146.

Guide grooves 148a,148b for receiving the projections 126a,126b, which are formed at the outer peripheral surface of the second member 120, are formed at an inner peripheral surface of the housing 140.

The guide grooves 148a,148b extend from an opening of a one end of the housing 140 at a predetermined length in the longitudinal direction of the housing 140. In the meantime, the guide grooves 148a,148b are disposed against the center line of the sliding groove 144 formed at the one end of the housing 140 at 90° opposing with each other.

When the second member 120 is disposed in the housing 140, the projections 126a,126b of the second member 120 are received in the guide grooves 148a,148b and thereby the movement of the second member 120 is guided during movement of the second member 120 within the housing 140.

The hinge assembly 100 according to the preferred embodiment of the present invention comprises a snap ring 160. When the first member 110 is engaged with the housing 140 after mounting the second member 120 and the third member 130 to the first member 110, the snap ring 160 prevents the second member 120 and the third member 130 from deviating from the hinge shaft 112.

The snap ring 160 is inserted into the annular groove 118 formed at the other end of the hinge shaft 112 and then is engaged with thereof in a state that the hinge shaft 112 is engaged with the housing 140 together with the second member 120 and the third member 130.

In order to attenuate the friction between the third member 130 and the snap ring 160, an annular ring 150 may be disposed between the third member 130 and the snap ring 160. As shown in FIG. 3, the annular ring 150 is disposed in the hinge assembly 100.

It will be understood by those skilled in the art that the annular ring 150 can be replaced with a washer having a diameter corresponding to an outer diameter of the hinge shaft 112 without departing from the spirit and scope of the invention as defined by the appended claims.

The hinge assembly 100 according to the first embodiment of the present invention constituted as the above is assembled with the following steps.

First, the second member 120 and the third member 130 are mounted to the hinge shaft 112 of the first member 110. When the second member 120 is mounted to the hinge shaft 112, the cam 122 formed at one end surface of the second member 120 is disposed opposing toward the projections 112a,112b formed at the outer peripheral surface of the hinge shaft 112.

Next, the second member 120 is tightly contacted with the projections 112a,112b of the first member 112 so that the first and the second cam receiving grooves 124a,124b formed at the cam 122 of the second member 120 are contacted with the front end surface of the projections 112a,112b formed at the hinge shaft 112.

Thereafter, the third member 130, that is a compressed coil spring is disposed at the hinge shaft 112 of the first member 110. Then, the hinge shaft 112 on which the second member 120 and the third member 130 are mounted is inserted to the housing 140. At this point, the projections 126a,126b formed at the outer peripheral surface of the second member 120 are inserted into the guide grooves 148a,148b so that they slide within the guide grooves 148a,148b.

Finally, the snap ring 160 is mounted into the annular groove 118 formed at the other end of the hinge shaft 112 passing through the housing 140 so that it prevents the second member 120 and the third member 130, which are mounted to the hinge shaft 112, from obviating from the hinge shaft 112 and the housing 140.

In the meantime, annular ring 150 such as a washer may be disposed between the snap ring 160 and the third member 130 mounted to the hinge shaft 112 as described above so as to reduce the friction there between.

Hereinafter, based on the attached drawings 10 to 16, we are explaining about the portable terminal 1000 on which the hinge assembly 100 according to the first embodiment of the present invention is mounted.

Since the hinge assembly 100 mounted to the portable terminal 1000 as described above is the same as the hinge assembly 100 according to the first embodiment of the present invention, it should be noted that, for the sake of clarity and understanding of the invention identical components which have identical functions have been identified with identical reference numerals throughout the different views which are illustrated in each of the attached drawing Figures.

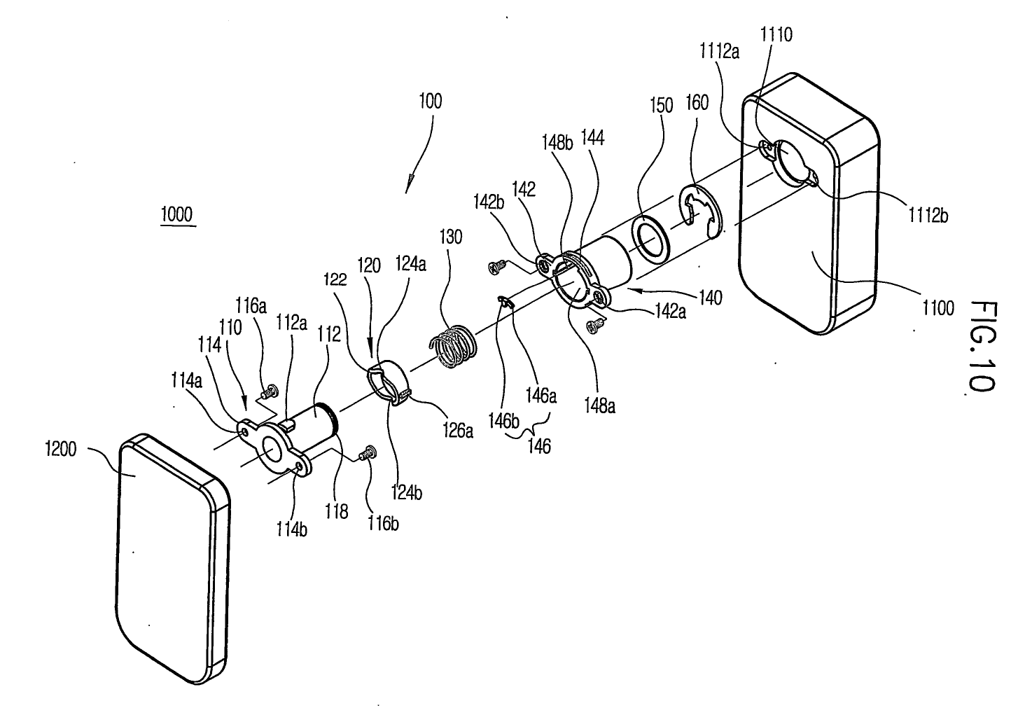

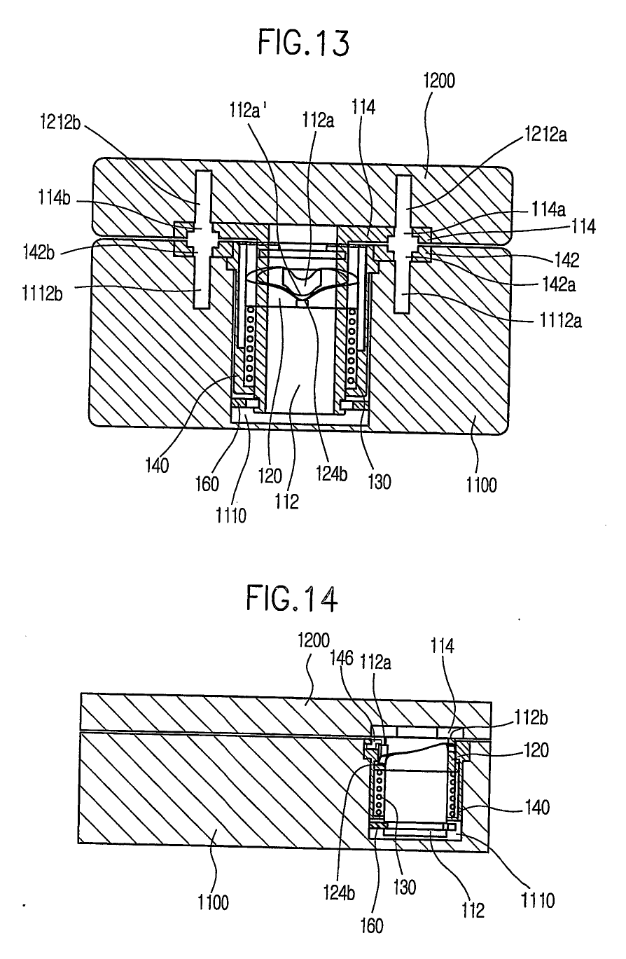

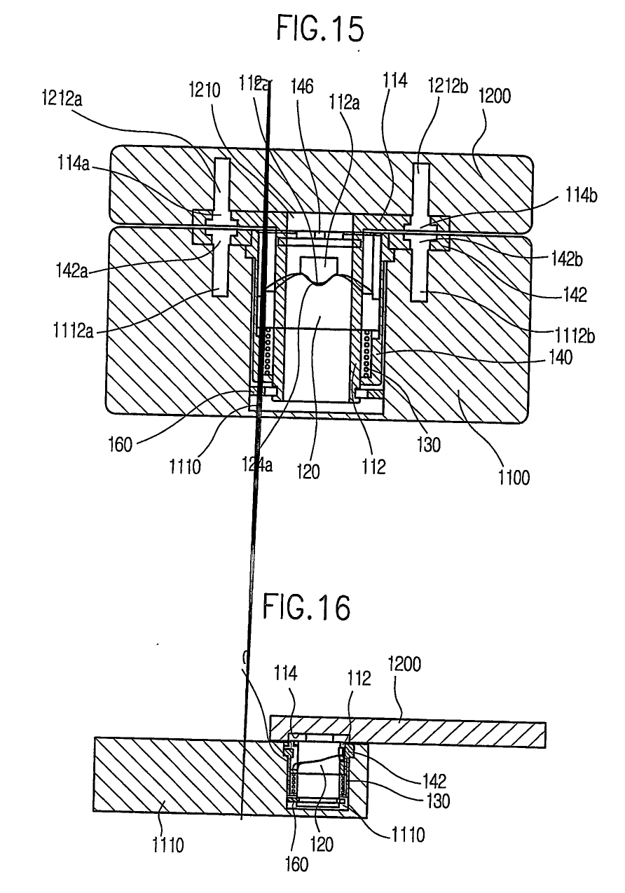

As shown in FIGS. 10 to 16, the portable terminal 1000 mounted with the hinge assembly 100 according to the first embodiment of the present invention comprises: a main body 1100 mounted with a key pad (not illustrated), a mike phone (not illustrated) and a battery (not shown); a folder 1200 mounted to be rotatable with respect to the main body 1100 horizontally and vertically and having a speaker phone (not illustrated) and a display panel (not illustrated); and a hinge assembly 100 to rotate the folder 1200 with respect to the main body 1100 horizontally and vertically, the hinge assembly 100.

The main body 1100 includes the key pad, the mike phone, a printed circuit board for operating the mike phone, and the battery for supplying an electric current to these element.

On a surface of the main body 1100, that is, on the surface of the key pad disposed, the housing receiving groove 1110 for receiving the housing 140 of the hinge assembly 100 as described above with reference drawings FIGS. 3 to 9, and recesses 1212a,1212b for fixing the hinge shaft 112 are formed.

On a surface of the folder 1200, that is, on the surface of the display panel disposed, the groove 1210 for receiving the flange 114 formed at the hinge shaft 112 of the hinge assembly 100, and recesses 1212a,1212b for fixing the hinge shaft 112 are formed.

After assembling the hinge assembly 100 as described above, the housing 140 is inserted into the housing receiving groove 1110 of the main body 1100. At this point, the housing 140 is positioned in a state that the screw holes 142a,142b formed at the flange 142 of the housing 140 are coaxially aligned with the recesses 1112a, 1112b formed at the main body 1100 of the portable terminal 1000.

Thereafter, the screws pass through the screw holes 142a,142b formed through the flange 142 of the housing 140 and then they are threaded into the recesses 1112a,1112b formed at the main body 1100. As a result, the housing 140 is fixed to the main body 1100 of the portable terminal 1000.

After fixing the housing 140 to the main body 1100 of the portable terminal 100, the hinge shaft 112 rotates at an angle of 90° centering on the axis thereof and then the flange 114 of the first member 110 is snugly disposed into the flange receiving groove 1210 formed at the folder 1200.

Thereafter, the flange 114 is aligned in a state that the screw holes 114a,114b formed at the flange 114 of the first member 110 are is coaxially aligned with the recesses 1212a,1212b formed at the folder 1200.

Then, the first member 110 is fixed to the folder 1200 by inserting the screws 116a,116b through the screw holes 114a,114b formed at the flange 114 of the first member 110 into the recesses 1212a,1212b formed at the folder 1200.

In the portable terminal 1000 assembled as stated above, the folder 1200 may rotate against the main body 1100 in the horizontal direction due to the hinge assembly 100 according to the first embodiment of the present invention.

Hereinafter, we are explaining about the function and the effect of the hinge assembly 1400 according to the first embodiment of the present invention and the portable terminal 1000 having the same.

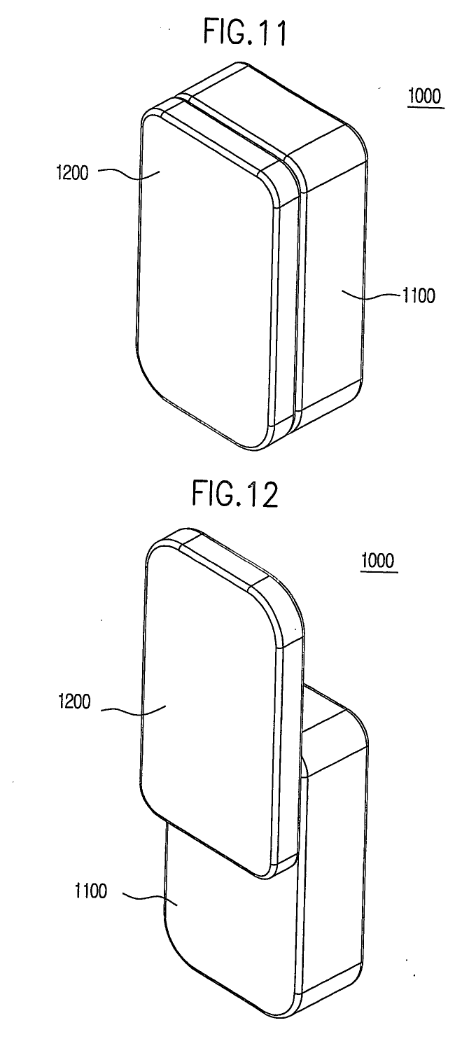

In the hinge assembly 1400 and the portable terminal 1000 assembled as described above, as shown in FIGS. 11,13 and 14, the projection 112a formed at the hinge shaft 112 is inserted into the second cam receiving groove 124b formed at one end surface of the second member and the projection 112b is positioned in the first cam receiving groove 124a in a state that the folder 1200 is closed against the main body 1100.

At this time, the third member, that is, the compressed coil spring 130 extends to the maximum and thereby it urges the second member 120 against the first member 110 so that the one end surface of the second member 120 is tightly contacted with the projection 112a formed at the hinge shaft 112 of the first member 110.

Furthermore, the stopper 146 installed at the one end of the housing 140 is positioned in the sliding groove 144 in a state that the projection 146b of the stopper 146 is located between the projection 112a formed at the hinge shaft 112 of the first member 110 and the flange 114.

Thereafter, when the folder 1200 is open by rotating the folder 1200 against the main body 1100 in the horizontal direction due to continuous application of an outer force to the folder 1200m, the hinge shaft 112 fixed to the folder 1200 rotates together with the folder 1200.

At this time, the projection 112a formed at the hinge shaft 112 protrudes from the second cam receiving groove 124b of the second member 120 and then moves along the cam 122 formed at the one end surface of the second member 120.

During the movement of the projection 112a of the hinge shaft 112 along the cam 122 of the second member 120, the second member 120 is pushed toward the other end of the housing 140 by means of the projection 112a of the hinge shaft 112. Accordingly, the second member 120 compresses the coil spring 130 and then moves toward the other end of the housing 140 along the inner peripheral surface of the housing 140.

Because the projections 126a,126b of the second member 120 are slideably received in the guide grooves 148a,148b formed on the inner peripheral surface of the housing 140, the second member 120 moving along the inner peripheral surface of the housing 140 moves within the housing 140 although the hinge shaft 112 of the first member 110 rotates.

As shown in FIGS. 12,15 and 16, if the folder 1200 rotates and then it is open, the hinge shaft 112 fixed to the folder 1200 rotates centering on the axis line thereof at 180° rotational angle. At this time, the projection 112a of the hinge shaft 112 moves along the cam 122 of the second member 120 and then is positioned in the first cam receiving groove 124a of the second member 120.

In the meantime, the projection 112b opposing to the projection 112a is contacted with the projection 146b of the stopper 146 mounted to the housing 140 when the folder 1200 is almost open due to rotation of the hinge shaft 112.

The projection 112b of the hinge shaft 112 contacting with the projection 146b of the stopper 146 pushes the projection 146b of the stopper 146 due to the continuous rotation of the hinge shaft 112.

Accordingly, the stopper 146 slides within the sliding groove 144. After moving at a predetermined distance, the stopper 146 stops to slide by means of the neck portion for defining the sliding groove 144.

Thereafter, the projection 112b of the hinge shaft 112 contacting with the projection 146b of the stopper 146 also stops to rotate and thereby the hinge shaft 112 having the projection 112b stops to rotate.

Finally, the folder 1200 engaged with the hinge shaft 112 also stops to rotate. At this time, the second member 120 moves toward the other end of the housing 140 at a predetermined distance by means of the projection 112a formed at the hinge shaft 112 and then it is elastically supported by the coil spring 130.

In the meantime, the hinge shaft 112 and the second member 120 are tightly contacted with each other due to the elastic force of the coil spring 130 in a state that the projection 112a is received in the first cam receiving groove 124a. Accordingly, if any exterior force is not applied to the folder 1200, the hinge shaft 112 cannot rotate.

In the hinge assembly 100 according to the first embodiment of the present invention and the portable terminal 1000 having the same, when the hinge shaft 112 and the folder 1200 are rotated at 180° and then open due to the elastic force of the second member 120 having the cam 222 and the coil spring 130, the folder 1200 maintains its open state if any external force is not applied to the folder 1200.

Alternatively, in order to close the folder 1200, it is required to apply an exterior force to the folder 1200 in a direction opposite to the force applying direction for closing the folder 1200 until the projection 112a formed at the hinge shaft 112 passes by the apex of the cam after getting away the first cam receiving groove 124a formed at the cam 122 of the second member 120.

Thereafter, the folder 1200 rotates in the reverse direction and the hinge shaft 112 engaged therewith also rotates in the reverse direction.

The projection 112a formed at the hinge shaft 112 moves toward the second cam receiving groove 124b of the cam 122 along the cam 122 of the second member 120 during the rotation of he hinge shaft 112.

At this time, it is possible to close the folder 1200 by continuously applying an exterior force thereto.

Because, the projection 112a formed at the hinge shaft 112 moves along the slanted surface of the cam 122 in the reverse direction after passing by the apex of the cam 122 of the second member 120, the folder 1200 having the hinge shaft 112 may be closed without applying the exterior force thereto.

As stated above, the hinge according to the first embodiment of the present invention and the portable terminal comprising the same, have the merits of restraining the rotation of the hinge shaft with respect to the main body at an angle of 180° due to operation of the cam of the second member and the stopper and rotating the folder in the clockwise direction or counterclockwise direction and thereby opening the folder.

Hereinafter, we are explaining the hinge assembly 200 according to the second embodiment of the present invention.

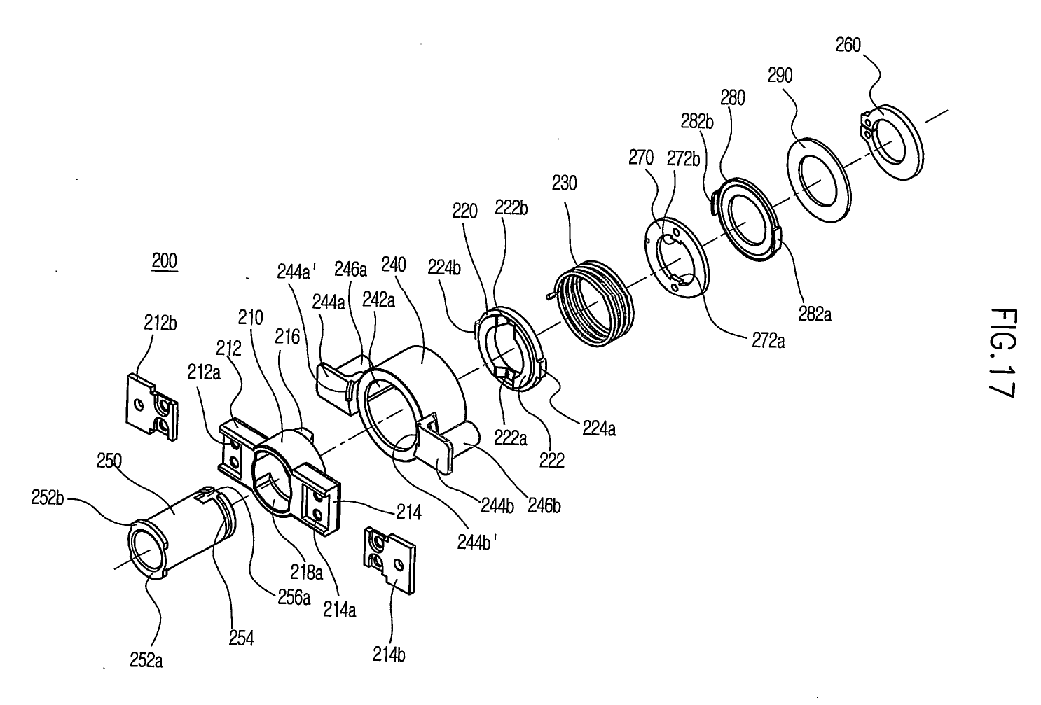

FIG. 17 is an exploded perspective view of the hinge assembly 200 according to the second embodiment of the present invention.

As shown in FIG. 17, the hinge assembly 200 according to the second embodiment of the present invention comprises a first member 210, a second member 220 and a third member 230. The first member 210 is coupled with an end of one article (not shown) to support the one article so that the one article can horizontally rotate with respect to the other article. The second member 220 is coupled with an end of the other article and is engaged with the first member 210 to support the one other article so that the one article can rotate with respect to the other article. The third member 230 provides the second member 220 with elasticity so that the first member 210 is firmly engaged with the second member 220.

The hinge assembly 200 according to the second embodiment of the present invention further comprises a housing 240 for receiving the first member 210, the second member 220 and the third member 230, and comprises a rotation shaft 250 for supporting these elements and passing through the first member 210, the second member 220 and the third member 230.

In the meantime, the hinge assembly 200 includes a snap ring 260 for preventing the second and the third members 220,230 mounted to the rotation shaft 250 from being released from the rotation shaft 250, which will be described herein below.

According to the second embodiment, as shown in FIG. 17, the first member 210 includes a cylindrical hinge shaft. A flanges 212,214 for fixing the first member 210 to the one object are formed at one end of the cylindrical hinge shaft. A driving cam 216 is formed at the other end surface of the hinge shaft.

Grooves 218a,218b for receiving the flanges 252a,252b of the rotation shaft 250, which will be described hereinafter, are formed at the inner peripheral surface of the hinge shaft 210.

Screw holes 212a,214a for receiving the screws there through are formed at the flanges 212,214, which are formed at the one end of the hinge shaft 210. Further, connectors 212b,214b for fixing the hinge shaft 210 to the one article are disposed at the flanges 212,214.

Screw holes for the threaded engagement between the connectors 212,214 and the flanges 212,214 of the hinge shaft 210 are formed through the connectors 212b,214b, and screw holes for the threaded engagement between the connectors 212,214 connected to the flanges 212,214 and the one article are formed through the connectors 212b,214b.

At a surface of one flange of the flanges 212,214 formed at the hinge shaft 210, a stopper 211 is integrally formed with the cylindrical shaped portion of the hinge shaft 210.

In the meantime, the driving cam 216 of the hinge shaft 210 comprises a pair of projections extending from the other end surface of the hinge shaft 210 at the same length. The width and the depth of the driving cam 216 is correspond to those of the first and the second driving cam receiving grooves 222a,222bb of a driven cam 222 formed at the one surface of the second member 220, which will be described herein below.

The second member 220 has a ring shape and is provided with the driven cam 222 on its one surface. The first and the second driving cam receiving grooves 222a,222bb for receiving the driving cam 216 of the hinge shaft 210 are formed at the driven cam 222.

A pair of projections 224a,224b are formed opposing each other at an outer peripheral surface of the second member 220. The projections 224a,224b of the second member 220 are received in the guide grooves 242a,242b formed opposing each other at an inner peripheral surface of the housing 240.

The third member 230 comprises a torsion spring having a predetermined diameter. When the hinge assembly 100 has been assembled, the torsion spring 230 is disposed between the other end surface of the second member 220 and the snap ring 260. One end of the torsion spring 230 is fixed to the second member 220 and the other end thereof is fixed to a support ring 270, which will be explained herein below.

When the rotation shaft 250 rotates together with the hinge shaft 210, the support ring 270 rotates together with the rotation shaft 250 in a state that the projections 272a,272b of the support ring 270 are inserted into the engaging grooves 256a,256b formed at the other end of the rotation shaft 250. As a result, the third member, that is the torsion spring 230, is compressed at the rotational direction of the rotation shaft 250.

The housing 240 has a cylindrical shape and guide grooves 242,242b for receiving the projections 224a,224b formed at the outer peripheral surface of the second member 220 are formed at the inner peripheral surface of the hosing 240.

The projections 224a,224b of the second member 220 to be received in the guide grooves 242a,242b of the housing 240 can smoothly move within the guide grooves 242a,242b. Accordingly, when the projections 224a,224b smoothly move along the guide grooves 242a,242b, the second member 220 having the projections 224a,224b can smoothly move along the axis of the housing 240 in the horizontal direction.

A pair of flanges 244a,244b are formed opposing each other in the longitudinal direction of the housing 240 at the one end side of the housing 240. Extension tubes 246a,246b are integrally formed with the one surface of the flanges 244a,244b, respectively. These extension tubes 246a,246b extend from the one surface of the flanges 244a,244b in the longitudinal direction of the housing 240.

Screw holes for fixing the housing 240 to the other article are formed through the extension tubes 246a,246b.

Sliding grooves 244a,244b having a predetermined shape are formed at the flange 142, which is formed at the one end of the housing 140. When the hinge shaft 210 and the housing 240 have been assembled together, the stopper 211 formed at one of the flanges 212,214 of the hinge shaft 210 is disposed in either the sliding groove 244a or 244b.

The rotation shaft 250 of the hinge shaft 200 according to the second embodiment of the present invention has a cylindrical shape and arc-shaped flanges 252a,252b are formed opposing each other in the longitudinal direction of the rotation shaft 250 on the one end and an annular groove 254 is formed on the other end thereof.

Engaging grooves 256a,256b having predetermined length and depth are formed at the outer peripheral surface of the rotation shaft 250 and they extend from the other end of the rotation shaft 250 to a position far apart at a predetermined distance.

When the rotation shaft 250 passes through the hinge shaft 210, the arc-shaped flanges 252a,252b formed at the one end of the rotation shaft 250 are snugly received in the grooves 218a,218b formed at the inner peripheral surface of the hinge shaft 210.

When the arc-shaped flanges 252a,252b integrally engaged in the grooves 218a,218b make the one other article to rotate against the other article in the horizontal direction, the rotation shaft 250 and the hinge shaft 210 rotate together.

The snap ring 260 is mounted in the annular groove 254 formed at the other end of the rotation shaft 250. The snap ring 260 prevents the elements mounted to the rotation shaft 250 from deviating from the rotation shaft 250.

In the meantime, the projections 272a,272b of a support ring 270, which will be explained herein below, are received in the engage grooves 256a,256b formed at an outer peripheral surface of the other end of the rotation shaft 250.

The hinge assembly 200 according to the second embodiment of the present invention includes pluralities rings for supporting the second member 220 and the third member 230 mounted to the rotation shaft 250, such as the support ring 270, the fixing ring 280, an annular ring 290 and the snap ring 260.

The support ring 270 comprises an annular ring, of which projections 272a,272b having width and thickness corresponding to the width and the depth of the engage grooves 256a,256b formed at the rotation shaft 250 are formed at the inner peripheral surface of the support ring 270.

In the meantime, a through hole is formed through the support ring 270 for receiving and fixing the other end of the torsion spring 230. By inserting the other end of the torsion spring 230 into the through hole, it is engaged with the support ring 270.

The support ring 270 is contacted with the other end of the third member 230 on the rotation shaft 250. The projections 272a,272b formed at the inner peripheral surface are received in the engage grooves 256a,256b formed at the other end of the rotation shaft 250. Accordingly, the support ring 270 is engaged with the rotation shaft 250 and rotates together during rotation of the rotation shaft 250. At this time, the support ring 270 compresses the third member, that is, the torsion spring 230 in the rotational direction.

The fixing ring 280 comprises an annular ring, of which a guide wall is formed at an outer peripheral portion of the fixing ring 280. Also, the extension portions 282a,282b having predetermined width and height are formed opposing each other at the outer peripheral portion of the fixing ring 280.

The fixing ring 280 is mounted to the rotation shaft 250 so that it is contacted with the support ring 270 and receives and supports the support ring 270.

The annular ring 290 is disposed between the fixing ring 280 and the snap ring 260 on the rotation shaft 250 and it can attenuate the friction between the fixing ring 280 and the snap ring 260.

Alternatively, the annular ring 290 may comprise a washer having a predetermined diameter, which come into the market.

The snap ring 260 prevents the element, which is mounted to the rotation shaft 250 by inserting into the annular groove 254 formed at the other end of the rotation shaft 250 as described above, from deviating from the hinge shaft 250.

The hinge assembly 200 according to the second embodiment of the present invention constituted as the above is assembled with the following steps.

First, as shown in FIG. 17, the rotation shaft 250 is inserted into the hinge shaft 210. At this time, the arc-shaped flanges 252a,252b formed on the rotation shaft 250 are snugly received in the grooves 218a,218b formed opposing with each other at the inner peripheral surface of the hinge shaft 210.

Then, the rotation shaft 250 having the hinge shaft 210 passes through the housing 240. At this time, the stopper 211 formed at one of the flanges 244a,244b of the hinge shaft 250 is slideably received in one of the sliding grooves 244a′,244b′ formed at the flanges 244a,244b of the housing 240.

Thereafter, the second member 220 is inserted into the housing 240 and then it is mounted to the rotation shaft 250. The projections 224a,224b formed at the outer peripheral surface of the second member 220 are inserted into the guide grooves 242a,242b so that they slide within the guide grooves 242a,242b.

Next, the second member 220 is tightly contacted with the hinge shaft 210 so that the first and the second cam receiving grooves 222a,222b formed at the one surface of the second member 220 are engaged with the driving cam 216 formed at the other end of the hinge shaft 210.

Thereafter, the third member 230, that is a torsion spring is mounted to the rotation shaft 250 in a state that one end thereof is fixedly engaged with the second member 220 and the other end thereof passes through the through hole of the support ring 270 so as to engage with the support ring 270.

While the support ring 270 has been mounted to the rotation shaft 250, the projections 272a,272b formed at the inner peripheral surface of the support ring 270 are inserted into the engage grooves 256a,256b formed at the other end of the rotation shaft 250.

Accordingly, the support ring 270 rotates together with the rotation shaft 250 and thereby it compresses the torsion spring 230 in the rotational direction.

Next, the fixing ring 280 is mounted to the rotation shaft 250 with tightly contacting with the support ring 270 so as to locate the fixing ring 280 at the guide wall of the fixing ring 280.

After disposing the washer 290 behind the fixing ring 280, the elements mounted to the rotation shaft 250 may not released from the rotation shaft 250 to the outside by mounting the snap ring 260 into the annular groove 254 formed at the other end of the rotation shaft 250.

Hereinafter, we are explaining about the portable terminal 2000 on which the hinge assembly 200 according to the second embodiment of the present invention is mounted.

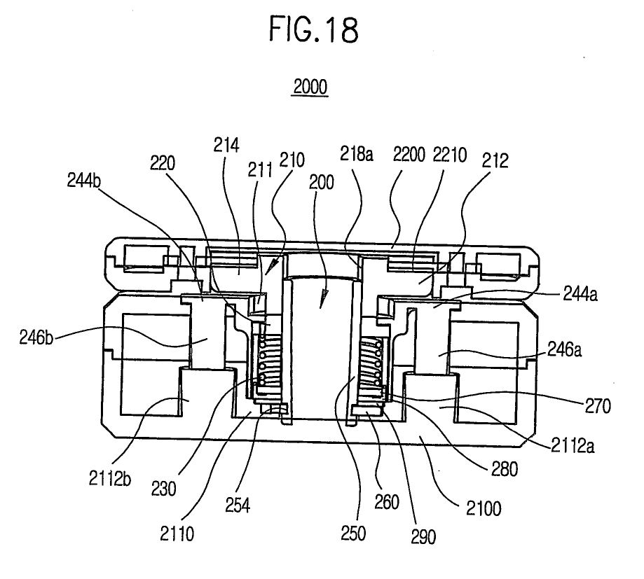

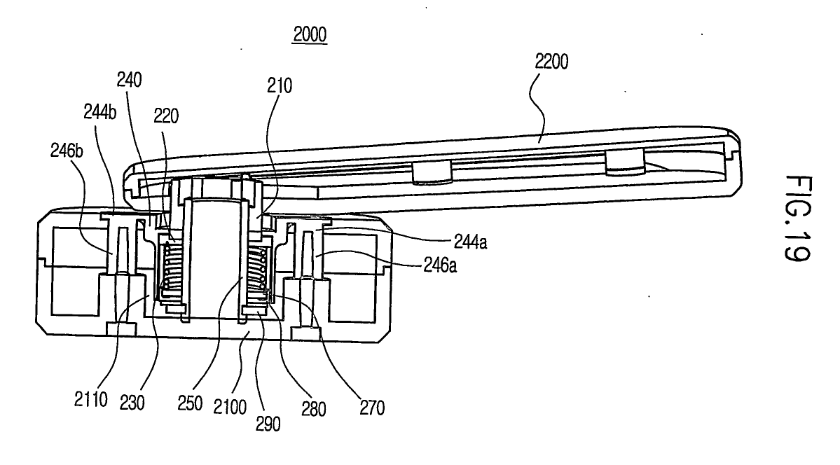

FIG. 18 is a cross-sectional view of the portable terminal 2000 on which the hinge assembly 200 according to the second embodiment of the present invention is mounted, for showing the close state of the folder 2200. FIG. 19 is a cross-sectional view of the portable terminal 2000 on which the hinge assembly 200 as shown in FIG. 17 is mounted, for showing the open state of the folder 2200

As shown in FIGS. 18 and 19, the portable terminal 2000 having the hinge assembly 200 according to the second embodiment of the present invention comprises a main body 2100 mounted with a key pad (not illustrated), a mike phone (not illustrated) and a battery (not shown); a folder 2200 mounted to be rotatable with respect to the main body 2100 horizontally and vertically and having a speaker phone (not illustrated) and a display panel (not illustrated); and a hinge assembly 200 to rotate the folder 2200 with respect to the main body 2100 horizontally and vertically.

The main body 2100 includes the key pad, the mike phone, a printed circuit board for operating the mike phone, and the battery for supplying an electric current to these element.

On a surface of the main body 2100, that is, on the surface of the key pad disposed, the housing receiving groove 2110 for receiving the housing 240 of the hinge assembly 200 as described above, and recesses 2112a,2112b for receiving the extension tubes 246a,246b extending from the flanges fixing the hinge shaft 112 are formed.

On a surface of the folder 2200, that is, on the surface of the display panel disposed, the grooves 2210 for receiving the flanges 212,214 formed at the hinge shaft 210 of the hinge assembly 200 are formed.

After assembling the hinge assembly 200 as described above, the housing 240 is inserted into the housing receiving groove 2110 of the main body 2100. At this point, the housing 240 is positioned in a state that the extension tubes 246a,246b extending from the flanges 244a,244b of the housing 240 are inserted into the recesses 2112a,2112b formed at the main body 2100 of the portable terminal 2000.

Thereafter, the screws pass through the recesses 2112a,2112b and then they extend through the extension tubes 246a,246b extending from the flanges 244a,244b of the housing 240. As a result, the housing 240 is fixed to the main body 2100 of the portable terminal 2000.

Prior to fix the housing 240 to the main body 2100 of the portable terminal 2000, the hinge shaft 210 is fixed to the folder 2200 by locating the fist member, that is, the hinge shaft 210 in the groove 2210 formed at the one surface of the folder 2200 and continuously inserting the screw into the through hole formed at the flanges 212,214 of the hinge shaft 210 so as to it is threaded into the one surface of the folder 2200.

Hereinafter, we are explaining about the function and the effect of the hinge assembly 200 according to the second embodiment of the present invention and the portable terminal 2000 having the same.

In the hinge assembly 200 and the portable terminal 2000 assembled as described above, as shown in FIG. 18, the driving cam 216 formed at the hinge shaft 210 is inserted into the first cam and the second cam receiving grooves 222a,222b formed at the one surface of the second member 220 in a state that the folder 2200 is closed against the main body 2100.

At this time, the third member, that is, the torsion spring 230 may have a minimum of elastic force for restraining the rotation of the rotation shaft 250.

Furthermore, the stopper 211 installed at the one of the flanges 212,214 of the hinge shaft 210 is slideably positioned in the sliding grooves 244a′,244b′ formed at the flanges 212,214 of the hinge shaft 210.

Thereafter, when the folder 2200 is open by rotating the folder 2200 against the main body 2100 in the horizontal direction due to continuous application of an outer force to the folder 2200, the hinge shaft 210 fixed to the folder 2200 rotates together with the folder 2200.

Because the projections 224a,224b of the second member 220 are slideably received in the guide grooves 242a,242b formed on the inner peripheral surface of the housing 140, the second member 220 moves within the housing 240 along the longitudinal direction although the rotation shaft 250 rotates together with the folder 2200.

Due to the rotation of the hinge shaft 210, the driving cam 216 formed at the hinge shaft 210 moves away from the first and the second driving cam receiving grooves 222a,222b of the second member 220 and then it moves along the cam 222 formed at the one surface of the second member 220.

While the driving cam 216 of the hinge shaft 210 moves along the cam 222 of the second member 220, the second member 220 is pushed toward the other end of the housing 240 by means of the driving cam 216 of the hinge shaft 210. Thereafter, the second member 220 compresses the torsion spring 230 and then moves toward the other end of the housing 240 along the inner peripheral surface of the housing 240.

Since the one end of the torsion spring 230 is fixed to the second member 220, which moves in the longitudinal direction without rotating, the other end of the torsion spring 230 is engaged with the support ring 270, which rotates together with the rotation shaft 250, the torsion spring 230 may be compressed in the rotational direction of the folder 2200, that is, in the rotational direction of the rotation shaft 250.

Accordingly, an elastic force for restraining the rotation of the folder 2200 and returning the folder 2200 to the close state is accommodated at the torsion spring 230.

If the folder 2200 rotates at 180° rotational angle by receiving the continuous exterior force, the driving cam 216 of the hinge shaft 210 is positioned in the driving cam receiving grooves 222a,222b of the second member 120. Accordingly, the elastic force of the torsion spring 230 is gradually increased in proportion thereto.

Since the force for restraining the rotation of the driving cam 216 is greater than the elastic force of the torsion spring 230 for rotating the driving cam 216, the hinge shaft 210 cannot rotate in the reverse direction due to the force of restitution of the torsion spring 230 under the state that the driving cam 216 is received in the driving cam receiving grooves 222a,222b.

Accordingly, the folder 2200 maintains its open state.

In order to close the folder 2200, if an exterior force is applied to the folder 2200 in the reverse direction, the driving cam 216 of the hinge shaft 210 received in the driving cam receiving grooves 222a,222b of the second member 220 gets out of the driving cam receiving grooves 222a,222b and then it is contacted with the cam 222 of the second member 220.

The hinge shaft 210 engaged with the folder 2200 and the rotation shaft 250 integrally engaged with the hinge shaft 210 rotate in the reverse direction and thereby it returns its initial position, that is, a position of closing the folder 2200.

When the rotation shaft 250 returns its initial position, the elastic force of the torsion spring 230 is gradually weaken and thereby the folder 2200 may be smoothly closed against the main body 2100.

As stated above, the hinge according to the second embodiment of the present invention and the portable terminal comprising the same, have the merits of restraining the rotation of the hinge shaft with respect to the main body at an angle of 180°. If the driving cam is released form the driving cam receiving groove by applying a predetermined exterior force to the folder under the state that the folder is open, the folder moves the initial position, that is, the close position due to the elastic force of the torsion spring without applying any further exterior force to the folder.

Hereinafter, we are explaining about the hinge assembly 300 according to the third embodiment of the present invention is mounted.

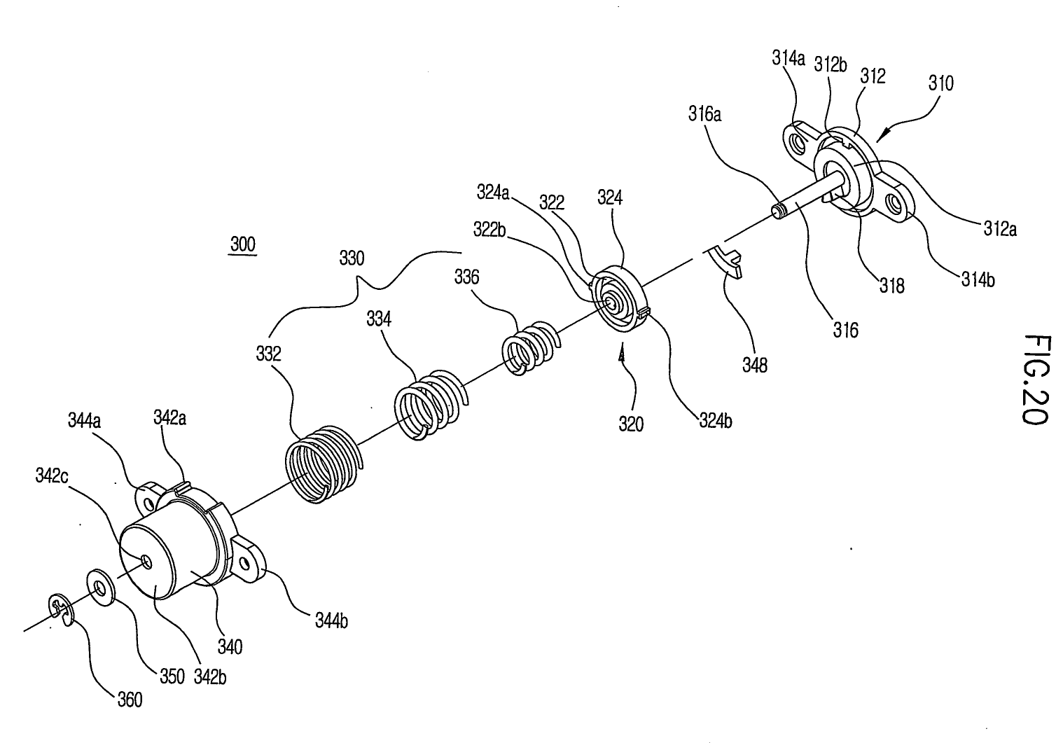

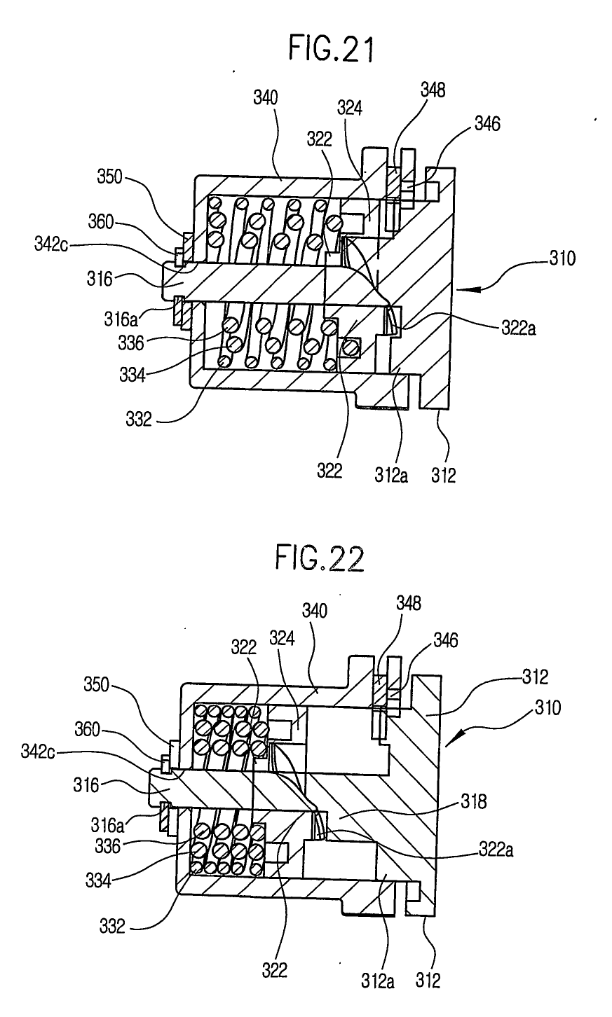

FIG. 20 is an exploded perspective view of the hinge assembly 300 according to the third embodiment of the present invention. FIG. 21 is a longitudinal sectional view of the hinge assembly 300 according to the third embodiment of the present invention, for showing the state that the hinge shaft is not rotated. FIG. 22 is a longitudinal sectional view of the hinge assembly 300 according to the third embodiment of the present invention, for showing the state that the hinge shaft is rotated.

As shown in FIGS. 20 and 21, the hinge assembly 300 according to the third embodiment of the present invention comprises a first member 310, a second member 320 and a third member 330. The first member 310 is coupled with an end of one article (not shown) to support the one article so that the one article can horizontally rotate with respect to the other article. The second member 320 is coupled with an end of the other article and is engaged with the first member 310 to support the one other article so that the one article can rotate with respect to the other article. The third member 330 provides the second member 320 with elasticity so that the first member 310 is firmly engaged with the second member 320.

Further, the hinge assembly 300 further includes a housing 340 for receiving the first member 310, the second member 320 and the third member 330. At this time, the housing 340 may be received and fixed in the other article.

The first member 310 includes a hinge shaft. The hinge shaft includes a cylindrical shaped body 312, flanges 314a,314b for fixing the hinge shaft to the one object, these flanges 314a,314b being formed at the body 312, a shaft portion 316 extending from the one surface of the body 312, and a driving cam 318 formed at the other peripheral surface of the shaft portion 316.

The body part 312 of the hinge shaft 310 is a round-shape, forming a flat surface in its one side, and forming a round-shaped wall part in another side. Flanges 314a, 314b are formed at predetermined intervals in the outside surface of the round-shaped wall part of the body part 312.

In each of the flanges 314a,314b, a through hole, to which a screw is extended penetrating for fixing the hinge shaft 310 to said one article, is formed.

In the body part 312 of the hinge shaft 310 in which the round-shaped wall, a round-shaped supporting board 312a is formed. In the center of the round-shaped supporting board 312a, the shaft part 316 of a real axis is extended to a predetermined length there from.

In the shaft part 316, the driving cam 318 is formed on the cylindrical surface in contact with the circular supporting board 312a. In addition, in the end of the shaft part 316, an annular groove 316a is formed. A snap ring 360 is mounted on the annular groove 316a.

Meanwhile, a projection 312b is formed at an inner peripheral surface of the round-shaped supporting board 312 with opposing to the driving cam 318 formed at the shaft body 316. The projection 312b extends along the longitudinal axis of the shaft 316.

The second member 320 comprises a cylindrical part 322 having a driven cam 322a engaged with the driving cam 318 of the hinge shaft 310 therein, and a flange part 324 having a skirt, which is formed as a radial shape in one end of the cylindrical part 322 and is extended towards the other end of the cylindrical part 322.

In the center of the cylindrical part 322 of the second member 320, a through hole to which the shaft part 316 of the hinge shaft 310 is extended penetrating. The driven cam 322a formed in the cylindrical part 322 is spirally formed from the lower surface of the cylindrical part 322 to one end centering the axis line of the cylindrical part 322, and each apex thereof is projected to the outside of the end of the cylindrical part 322. The apexes limit the cam receiving groove for receiving the driving cam 318 of the hinge shaft 310 there between.

The spiral driven cam 322a is formed to be symmetrical with the axis line of the cylindrical part 322.

Meanwhile, in the circumference surface of the skirt part formed in the flange part 324 of the second member 320, projections 324a, 324b are formed opposing with each other and extended passing the end of the skirt.

The third member 330 comprises a first, second and third coil spring 332,334,336, and each coil spring 332,334,336 has predetermined elastic force. In addition, each coil spring 332,334,336 has different diameter.

Regarding the size of the coil springs 332,334,336, the first coil spring 332 has the biggest diameter, and the second coil spring 334 has the following diameter, and the third coil spring 336 has the smallest diameter.

The housing 340 comprises an open end 342a and a close end 342b, wherein flanges 344a,344b for fixing the housing 340 to one article are formed opposing with each other at the open end 342a.

A sliding groove 346 having a predetermined length is formed at an inner peripheral surface of the open end 342a of the housing 340. A stopper 348 is slideably disposed in the sliding groove 346.

A guide groove (not shown) is formed in the longitudinal direction at an inner peripheral surface of the housing 340. The guide groove is arranged at 90° against the center of the sliding groove 346 formed at an inner peripheral surface of the open end 342a of the housing 340.

The projections 324a,324b formed at the outer peripheral surface of the skirt portion of the second member 320 are slideably disposed in the guide groove of the housing 340.

Furthermore, the hinge assembly 300 comprises an annular ring 350, which is disposed at the shaft portion 316 passing through the housing 340 so as to reduce the friction between the close end 342b of the housing 340 and the snap ring 360. Preferably, the annular ring 350 comprises a predetermined size of washer.

The hinge assembly 300 according to the third embodiment of the present invention constituted as the above is assembled with the following steps.

First, the coil springs 332,334,336 are inserted into the housing 340 from the large diameter size to the small diameter size. Then, the stopper 348 is disposed in the sliding groove 346 of the housing 340.

Next, the second member 320 is mounted to the shaft part 316 of the hinge shaft 310. At this time, the shaft part 316 passes through the through hole 322b formed at the cylindrical part 322 of the second member 320. Furthermore, the second member 320 is aligned with the shaft part 316 so that the driving cam 318 formed at the shaft part 316 is contacted with the lower surface of the cylindrical part 322.

Thereafter, the shaft part 316 of the hinge shaft 310 having the second member 320 passes through the coil springs 332,334,336 and the through hole 343c formed at the close end 342b of the housing 340. At this time, the hinge shaft 310 is aligned with the housing 340 so that the circular-shaped support 312a of the hinge shaft 310 is positioned in the housing 340. At this point, the projections 324a,324b of the second member 320 are inserted into the guide grooves formed at the inner peripheral surface of the housing 340 so that they slide within the guide grooves in the longitudinal direction of the housing 340.

Next, the annular ring 350 is mounted to the shaft part 316 of the hinge shaft 310 extending through the through hole 342c formed at the close end 342b of the housing 340. Furthermore, a snap ring 360 is mounted in the annular groove 316a of the shaft part 316 so that it prevents the hinge shaft 310 from obviating from the housing 340.

Hereinafter, based on the attached drawings, we are explaining about the portable terminal 3000 on which the hinge assembly 300 according to the third embodiment of the present invention is mounted.

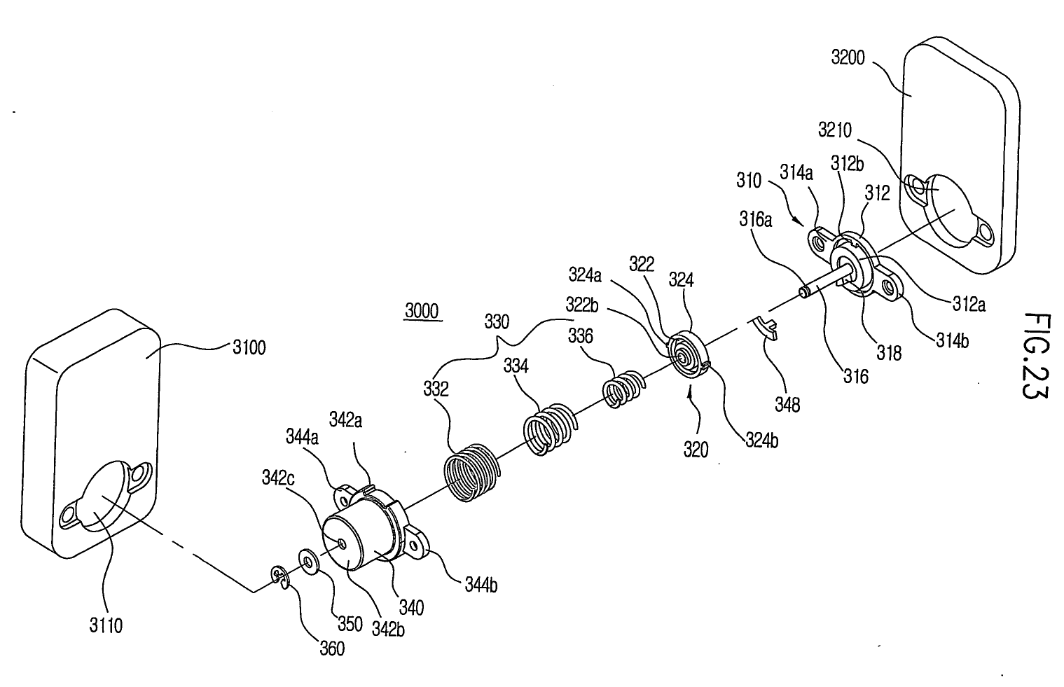

FIG. 23 is an exploded view of the portable terminal 3000 on which the hinge assembly 300 according to the third embodiment of the present invention is mounted.

As shown in FIG. 23, the portable terminal 3000 comprises a main body 3100 mounted with a key pad (not illustrated), a mike phone (not illustrated) and a battery (not shown); a folder 3200 mounted to be rotatable with respect to the main body 3100 horizontally and vertically and having a speaker phone (not illustrated) and a display panel (not illustrated); and a hinge assembly 300 to rotate the folder 3200 with respect to the main body 3100 horizontally and vertically, the hinge assembly 300 being disposed between the main body 3100 and the folder 3200.

On a surface of the main body 3100, that is, on the surface of the key pad disposed, the housing receiving groove 3110 for receiving the housing 340 of the hinge assembly 300 as described above is formed.

On a surface of the folder 3200, that is, on the surface of the display panel disposed, which is opposite to the one surface of the main body 3100, the groove 3210 for receiving the hinge shaft 310 of the hinge assembly 300 is formed.

When the hinge assembly 300 has been mounted to the portable terminal 3000, the housing 340 is inserted into the housing receiving groove 3110 formed at the main body 3100 of the portable terminal 3000 and then screws are inserted into the through hole of the flanges 344a,344b formed at the open end 342a of the housing 340 so as to engage the housing 340 to the main body 3110.

Thereafter, the hinge shaft 310 is disposed in the groove 3210 formed at the folder 3200, and then screws are inserted into the through holes of the flanges 344a,344b formed at the hinge shaft 310 so as to engage the hinge shaft 310 to the folder 3200.

Next, the second member 320 is mounted to the shaft part 316 of the hinge shaft 310. Then, the coil springs 332,334,336 are disposed in the second housing 320 and the shaft part 316 of the hinge shaft 310 having the second member 320 passes through the coil springs 332,334,336 and the through hole 342c formed at the close end 342b of the housing 340.

Finally, the annular ring 350 is mounted to the shaft part 316 of the hinge shaft 310 passing through the through hole 342c of the housing 340 at the other surface of the main body 3100. Furthermore, the snap ring 360 is inserted into the annular groove 316a formed at the distal end of the shaft part 316 of the hinge shaft 310 so as to prevent the hinge shaft 310 from deviating from the housing 340.

Hereinafter, we are explaining about the function and the effect of the hinge assembly 300 according to the third embodiment of the present invention and the portable terminal 3000 having the same.

Under the state that the folder 3200 of the portable terminal 3000 is closed against the main body 3100, the driving cam 318 of the hinge shaft 310 is contacted with the lower surface of the cylindrical part 322 of the second member 320.

In a state that the folder 3200 is closed, the projection 312b formed at the circular-shaped wall of the hinge shaft 310 is position opposing to the stopper 348 disposed in the sliding groove 346 of the housing 340.

When a user opens the folder 3200 of the portable terminal 3000, the driving cam 318 of the hinge shaft 310 moves along the driven cam 322a formed at the cylindrical part 322 of the second member 320.

At this time, the second member 320 is pushed toward the close end 342b of the housing 340 by means of the driving cam 318 of the hinge shaft 310. Because the projections 324a,324b formed at the outer peripheral surface of the skirt portion are slideably received in the guide grooves formed on the inner peripheral surface of the housing 340, the second member 320 moves within the housing 340 along the longitudinal direction without rotating together with the hinge shaft 310.

If the folder 3200 rotates in the horizontal direction by receiving the continuous exterior force, the driving cam 318 of the hinge shaft 310 moves to the cam receiving grooves formed between the apexes of the driven cam 318 of the second member 320. Under this state, the folder 3200 rotates against the main body 3100 at 180°.

At this time, the stopper 348 disposed in the sliding groove 346 of the housing 340 is contacted against the projection 312b integrally formed with circular-shaped wall of the hinge shaft 310. As a result, the projection 312b pushes the stopper 348 in the rotational direction of the hinge shaft 310.

After slideably moving within the sliding groove 346 at a predetermined distance with the aid of the projection 312b of the hinge shaft 310, the stopper 348 stops by means of the wall for defining the sliding groove 346.

Accordingly, the hinge shaft 310 having the projection 312b contacting against the stopper 348 also stops to move.

In order to close the folder 3200, if an exterior force is applied to the folder 32200 in the forward or the reverse directions, the driving cam 318 of the hinge shaft 310 gets out of the groove between the apexes of the driven cam 322a.

Thereafter, if additional force is applied to the folder 3200, the driving cam 318 of the hinge shaft 310 slides along the driven cam 322a of the second member 320 toward the lower surface of the cylindrical part 322.

At this time, since the driving cam 318 is tightly contacted with the driving cam 318 due to the elastic force of the coil springs 332,334,336, the driving cam 318 smoothly slides along the driven cam 322a, and thereby the folder 3200 on which the hinge shaft 310 having the driving cam 318 is engaged smoothly is closed.

In the meantime, since the driven cam 322a is formed to be symmetrical with the axis line of the cylindrical part 322 of the second member 320, it is possible to open or close the folder 3200 during rotation of the folder 3200 in the clockwise or counterclockwise direction.

As stated above, the hinge assembly according to the third embodiment of the present invention and the portable terminal comprising the same, have the merits of capable of rotating the hinge shaft of the hinge assembly in the clockwise direction or in the counterclockwise direction and of opening or closing the folder without regard to the rotation of the hinge shaft of the hinge assembly in any rotational direction

Hereinafter, we are explaining about the hinge assembly 400 according to the forth embodiment of the present invention is mounted.

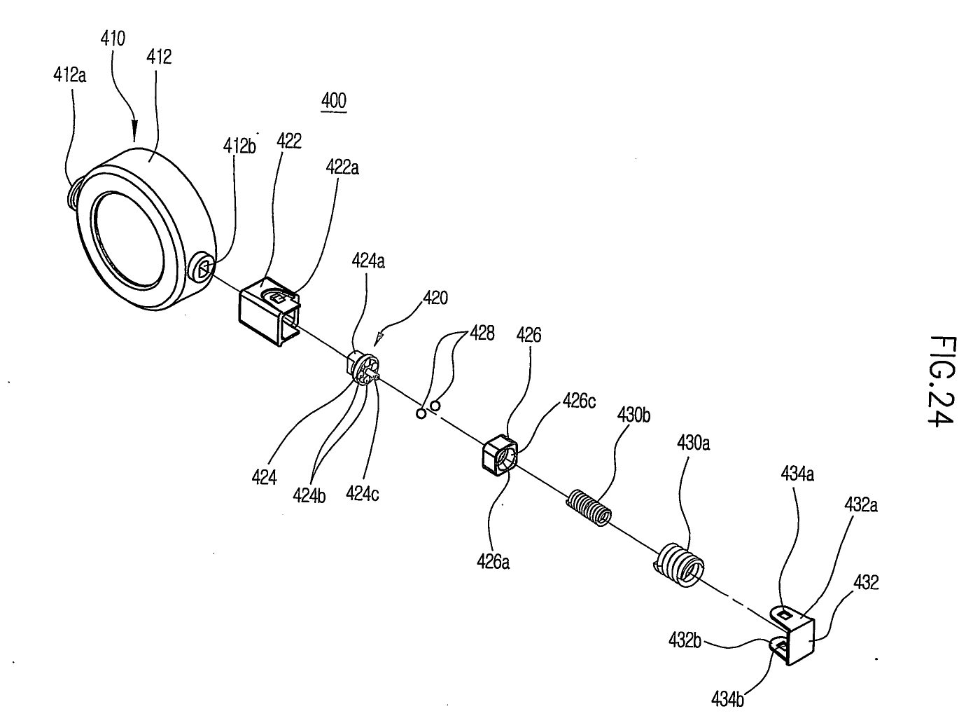

FIG. 24 is an exploded perspective view of the hinge assembly 400 according to the fourth embodiment of the present invention.

As shown in FIG. 24, the hinge assembly 400 according to the fourth embodiment of the present invention comprises a first hinge 410 and a second hinge 420. The first hinge 410 is mounted to an end of one article (not shown) to support the one article so that the one article can horizontally rotate with respect to the other article. The second hinge 420 is mounted to the other article so that it can rotate with centering on the axis perpendicular to the rotational axis of the first hinge 410 mounted to the one article and thereby the one article can rotate with respect to the other article.

The first hinge 410 includes a cylindrical shaped body 412. Hollow projections 412a,412b that is opposite with each other are formed at an outer peripheral surface of the body 412. One 412a of the hollow projections 412a,412b has a circular shape cross-sectional surface and the other 412b has a rectangular shaped inner surface.

The distal end of the driving cam shaft 424a of the second hinge 420 is forcibly inserted into the hollow projection 412b having a rectangular shaped inner surface.

The second hinge 420 comprises a housing 422, a driving cam 424, which is arranged inside of the housing 422, which its one end is firmly coupled with the hollow projection 412b of the body 412, a driven cam 426, which is arranged inside of the housing 422, and engaged with the driving cam 424, pluralities balls 428 disposed between the driving cam 424 and the driven cam 426 so as to make the driving cam 424 to rotate against the driven cam 426, at least coil springs 430a,430b for elastically supporting the driven cam 426 within the housing 422, and a cover 432 for preventing the above elements from being obviated from the housing 422.

The housing 422 of the second hinge 420 has a rectangular shape of cross section and is provided with the open end and the close end. A through hole is formed at the close end of the housing 422.

A combining projection 422a for fixing the cover 432 is formed at both walls extending toward the close end from the open end of the housing 422.

On the one surface of the driving cam 424 of the second hinge 420, pluralities of grooves 424b having a hemisphere shape are formed. On the other surface of the driving cam 424, a driving cam shaft 424a extends at a predetermined distance.

Preferably, four grooves 424b having a hemisphere shape are formed at the one surface of the driving cam 424 and they are arranged at 90°. Meanwhile, a shaft 424c having a predetermined distance protrudes from the center of the one surface of the driving cam 424.

The driving cam shaft 424a has a rectangular shape of cross section, which is the same as that of the hollow projection 412b of the body 412.

The driving cam 424 of the second hinge 420 is a hexahedron, on which grooves 426b having a hemisphere shape are formed at the one surface of the driving cam 424. At this time, the number of the grooves 426b is the same as that of the grooves 424b. A through hole 426a is formed at the center of the driven cam 426 and a shaft 424c protruding from the center of the one surface of the driving cam 424 passes there through.

A groove 426c for receiving the coil springs 430a,430b is formed at the other surface of the driven cam 426 of the second hinge 420.

The coil springs 430a,430b have different diameter and elastic force, respectively. In the groove 426c of the driven cam 426, the coil spring 430b having the smallest diameter is inserted into the coil spring 430a having the biggest diameter.

The cover 432 is formed by folding a metal plate, and the cross sectional area of the center thereof is the same as that of the housing 422. Through holes 434a,434b are formed at the extension portion 432a,432b formed at both peripheral surfaces of the center portion. The engage projection 422a formed at the side wall of the housing 422 passes through the through holes 434a,434b.

The pluralities balls 428 disposed between the driving cam 424 and the driven cam 426 are made of a synthetic resin and has the same radius curvature as that of the grooves 424b,426b formed at one surface of the driving cam 424 and the driven cam 426. Preferably, the number of the balls 428 is four.

Furthermore, the ball 428 is attached and fixed in the groove 426b of the driven cam 426 by using adhesives.

The hinge assembly 400 according to the fourth embodiment of the present invention constituted as the above is assembled with the following steps.

First, the driving cam 424 is inserted into the housing 422 of the second hinge 420. At this time, the cam shaft 424a of the driving cam 424 passes through the through hole formed at the close end of the housing 422.

Next, the driven cam 426 is inserted into the housing 422 so that the ball 428 attached to the driven cam 426 is inserted into the groove 424b formed at the one surface of the driving cam 424.

Thereafter, the coil springs 430a,430b are disposed in the housing 422 so that the one ends of the coil springs 430a,430b are inserted into the groove 426c formed at the other surface of the driven cam 426.

Finally, the second hinge 420 is engaged with the body 412 by forcibly inserting the distal end of the cam shaft 424a of the driving cam 424 into the hollow projection 412b formed at the outer peripheral surface of the body 412.

In the hinge assembly 400 according to the fourth embodiment of the present invention, the driving cam 424 of the second hinge 420 rotates at an angle of 90° against the driven cam 426. Since the pluralities balls 428 are arranged at 90° between the driving cam 424 and the driven cam 426, one of the balls 428 may move from one of the grooves 424b to another of the grooves 424b within the range of 90° angle.

Under the state that the second hinge 420 is mounted to the one article and the body 412 is mounted to the other article, if the body 412 is connected to the above one article so as to connect it with the second hinge 420, it is possible to rotate the above one article against the other article at 360° in the horizontal direction and at 180° in the vertical direction.

Hereinafter, we are explaining about the hinge assembly 400 according to the fourth embodiment of the present invention and the portable terminal 4000 having the same.

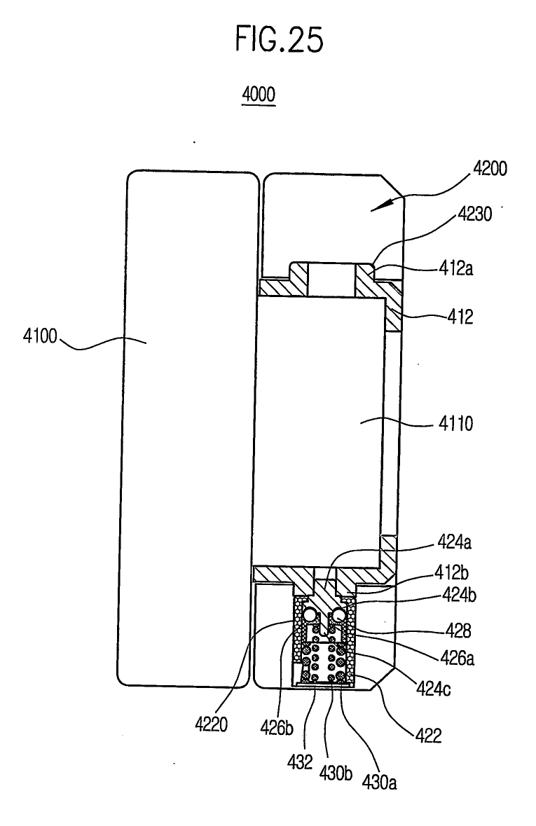

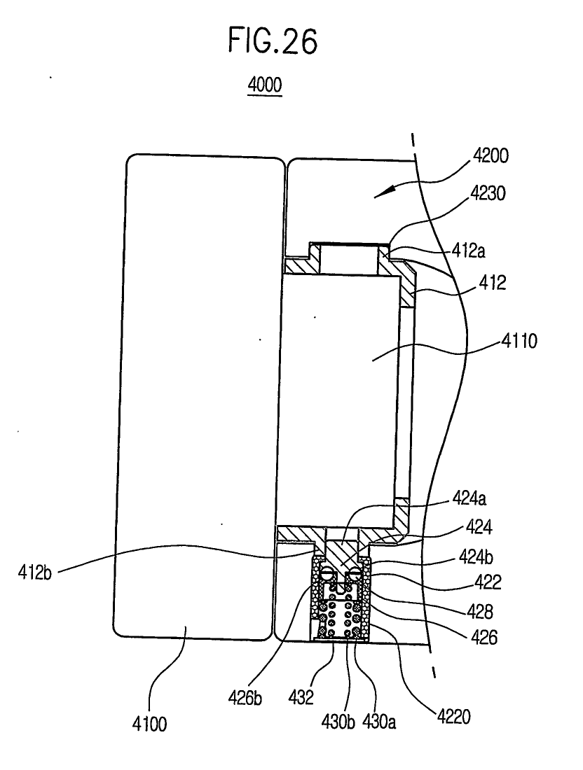

FIG. 25 is a partial sectional view of the portable terminal 4000 having the hinge assembly 400 according to the fourth embodiment of the present invention, for showing the close state of the folder. FIG. 26 is a partial sectional view of the portable terminal 4000 having the hinge assembly 400 according to the fourth embodiment of the present invention, for showing the open state of the folder.

As shown in FIGS. 25 and 26, the portable terminal 4000 mounted with the hinge assembly 400 according to the fourth embodiment of the present invention comprises: a main body 4100 mounted with a key pad (not illustrated), a mike phone (not illustrated) and a battery (not shown); a folder 4200 mounted to be rotatable with respect to the main body 4100 horizontally and vertically and having a speaker phone (not illustrated) and a display panel (not illustrated); and a hinge assembly 400 to rotate the folder 4200 with respect to the main body 4100 horizontally and vertically, the hinge assembly 400.

A mounting portion 4110 for mounting the body 412 of the hinge assembly 400 is formed at one surface of the main body 4100.

The mounting portion 4110 has a circular-shaped sectional area. The diameter and the height of the mounting portion 4110 are the same as those of the body 412.

The body receiving portion 4210 is formed at one end of the folder 4200 and is recessed toward the inner side of the folder 4200 so that it is correspond to the semi-circle portion of the mounting portion 4110 of the main body 4100.

On the end of a rotational body receiving portion 4210 of the folder 4200, a fixing portion for mounting the second hinge 420 of the hinge assembly 400 is formed. On the other end of the rotational body receiving portion 4210 of the folder 4200, a circular groove 4230 for rotatably receiving the projection 412a having the biggest diameter of the hollow projections 412a,412b of the rotational body 412 is formed.

The sectional shape of the fixing portion 4220 is the same as that of the housing 422 of the second hinge 420.

The hinge assembly 400 according to the fourth embodiment of the present invention constituted as the above is assembled with the following steps.

First, the second hinge 420 of the hinge assembly 400 is mounted to the fixing portion 4220 of the folder 4200. At this time, the driving cam shaft 424a protruding from the housing 422 of the second hinge 420 is inserting into the rotational body receiving portion 4210 of the folder 4200.

Next, the rotating body 412 is placed to the rotating body storing part 412 of the folder 4200. Afterward, the projection 412b having a rectangular-shaped hollow part among the projections (412a, 412b) formed on the outside surface of the rotating body (412) is placed to correspond to the end of the driving cam shaft (424a) of the second hinge, and the outside surface of the rotating body (412) is placed to be adjoined with the cylindrical surface of the rotating body storing part (4210)

Thereafter, the projection (412b) of the rotating body (412) is inserted to the fixed part (4220) formed on one end of the folder (4200) and the other projection (412a) is inserted to the round-shaped groove (4230) formed on the other end of the folder (4200) so the rotating body (412) is combined with the folder (4200),

The folder (4200) combined with the rotating body (412) according to the above steps, becomes enable to rotate centering on the axis which is extended passing the center of the two projections (412a, 412b) of the rotating body (412).

After combining the rotating body (412) to the folder (4200), the housing (422) of the second hinge (420) is pressed facing the projection (412b) of the rotating body (412), while arranging the driving cam shaft (424a) mounted on the fixed part (4220) of the folder (4200) to be consistent with the cross shape of the projection (412b) of the rotating body (412).

As a result, the end of the driving cam shaft (424a) of the second hinge (420) is firmly combined by forcing to be fit into the projection (412b) of the rotating body (412).

Finally, the rotating body 412 having the folder 4200 is rotatably mounted to the mounting portion 4110 formed at the body 4100 of the portable folder 4000.

Hereinafter, based on the attached drawings, we are explaining about the function and the effect of the hinge assembly (400) according to the fourth embodiment of the present invention and the portable terminal (4000) having the same.

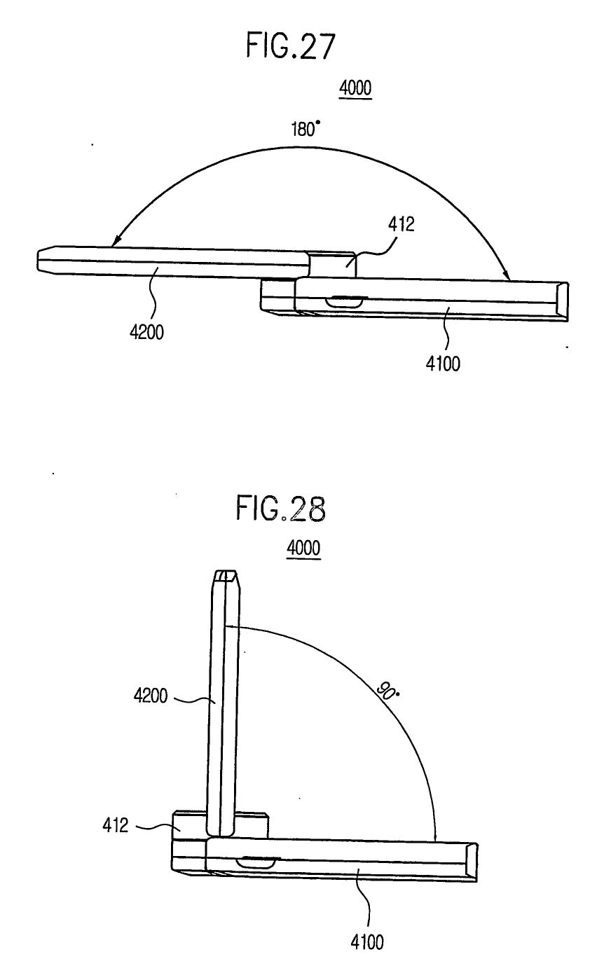

By referring to FIGS. 27 and 28, one can understand that the folder (4200) of the portable terminal (4000) can be rotated with respect to the axis which is extended passing through the center of the two projections (412a, 412b) of the rotating body (412) combined with the body (4100).

As stated above, since each of the hemispherical grooves (426a, 426b) and a plurality of balls (428) are formed and attached to be at right angle to the driving cam (424) and driven cam of the second hinge (420), which are mounted on the folder (4200), the balls (428) and the hemispherical groove (424b, 426b) become adjoined whenever they rotate at right angle.

However, the maximum rotating angle of the folder (4200) is limited to 180°, because if the folder rotates at an angle of 180°, the other surface of the folder (4200) adjoins with one surface of the main body (4100) and it cannot rotate anymore.

Meanwhile, at the time of rotating with respect to the main body (4100) of the portable terminal (4000), the driving cam of the second hinge (420) does not rotate since its shaft is combined with the rotating body (412). Instead, the driven cam (426) of the second hinge (420) and the housing (422) become in a body and rotate with the folder (4200).

Therefore, if the driven cam (426) of the second hinge (420) rotates, a plurality of balls (428) stored in the hemispheric groove (424b) of the driving cam (424) come out of the hemispheric groove (424b) and adjoin the partition between the hemispheric groove (424b).

At this point, the driven cam (426), as the balls (428) adjoin the partition between the hemispheric grooves (424b), is pushed out to the cover (432) of the housing (422) by the driving cam (424).

Next, when the folder is open by external force to the folder (4200), the plurality of balls (428) move into the hemispheric groove (424b) next to the partition and inserted. The balls (428) inserted to the hemispheric groove (424b) adhere closely by elastic force of the coil spring arranged between the driven cam (426) and the cover (432).

Accordingly, if applying external force to the folder (4200) so that the folder does not rotate any more, the folder becomes in the stopped state by close adherence force between the balls (428) and the hemispheric groove (424b).

As stated above, the folder of the portable terminal (4000) can be rotated with respect to the main body (4100) with an angle unit of 90° and can be stopped by the second hinge (420) of the hinge assembly (400).

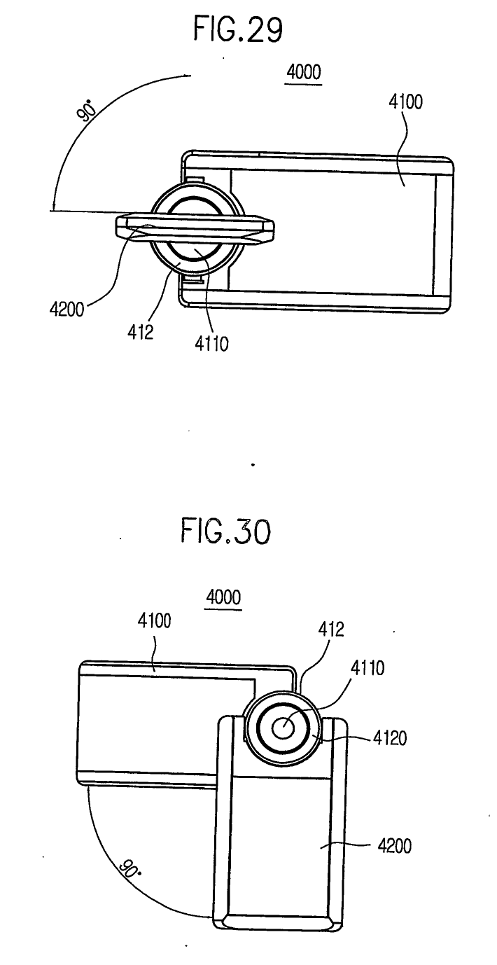

By referring to FIGS. 29 and 30, one can understand that the folder (4200) of the portable terminal (4000) can rotate horizontally with respect to the main body (4000) at an angle of 360° in a clockwise rotation and counter clockwise rotation. In addition, one can also understand that the folder (4200) can stand at right angle to the body vertically and can rotate horizontally with respect to the main body (4100).

That is because the rotating body (412) is mounted on the main body (4100) so that it can rotate at an angle of 360°, further, the folder is combined to become rotatable centering on the axis of the two projections (412a, 412b) of the rotating body (412) while the second hinge (420) of the hinge assembly (400) is combined with the projections (412a, 412b) of the rotating body (412) to become rotatable.

As stated above, the hinge (400) according to the fourth embodiment of the present invention and the portable terminal (4000) comprising the same, have the merits of circling the folder with respect to the main body at an angle of 180° with the angle unit of 90° and rotating the folder horizontally with respect to the main body at an angle of 360°.

In addition, this invention has the merit of circling the folder with respect to the main body at an angle of 180° with the angle unit of 90° and rotating the folder with respect to the main body at an angle of 360° horizontally in a clockwise and count clockwise rotation.

Hereinafter, we are explaining the hinge assembly (500) according to the fifth embodiment of the present invention.

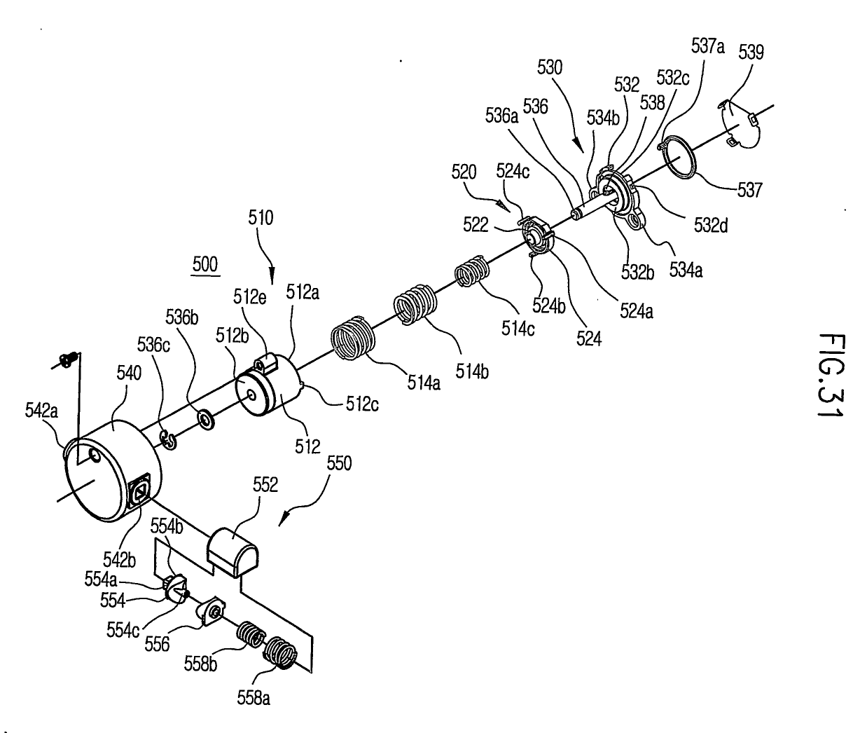

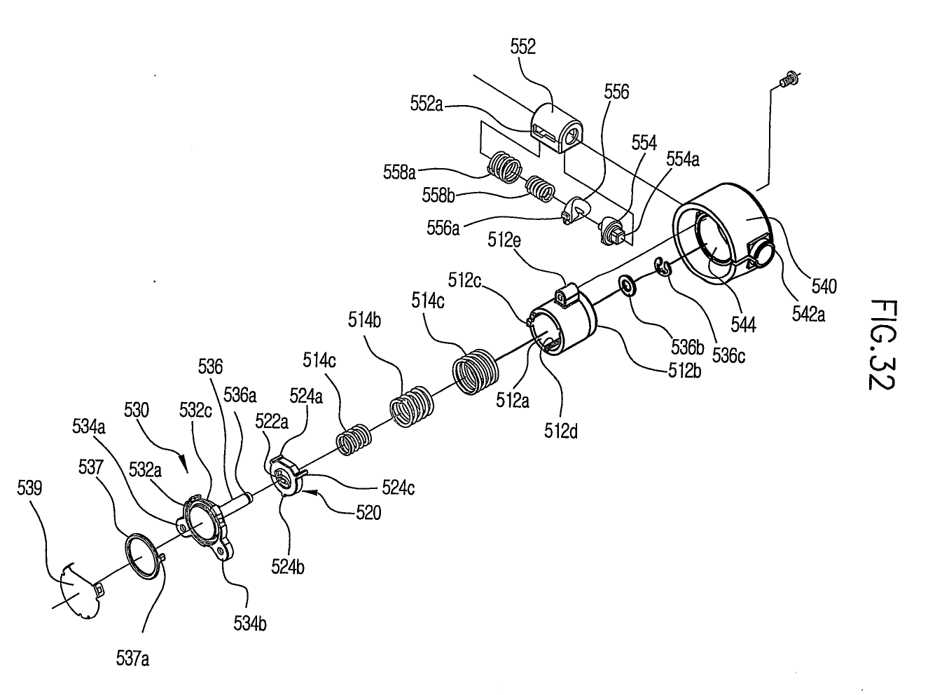

FIG. 31 is a perspective view of the hinge assembly (500) according to the fifth embodiment of the present invention, showing the driving cam of the hinge shaft, and FIG. 32 is a view showing the inside of the housing by rotating the hinge assembly (500) of FIG. 31 at an angle of 180°.

As FIGS. 31 and 32 show, the hinge assembly (500) according to the fifth embodiment of the present invention comprises:

a first hinge (510) mounted on one article (not illustrated) to rotate vertically with respect to one side of the article while supporting another article (not illustrated); and a second hinge (550) mounted on another article to rotate centering on an axis which is vertical against the rotating axis of the first hinge (510) mounted on one article, and rotates said another article with respect to said one article centering on the vertical axis.

The first hinge (510) comprises a housing (512), a plurality of elastic members (514a, 514b, 514c) stored in the housing (512), a cam disc (520) arranged in the housing to be capable of moving sliding inside of the housing (510), and a hinge shaft (530) fixed said one article, extended penetrating the cam disc (520), the elastic members (514, 514b, 514c) and the housing (510), and having the driving cam (538).

The first hinge (510) further comprises a coupling member (540) combined therewith for connecting said one article to said another article.

The hinge shaft (530) comprises a disc-shaped body part (532), flange parts (534a, 534b) formed in the body part and for fixing the hinge shaft (530) to said one article, a shaft part (536) extended from one side of the body part (532) and a driving cam (538) formed on the outside surface of the shaft part (536), which is in contact with the body part (532).

The body part (532) of the hinge shaft (530) is a round-shape, forming an annular groove (532a) for storing the stopper ring (537), which is mentioned later, in its one side, and forming a round-shaped wall part in another side. The flanges (534a, 534b) are formed at predetermined intervals in the outside surface of the round-shaped wall part of the body part (532)

In each of the flanges (534a, 534b), a through hole, to which a screw is extended penetrating for fixing the hinge shaft (530) to said one article, is formed.

In the body part (532) of the hinge shaft (530) in which the round-shaped wall, a round-shaped supporting board (532b). In the center of the round-shaped supporting board (532b), the shaft part (536) of a real axis is extended to a predetermined length there from.

In the shaft part (536), the driving cam (538) is formed on the cylindrical surface in contact with the circular supporting board (532b). In addition, in the end of the shaft part (536), an annular groove (536a) is formed. A snap ring (536c) is mounted on the annular groove (536a).

Meanwhile, the wall of the circular body part (532) forms a sliding groove (532c) by some parts being cut, and in the sliding groove (532c), a projection (537a) of the stopper ring, which is mentioned later, is arranged to be capable of sliding.

In addition, the outside surface of the wall of the circular body part (532), a projection (532d) is formed to be arranged at an angle of 1200. The flange of the cover (539) for protecting the stopper ring (537), which is described below, is combined with the projection.

The cam disc (520) comprises a cylindrical part (522) having the driven cam (522a) engaged with the driving cam (538) of the hinge shaft (530) therein, and the flange part (524) having a skirt, which is formed as a radial shape in one end of the cylindrical part (522) and is extended towards the other end of the cylindrical part (522).

In the center of the cylindrical part (522) of the cam disc (520), a penetrating hole to which the shaft part (536) of the hinge shaft (510) is extended penetrating. The driven cam (522a) formed in the cylindrical part (522) is spirally formed from the lower surface of the cylindrical part (522) to one end centering the axis line of the cylindrical part (522), and each apex thereof is projected to the outside of the end of the cylindrical part (522). The apexes limit the cam storing groove for storing the driving cam (538) of the hinge shaft (530) there between.

The spiral driven cam (522a) is formed to be symmetrical with the axis line of the cylindrical part (522).

Meanwhile, in the circumference surface of the skirt part formed in the flange part (524) of the cam disc (520), projections (524a, 524b, 524c) are formed at an angle of 120°, and are extended passing the end of the skirt, as FIG. 31 shows.

The elastic member comprises a first, second and third coil spring (514a, 514b, 514c), and each coil spring has predetermined elastic force. In addition, each coil spring (514a, 514b, 514c) has different diameter.

Regarding the size of the coil springs (514a, 514b, 514c), the first coil spring (514a) has the biggest diameter, and the second coil spring has the following diameter (514b), and the third coil spring (514c) has the smallest diameter.

The housing (512) comprises an open end and a close end, wherein a predetermined length of projection (512c) along the shaft line of the housing (512) is formed in the open end.

A through hole is formed in the close end of the housing (512), and the end of the shaft part (536) of the hinge shaft (530) is extended through the through hole.

Meanwhile, a guide recess (512d) is formed with centering in the longitudinal axis of the housing (512) in the inner peripheral of the housing (512). When assembling, the projections (524a, 524b and 524c) formed in the skirt part of the cam disc (520) are arranged in the guide recess (512d) so that the they can be moved glidingly.

On the outer peripheral surface of the housing (512), a flange (512e) is formed for fixing the housing (512) to the coupling member (540) in the place adjacent to the close end (512b). A through hole with which a screw is couple is formed on the flange (512e).

Further, the hinge assembly (500) comprises a snap ring (536c), which is mounted on the shaft part (536) extending through the housing (512), for preventing the hinge shaft (530) going away from the housing (512) The snap ring (536c) is mounted on an annular recess (536a) formed on the end of the shaft part (536) of the hinge shaft (530), which extends through the close end (513b) of the housing (512).

In addition, the hinge assembly (500) comprises an annular ring (536b), which is arranged between the close end (512b) of the housing and the snap ring (536c), to reduce the friction between the close end (512b) and the snap ring (536c).

A predetermined size of washer can be used as the annular ring (536b) put on the sale.

The second hinge (550) comprises: a housing (552) mounted on the other one article; a driving cam (554) disposed in the housing 552, one end of the driving cam 554 being firmly engaged with one 542b of the projections 542a,542b of the coupling member 540, in which a cam is formed at the other end of the driving cam 554; a driven cam 556 disposed in the housing 552 and engaged with the driving cam 554; and at least one elastic members 558a,558b for elastically supporting the driven cam 556, which is disposed between the driven cam 556 and one wall of the housing 552 within the housing 552.

The housing (552) has an open end and a close end, and a through hole through which the cam shaft extends is formed on the open end. Meanwhile, a guide hole (552a) is formed on one side of wall of the housing (552). A projection (556a) of the driven cam (556) mentioned below is inserted to the guide hole (552a) to be moved glidingly.

The driving cam (554) comprises a cam (554b) having a convex block shape and a coupled projection (554c) in the center thereof, and a cam shaft (554a) extended from one side of the cam (554b). The driving cam (554) is arranged inside of the housing (552) so that the cam shaft (554a) can extend through the through hole formed on the open end of the housing (552).

The driven cam (556) has a concaved block shape and a through hole (556b) is formed in the center thereof. Further, on the outer peripheral surface of the driven cam (556), a projection (556a) is formed opposing each other. At the time of arranging the driven cam (556) on the housing (552), each projection (556a) is inserted into the guide hole (552a) formed on the side wall of the housing (552) so that it can move glidingly. The driven cam (556) is arranged inside of the housing so that the concave block thereof can be engaged with the convex block of the driving cam (554)

The elastic member comprises a number of coil springs (558a, 558b). The coil springs (558a, 558b) have different diameters and elasticity. The elastic member (558a, 558b) is arranged between the driven cam (556) and the close end of the housing (552), so an end is adjacent to the driven cam (556) and the other end is adjacent to the close end of the housing and supported.

The coupling member (540) is cylindrical having an open end and a close end, and having a cylindrical part (544), which is stored and coupled with the close end of the housing (512) of the first hinge (510) inside area thereof.

On the surface of the close end of the coupling member (540), a through hole is formed on the place offset from the center thereof at a predetermined distance. The through hole is coaxially aligned with the through hole of the flange 512e formed at the housing 512 of the fist hinge 510 to be engaged with the cylindrical part (544).

Hollow projections 542a,542b that are opposite with each other are formed at an outer peripheral surface of the coupling member 540. One 542a of the hollow projections 542a,542b has a circular shape cross-sectional surface and the other 542b has a rectangular shaped inner surface.

The distal end of the driving cam shaft 424a of the second hinge 420 is forcibly inserted into the hollow projection 412b having a rectangular shaped inner surface.

The hinge assembly 500 according to the fifth embodiment of the present invention constituted as the above is assembled with the following steps.

First, the assembling process of the first hinge 510 will be explained herein below.

The stopper ring 537 is disposed in the annular groove 532a formed at the one surface of the circular body 532 so that the projection 537a of the stopper ring 537 is positioned in the sliding groove 532c formed at the wall of the circular body 532 of the hinge shaft 530.

Next, the driven cam 426 is inserted into the housing 422 so that the ball 428 attached to the driven cam 426 is inserted into the groove 424b formed at the one surface of the driving cam 424.

Thereafter, the cover 539 is located onto the one surface of the circular body 532 of the hinge shaft 530 and the flange of the cover 539 is engaged with the projection 532d formed at the wall of the circular body 532. Accordingly, it is possible to prevent the stopper ring 537 from being obviating from the circular groove 532a of the circular body 532 of the hinge shaft 530.

Next, the cam disc 520 is mounted to the shaft portion 536 of the hinge shaft 530. At this time, the driving cam 538 of the hinge shaft 530 is contacted with the lower surface of the cylindrical part 522 of the cam disc 520.

Continuously, the first, the second and the third coil springs 514a,514b,514c are inserted into the housing 512, and the hinge shaft 530 is inserted into the housing 512 so that the cam disc 520 is contacted with the coil springs 514a,514b,514c.

At this time, the projections 524a,524b,524c formed at the outer peripheral surface of the cam disc 520 are slideably disposed in the guide groove 512d formed at the inner peripheral surface of the housing 512.

In the meantime, the shaft portion 536 of the hinge shaft 530 passes through the closing springs 514a,514b,514c and the close end 512b of the housing 512. Furthermore, the support member 532b of the hinge shaft 530 is engaged in the opening of the housing 512.

Thereafter, the annular ring 536b such as a washer may be disposed at the distal end of the shaft portion 536 of the hinge shaft 530 passing through the close end 512a of the housing 512. The snap ring 536c is mounted in the annular groove 536a formed at the distal end of the shaft portion 536.

Second, the assembling process of the second hinge 550 will be explained herein below.

The driving cam 554 is inserted into the housing 552. At this time, the cam shaft 554a of the driving cam 554 passes through the through hole formed at the open end of the housing 552.

The driven cam 556 is inserted into the housing 552 so that the depressed cam is engaged with the bulging cam of the driving cam 554. At this time, the projection 554c of the driving cam 554 passes through the through hole formed at the center of the driven cam 556.

Finally, the coil springs 558a,558b are disposed between the driven cam 556 and the close end of the housing 552 so that the driven cam 556 is elastically supported by the coil springs 558a,558b.

Then, the first hinge 510 and the second hinge 550 assembled as described above are engaged with the coupling member 540.

When the hinge 510 has been assembled with the coupling member 540, the close end 512b of the housing 512 is inserted into the cylindrical part 544 formed at the inner space of the coupling member 540. At this time, the through hole formed at the outer peripheral surface of the housing 512 of the first hinge 510 is coaxially aligned with the through hole formed at the close end of the coupling member 540.

Thereafter, the first hinge 510 is engaged with the coupling member 540 by inserting the screw through the through hole of the coupling member 540 into the through hole formed at the flange 512e of the housing 512.

The second hinge 550 is engaged with the coupling member 540 by forcibly inserting the cam shaft 554a of the driving cam 554 into the projection 542b having the sectional shape as the same as that of the cam shaft 554a.

In the hinge assembly 500 according to the fifth embodiment of the present invention, the one article can horizontally and vertically rotate with respect to the other article by fixing the first hinge to the one article and combining the second hinge to the other article.

Hereinafter, we are explaining about the hinge assembly 500 according to the fourth embodiment of the present invention and the portable terminal 5000 having the same.

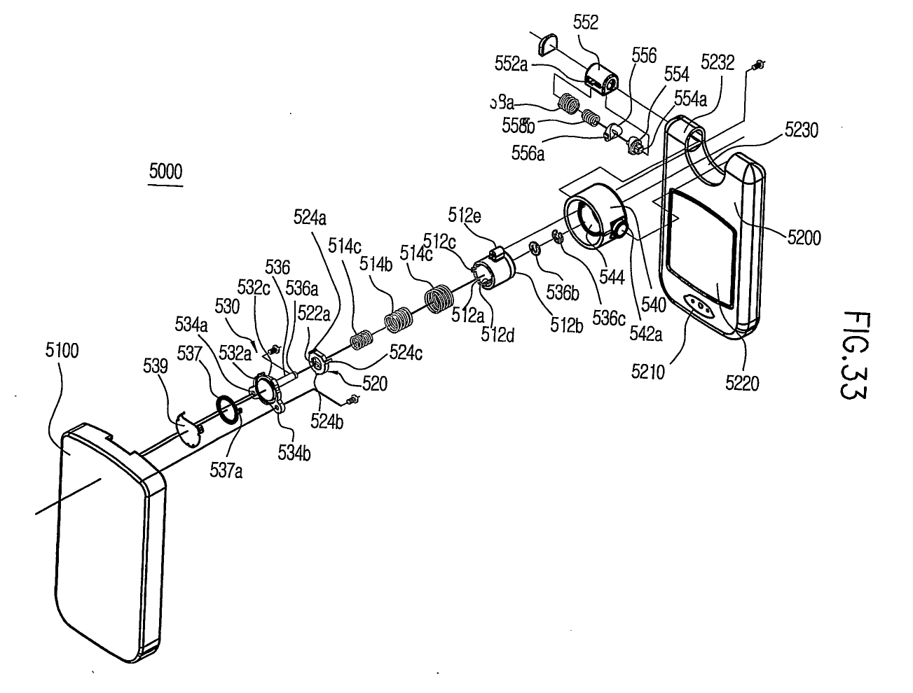

FIG. 33 is an exploded perspective view of the portable terminal 5000 having the hinge assembly 500 according to the fifth embodiment of the present invention.

As shown in FIG. 33, the portable terminal 5000 comprises: a main body 5100 mounted with a key pad (not illustrated), a mike phone (not illustrated) and a battery (not shown); a folder 5200 mounted to be rotatable with respect to the main body 5100 horizontally and vertically and having a speaker phone 5210 and a display panel 5220; and a hinge assembly 500 to rotate the folder 5200 with respect to the main body 5100 horizontally and vertically.

The first groove 5110 for receiving the hinge shaft 530 of the fist hinge 510 and the second groove 5120 for receiving a part of the housing 512 of the fist hinge 510 and a part of the coupling member 540 are formed at the main body 5100.

The hinge shaft 530 is fixedly engaged in the first groove 5110 of the main body 5100. The housing 512 and the coupling member 540 are rotatably disposed in the second groove 5120 of the main body 5100.

The coupling member receiving part 5230 is formed at the one end of the folder 5200. The coupling member receiving part 5230 is depressed toward the inner side of the folder 5200 so that it is correspond to the semi-circle portion of the coupling member 540.

One of the ends of the coupling member receiving part 5230 of the folder 5200, a fixing portion for mounting the second hinge 550 of the hinge assembly 500 is formed. On the other end of the coupling member receiving part 5230, a circular groove 5234 for rotatably receiving the projection 542a having the biggest diameter of the hollow projections 542a,542b of the coupling member 540 is formed.

The cross sectional shape of the fixing portion 5232 is the same as that of the housing 552 of the second hinge 550.

Hereinafter, based on the attached drawings, we are explaining about the function and the effect of the hinge assembly 500 according to the fifth embodiment of the present invention and the portable terminal 5000 having the same.

First, the assembling process of the portable terminal 5000 will be explained herein below.

The first hinge 510 assembled as described above is disposed in the grooves 5110,5120 formed at the main body 5100. At this time, the hinge shaft 530 of the first hinge 510 is positioned in the first groove 5110 of the main body 5100 and a part of the housing 512 of the first hinge 510 is aligned with the second groove 5120 of the main body 5100.

Thereafter, the first hinge 510 is engaged with the main body 5100 by inserting the screw through the through hole at the flanges 534a,534b of the hinge shaft 530.

Then, the housing 512 of the first hinge 510 is inserted into the cylindrical part 544 of the coupling member 540. The housing 512 is aligned with the coupling member 540 such that the through hole formed at the flange 512e of the housing 512 is coaxially aligned with the through hole formed at the close end of the coupling member 540.

The fist hinge 510 may be engaged with the coupling member 540 by inserting the screw through the through hole of the coupling member 540 into the through hole formed at the flange 512e of the housing 512.

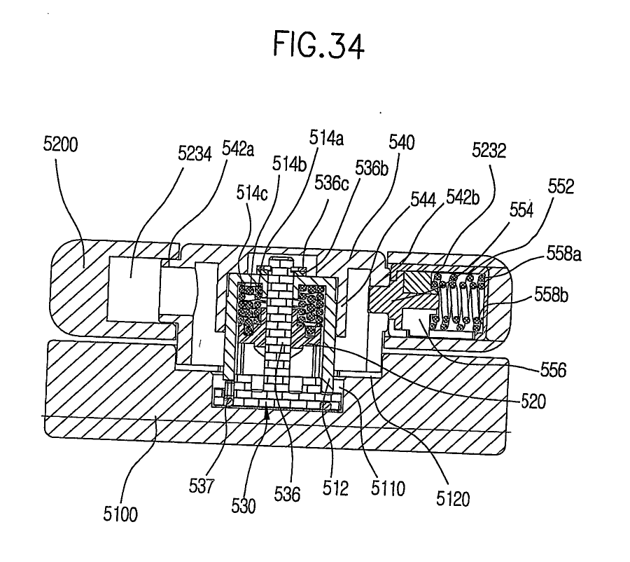

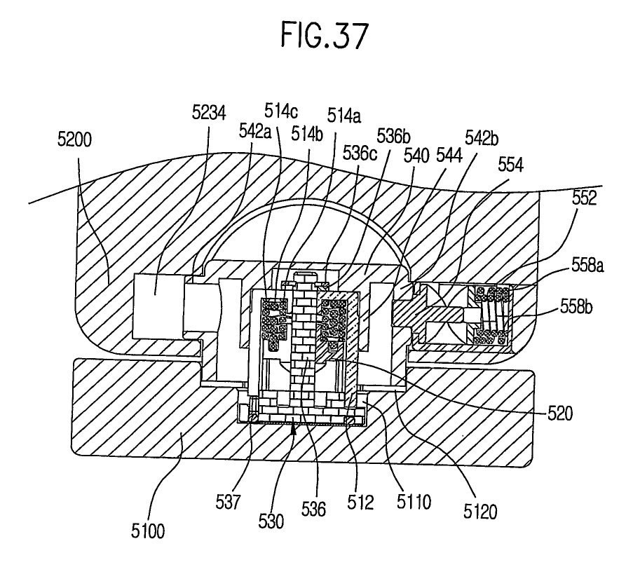

As shown in FIGS. 34 and 37, the coupling member 540 is engaged with the folder 5200 by inserting the projections 542a,542b of the coupling member 540 into the fixing portion 5232 and the circular-shaped groove 5234 formed at both end of the coupling member receiving part 5230.

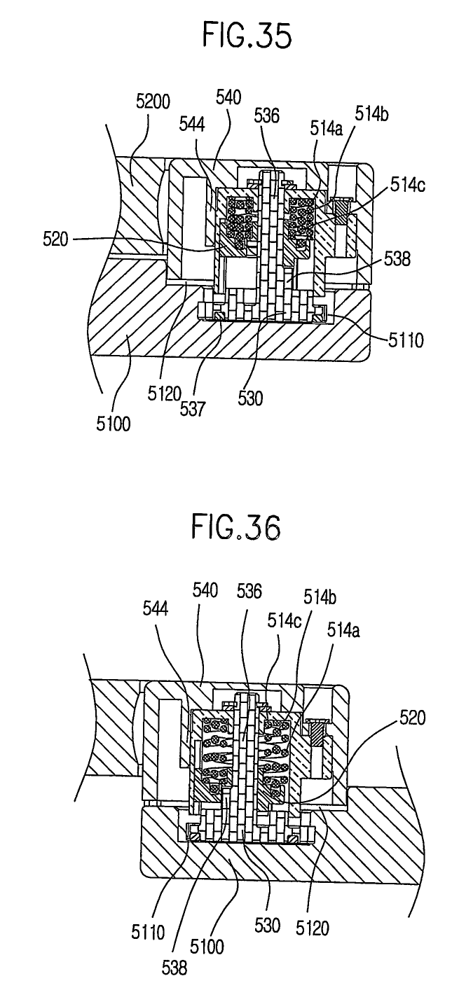

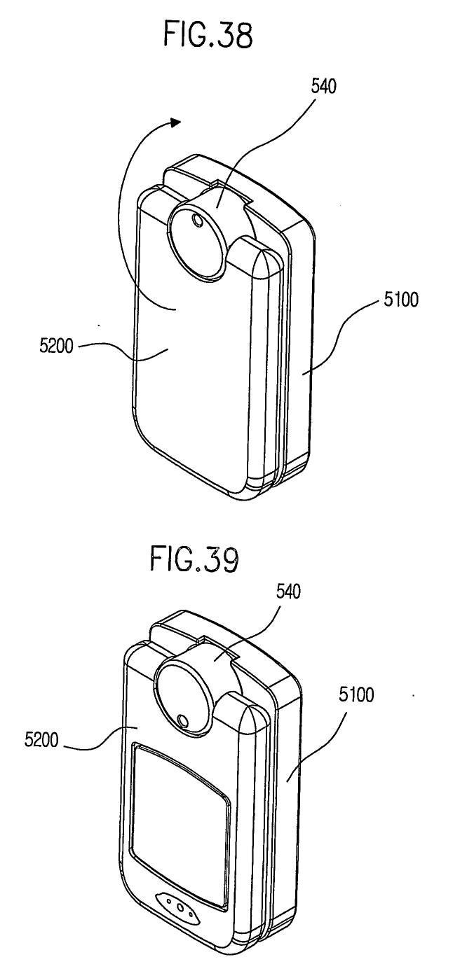

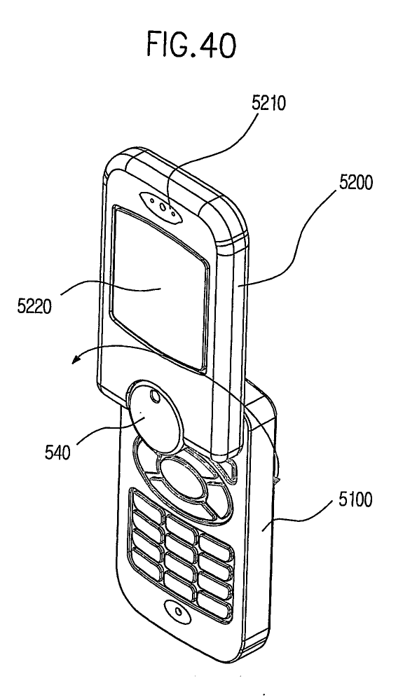

In the portable terminal 5000 assembled as described above, as shown in FIGS. 34 to 40, the driving cam 538 formed at the hinge shaft 530 of the first hinge 510 is located at the lower surface of the cylindrical part 522 of the cam disc 520, and the driving cam 554 of the second hinge 550 is engaged with the driven am 556.

When the folder 5200 is closed, the projection 537a disposed in the sliding groove 532c of the circular-shaped wall of the hinge shaft 530 is positioned opposing to the projection 512c formed at the open end of the housing 512.

Thereafter, if the folder 5200 of the portable terminal 5000 is open by rotating it against the main body 5100 in the horizontal direction, the housing 512 of the fist hinge 510 rotates together with the folder 5200. Accordingly, the driving cam 538 of the hinge shaft 530 moves along the driven cam 522a formed at the cylindrical part of the cam disc 520.

At this time, the cam disc 520 is pushed toward the close end of the housing 512 by means of the driving cam 538 of the hinge shaft 530. Since the projections 524a,524b,524c formed at the outer circumference surface of the skirt part are slideably disposed in the sliding groove 512d formed at the inner circumference surface of the housing 512, the cam disc 520 does not rotate together with the hinge shaft 530. Instead, the cam disc 520 moves along the longitudinal axis of the housing 512 toward the close end 512b.

When the folder 5200 is rotated in the horizontal direction due to continuous application of an outer force to the folder 5200, the driving cam 538 of the hinge shaft 530 moves to the cam receiving groove formed between the apexes of the driven cam 522a of the cam disc 520. Under this state, the folder 5200 has been rotated against the main body 5100 at 180°.

At this time, the projection 512c formed at the housing 512 of the first hinge 510 rotating together with the folder 5200 is contacted against the projection 537a of the stopper ring 537 disposed in the sliding groove 532c of the cylindrical wall of the hinge shaft 530. As a result, the projection 512c pushed the projection 537a toward in the rotational direction.

After moving along the sliding groove 532c at a predetermined distance by means of the projection 512c formed at the housing 512 of the first hinge 510, the projection 537a stops to move due to operation of the wall for defining the sliding groove 532c.

Accordingly, the housing 512 having the projection 512c contacting against the projection 537a of the stopper ring 537 also stops to rotate. As a result, the folder 5200 engaged with the housing 512 of the first hinge 510 by means of the coupling member 540 also stops to rotate.

If a user wants to close the open folder 5200 by rotating the folder 5200 in the horizontal direction, it is required to apply an external force to the folder 5200 in the forward or the reward directions so as to obviate the driving cam 538 of the hinge shaft 530 from the grooves between apexes of the driven cam 522a.

Thereafter, if additional force is applied to the folder 5200, the driving cam 538 of the hinge shaft 530 slides along the driven cam 522a of the cam disc 520 toward the lower surface of the cylindrical part 322.

At this time, since the driven cam 522a is tightly contacted with the driving cam 538 due to the elastic force of the coil springs 514a,514b,514c, the driving cam 538 smoothly slides along the driven cam 522a, and thereby the folder 5200 on which the housing 512 having the driven cam 522a is engaged smoothly is closed.

In the meantime, since the driven cam 522a is formed to be symmetrical with the axis line of the cylindrical part of the cam disc 520, it is possible to open or close the folder 5200 during rotation of the folder 5200 in the clockwise or counterclockwise direction.

When a user opens the folder 5200 by vertically pivoting with the centering on the central axis line of the projections 542a,542b of the coupling member 540 of the folder 5200, the housing 522 of the second hinge 550 mounted to the folder 5200 moves in the rotational direction of the folder 5200.

Accordingly, the driven cam 556 slideably disposed in the housing 552 of the second hinge 550 also rotates together with the folder 5200.

The compressed block of the driven cam 556 slides along the bulging block of the driving cam 552 during the rotation of the driving cam 556 and the housing 552. At this time, the driven cam 556 is pushed toward the close end of the housing 552 by means of the driving cam 554.

If the folder 5200 is continuously rotated with the centering on the central axis line of the projections 542a,542b of the coupling member 540, the apex of the compressed block of the driven cam 556 is contacted against the apex of the bulging block of the driving cam 554 and thereby the driven cam 556 is pushed toward the close end of the housing 552 to the maximum. Accordingly, the coil springs 558a,558b for supporting the driven cam 556 are compressed to the maximum.

If the folder 5200 is further rotated so as to fully open it, the compressed block of the driven cam 556 slides along the bulging block of the driving cam 554 and thereby the compressed portion of the driven cam 556 is contacted against the bulging portion of the driving cam 554.

If a user wants to close the folder 5200, it is required to rotate the folder 5200 in the reverse direction with centering on the central axis line extending between the projections 542a,542b of the coupling member 540, the apex of the compressed block of the driven cam 556 is contacted against the apex of the bulging block of the driving cam 554 and thereby the driven cam 556 is pushed toward the close end of the housing 552 to the maximum. Accordingly, the coil springs 558a,558b for supporting the driven cam 556 are compressed to the maximum.

Next, when the folder is open by external force to the folder (4200), the plurality of balls (428) move into the hemispheric groove (424b) next to the partition and inserted. The balls (428) inserted to the hemispheric groove (424b) adhere closely by elastic force of the coil spring arranged between the driven cam (426) and the cover (432).

Accordingly, if applying external force to the folder (4200) so that the folder does not rotate any more, the folder becomes in the stopped state by close adherence force between the balls (428) and the hemispheric groove (424b).

As stated above, the folder of the portable terminal (4000) can be rotated with respect to the main body (4100) with an angle unit of 90° and can be stopped by the second hinge (420) of the hinge assembly (400).

By referring to FIGS. 29 and 30, one can understand that the folder (4200) of the portable terminal (4000) can rotate horizontally with respect to the main body (4000) at an angle of 360° in a clockwise rotation and counter clockwise rotation. In addition, one can also understand that the folder (4200) can stand at right angle to the body vertically and can rotate horizontally with respect to the main body (4100).

That is because the rotating body (412) is mounted on the main body (4100) so that it can rotate at an angle of 360°, further, the folder is combined to become rotatable centering on the axis of the two projections (412a, 412b) of the rotating body (412) while the second hinge (420) of the hinge assembly (400) is combined with the projections (412a, 412b) of the rotating body (412) to become rotatable.

As stated above, the hinge (400) according to the fourth embodiment of the present invention and the portable terminal (4000) comprising the same, have the merits of circling the folder with respect to the main body at an angle of 180° with the angle unit of 90° and rotating the folder horizontally with respect to the main body at an angle of 360° In addition, this invention has the merit of circling the folder with respect to the main body at an angle of 180° with the angle unit of 90° and rotating the folder with respect to the main body at an angle of 360° horizontally in a clockwise and count clockwise rotation.

Hereinafter, we are explaining the hinge assembly (500) according to the fifth embodiment of the present invention.

FIG. 31 is a perspective view of the hinge assembly (500) according to the fifth embodiment of the present invention, showing the driving cam of the hinge shaft, and FIG. 32 is a view showing the inside of the housing by rotating the hinge assembly (500) of FIG. 31 at an angle of 180°.

As FIGS. 31 and 32 show, the hinge assembly (500) according to the fifth embodiment of the present invention comprises:

a first hinge (510) mounted on one article (not illustrated) to rotate vertically with respect to one side of the article while supporting another article (not illustrated); and a second hinge (550) mounted on another article to rotate centering on an axis which is vertical against the rotating axis of the first hinge (510) mounted on one article, and rotates said another article with respect to said one article centering on the vertical axis.

The first hinge (510) comprises a housing (512), a plurality of elastic members (514a, 514b, 514c) stored in the housing (512), a cam disc (520) arranged in the housing to be capable of moving sliding inside of the housing (510), and a hinge shaft (530) fixed said one article, extended penetrating the cam disc (520), the elastic members (514, 514b, 514c) and the housing (510), and having the driving cam (538).

The first hinge (510) further comprises a coupling member (540) combined therewith for connecting said one article to said another article.

The hinge shaft (530) comprises a disc-shaped body part (532), flange parts (534a, 534b) formed in the body part and for fixing the hinge shaft (530) to said one article, a shaft part (536) extended from one side of the body part (532) and a driving cam (538) formed on the outside surface of the shaft part (536), which is in contact with the body part (532).

The body part (532) of the hinge shaft (530) is a round-shape, forming an annular groove (532a) for storing the stopper ring (537), which is mentioned later, in its one side, and forming a round-shaped wall part in another side. The flanges (534a, 534b) are formed at predetermined intervals in the outside surface of the round-shaped wall part of the body part (532)

In each of the flanges (534a, 534b), a through hole, to which a screw is extended penetrating for fixing the hinge shaft (530) to said one article, is formed.

In the body part (532) of the hinge shaft (530) in which the round-shaped wall, a round-shaped supporting board (532b). In the center of the round-shaped supporting board (532b), the shaft part (536) of a real axis is extended to a predetermined length there from.

In the shaft part (536), the driving cam (538) is formed on the cylindrical surface in contact with the circular supporting board (532b). In addition, in the end of the shaft part (536), an annular groove (536a) is formed. A snap ring (536c) is mounted on the annular groove (536a).

Meanwhile, the wall of the circular body part (532) forms a sliding groove (532c) by some parts being cut, and in the sliding groove (532c), a projection (537a) of the stopper ring, which is mentioned later, is arranged to be capable of sliding.

In addition, the outside surface of the wall of the circular body part (532), a projection (532d) is formed to be arranged at an angle of 120°. The flange of the cover (539) for protecting the stopper ring (537), which is described below, is combined with the projection.

The cam disc (520) comprises a cylindrical part (522) having the driven cam (522a) engaged with the driving cam (538) of the hinge shaft (530) therein, and the flange part (524) having a skirt, which is formed as a radial shape in one end of the cylindrical part (522) and is extended towards the other end of the cylindrical part (522).

In the center of the cylindrical part (522) of the cam disc (520), a penetrating hole to which the shaft part (536) of the hinge shaft (510) is extended penetrating. The driven cam (522a) formed in the cylindrical part (522) is spirally formed from the lower surface of the cylindrical part (522) to one end centering the axis line of the cylindrical part (522), and each apex thereof is projected to the outside of the end of the cylindrical part (522). The apexes limit the cam storing groove for storing the driving cam (538) of the hinge shaft (530) there between.

The spiral driven cam (522a) is formed to be symmetrical with the axis line of the cylindrical part (522).

Meanwhile, in the circumference surface of the skirt part formed in the flange part (524) of the cam disc (520), projections (524a, 524b, 524c) are formed at an angle of 120°, and are extended passing the end of the skirt, as FIG. 31 shows.

The elastic member comprises a first, second and third coil spring (514a, 514b, 514c), and each coil spring has predetermined elastic force. In addition, each coil spring (514a, 514b, 514c) has different diameter.

Regarding the size of the coil springs (514a, 514b, 514c), the first coil spring (514a) has the biggest diameter, and the second coil spring has the following diameter (514b), and the third coil spring (514c) has the smallest diameter.

The housing (512) comprises an open end and a close end, wherein a predetermined length of projection (512c) along the shaft line of the housing (512) is formed in the open end.

A through hole is formed in the close end of the housing (512), and the end of the shaft part (536) of the hinge shaft (530) is extended through the through hole.

Meanwhile, a guide recess (512d) is formed with centering on the longitudinal axis of the housing (512) in the inner peripheral of the housing (512). When assembling, the projections (524a, 524b and 524c) formed in the skirt part of the cam disc (520) are arranged in the guide recess (512d) so that the they can be moved glidingly.

On the outer peripheral surface of the housing (512), a flange (512e) is formed for fixing the housing (512) to the coupling member (540) in the place adjacent to the close end (512b). A through hole with which a screw is couple is formed on the flange (512e).

Further, the hinge assembly (500) comprises a snap ring (536c), which is mounted on the shaft part (536) extending through the housing (512), for preventing the hinge shaft (530) going away from the housing (512)

The snap ring (536c) is mounted on an annular recess (536a) formed on the end of the shaft part (536) of the hinge shaft (530), which extends through the close end (513b) of the housing (512).

In addition, the hinge assembly (500) comprises an annular ring (536b), which is arranged between the close end (512b) of the housing and the snap ring (536c), to reduce the friction between the close end (512b) and the snap ring (536c).

A predetermined size of washer can be used as the annular ring (536b) put on the sale.

The second hinge (550) comprises: a housing (552) mounted on the other one article; a driving cam (554) disposed in the housing 552, one end of the driving cam 554 being firmly engaged with one 542b of the projections 542a,542b of the coupling member 540, in which a cam is formed at the other end of the driving cam 554; a driven cam 556 disposed in the housing 552 and engaged with the driving cam 554; and at least one elastic members 558a,558b for elastically supporting the driven cam 556, which is disposed between the driven cam 556 and one wall of the housing 552 within the housing 552.

The housing (552) has an open end and a close end, and a through hole through which the cam shaft extend is formed on the open end. Meanwhile, a guide hole (552a) is formed on one side of wall of the housing (552). A projection (556a) of the driven cam (556) mentioned below is inserted to the guide hole (552a) to be moved glidingly.

The driving cam (554) comprises a cam (554b) having a convex block shape and a coupled projection (554c) in the center thereof, and a cam shaft (554a) extended from one side of the cam (554b). The driving cam (554) is arranged inside of the housing (552) so that the cam shaft (554a) can extend through the through hole formed on the open end of the housing (552).

The driven cam (556) has a concaved block shape and a through hole (556b) is formed in the center thereof. Further, on the outer peripheral surface of the driven cam (556), a projection (556a) is formed opposing each other. At the time of arranging the driven cam (556) on the housing (552), each projection (556a) is inserted into the guide hole (552a) formed on the side wall of the housing (552) so that it can move glidingly. The driven cam (556) is arranged inside of the housing so that the concave block thereof can be engaged with the convex block of the driving cam (554)

The elastic member comprises a number of coil springs (558a, 558b). The coil springs (558a, 558b) have different diameters and elasticity. The elastic member (558a, 558b) is arranged between the driven cam (556) and the close end of the housing (552), so an end is adjacent to the driven cam (556) and the other end is adjacent to the close end of the housing and supported.

The coupling member (540) is cylindrical having an open end and a close end, and having a cylindrical part (544), which is stored and coupled with the close end of the housing (512) of the first hinge (510) inside area thereof.

On the surface of the close end of the coupling member (540), a through hole is formed on the place offset from the center thereof at a predetermined distance. The through hole is coaxially aligned with the through hole of the flange 512e formed at the housing 512 of the fist hinge 510 to be engaged with the cylindrical part (544).

Hollow projections 542a,542b that are opposite with each other are formed at an outer peripheral surface of the coupling member 540. One 542a of the hollow projections 542a,542b has a circular shape cross-sectional surface and the other 542b has a rectangular shaped inner surface.

The distal end of the driving cam shaft 424a of the second hinge 420 is forcibly inserted into the hollow projection 412b having a rectangular shaped inner surface.

The hinge assembly 500 according to the fifth embodiment of the present invention constituted as the above is assembled with the following steps.

First, the assembling process of the first hinge 510 will be explained herein below.

The stopper ring 537 is disposed in the annular groove 532a formed at the one surface of the circular body 532 so that the projection 537a of the stopper ring 537 is positioned in the sliding groove 532c formed at the wall of the circular body 532 of the hinge shaft 530.

Next, the driven cam 426 is inserted into the housing 422 so that the ball 428 attached to the driven cam 426 is inserted into the groove 424b formed at the one surface of the driving cam 424.

Thereafter, the cover 539 is located onto the one surface of the circular body 532 of the hinge shaft 530 and the flange of the cover 539 is engaged with the projection 532d formed at the wall of the circular body 532. Accordingly, it is possible to prevent the stopper ring 537 from being obviating from the circular groove 532a of the circular body 532 of the hinge shaft 530.

Next, the cam disc 520 is mounted to the shaft portion 536 of the hinge shaft 530. At this time, the driving cam 538 of the hinge shaft 530 is contacted with the lower surface of the cylindrical part 522 of the cam disc 520.

Continuously, the first, the second and the third coil springs 514a,514b,514c are inserted into the housing 512, and the hinge shaft 530 is inserted into the housing 512 so that the cam disc 520 is contacted with the coil springs 514a,514b,514c.

At this time, the projections 524a,524b,524c formed at the outer peripheral surface of the cam disc 520 are slideably disposed in the guide groove 512d formed at the inner peripheral surface of the housing 512.

In the meantime, the shaft portion 536 of the hinge shaft 530 passes through the closing springs 514a,514b,514c and the close end 512b of the housing 512. Furthermore, the support member 532b of the hinge shaft 530 is engaged in the opening of the housing 512.

Thereafter, the annular ring 536b such as a washer may be disposed at the distal end of the shaft portion 536 of the hinge shaft 530 passing through the close end 512a of the housing 512. The snap ring 536c is mounted in the annular groove 536a formed at the distal end of the shaft portion 536.

Second, the assembling process of the second hinge 550 will be explained herein below.

The driving cam 554 is inserted into the housing 552. At this time, the cam shaft 554a of the driving cam 554 passes through the through hole formed at the open end of the housing 552.

The driven cam 556 is inserted into the housing 552 so that the depressed cam is engaged with the bulging cam of the driving cam 554. At this time, the projection 554c of the driving cam 554 passes through the through hole formed at the center of the driven cam 556.

Finally, the coil springs 558a,558b are disposed between the driven cam 556 and the close end of the housing 552 so that the driven cam 556 is elastically supported by the coil springs 558a,558b.

Then, the first hinge 510 and the second hinge 550 assembled as described above are engaged with the coupling member 540.

When the hinge 510 has been assembled with the coupling member 540, the close end 512b of the housing 512 is inserted into the cylindrical part 544 formed at the inner space of the coupling member 540. At this time, the through hole formed at the outer peripheral surface of the housing 512 of the first hinge 510 is coaxially aligned with the through hole formed at the close end of the coupling member 540.

Thereafter, the first hinge 510 is engaged with the coupling member 540 by inserting the screw through the through hole of the coupling member 540 into the through hole formed at the flange 512e of the housing 512.

The second hinge 550 is engaged with the coupling member 540 by forcibly inserting the cam shaft 554a of the driving cam 554 into the projection 542b having the sectional shape as the same as that of the cam shaft 554a.

In the hinge assembly 500 according to the fifth embodiment of the present invention, the one article can horizontally and vertically rotate with respect to the other article by fixing the first hinge to the one article and combining the second hinge to the other article.

Hereinafter, we are explaining about the hinge assembly 500 according to the fourth embodiment of the present invention and the portable terminal 5000 having the same.

FIG. 33 is an exploded perspective view of the portable terminal 5000 having the hinge assembly 500 according to the fifth embodiment of the present invention.

As shown in FIG. 33, the portable terminal 5000 comprises: a main body 5100 mounted with a key pad (not illustrated), a mike phone (not illustrated) and a battery (not shown); a folder 5200 mounted to be rotatable with respect to the main body 5100 horizontally and vertically and having a speaker phone 5210 and a display panel 5220; and a hinge assembly 500 to rotate the folder 5200 with respect to the main body 5100 horizontally and vertically.

The first groove 5110 for receiving the hinge shaft 530 of the fist hinge 510 and the second groove 5120 for receiving a part of the housing 512 of the fist hinge 510 and a part of the coupling member 540 are formed at the main body 5100.

The hinge shaft 530 is fixedly engaged in the first groove 5110 of the main body 5100. The housing 512 and the coupling member 540 are rotatably disposed in the second groove 5120 of the main body 5100.

The coupling member receiving part 5230 is formed at the one end of the folder 5200. The coupling member receiving part 5230 is depressed toward the inner side of the folder 5200 so that it is correspond to the semi-circle portion of the coupling member 540.

One of the ends of the coupling member receiving part 5230 of the folder 5200, a fixing portion for mounting the second hinge 550 of the hinge assembly 500 is formed. On the other end of the coupling member receiving part 5230, a circular groove 5234 for rotatably receiving the projection 542a having the biggest diameter of the hollow projections 542a,542b of the coupling member 540 is formed.

The cross sectional shape of the fixing portion 5232 is the same as that of the housing 552 of the second hinge 550.

Hereinafter, based on the attached drawings, we are explaining about the function and the effect of the hinge assembly 500 according to the fifth embodiment of the present invention and the portable terminal 5000 having the same.

First, the assembling process of the portable terminal 5000 will be explained herein below.

The first hinge 510 assembled as described above is disposed in the grooves 5110,5120 formed at the main body 5100. At this time, the hinge shaft 530 of the first hinge 510 is positioned in the first groove 5110 of the main body 5100 and a part of the housing 512 of the first hinge 510 is aligned with the second groove 5120 of the main body 5100.

Thereafter, the first hinge 510 is engaged with the main body 5100 by inserting the screw through the through hole at the flanges 534a,534b of the hinge shaft 530.

Then, the housing 512 of the first hinge 510 is inserted into the cylindrical part 544 of the coupling member 540. The housing 512 is aligned with the coupling member 540 such that the through hole formed at the flange 512e of the housing 512 is coaxially aligned with the through hole formed at the close end of the coupling member 540.

The fist hinge 510 may be engaged with the coupling member 540 by inserting the screw through the through hole of the coupling member 540 into the through hole formed at the flange 512e of the housing 512.

As shown in FIGS. 34 and 37, the coupling member 540 is engaged with the folder 5200 by inserting the projections 542a,542b of the coupling member 540 into the fixing portion 5232 and the circular-shaped groove 5234 formed at both end of the coupling member receiving part 5230.

In the portable terminal 5000 assembled as described above, as shown in FIGS. 34 to 40, the driving cam 538 formed at the hinge shaft 530 of the first hinge 510 is located at the lower surface of the cylindrical part 522 of the cam disc 520, and the driving cam 554 of the second hinge 550 is engaged with the driven am 556.

When the folder 5200 is closed, the projection 537a disposed in the sliding groove 532c of the circular-shaped wall of the hinge shaft 530 is positioned opposing to the projection 512c formed at the open end of the housing 512.

Thereafter, if the folder 5200 of the portable terminal 5000 is open by rotating it against the main body 5100 in the horizontal direction, the housing 512 of the fist hinge 510 rotates together with the folder 5200. Accordingly, the driving cam 538 of the hinge shaft 530 moves along the driven cam 522a formed at the cylindrical part of the cam disc 520.

At this time, the cam disc 520 is pushed toward the close end of the housing 512 by means of the driving cam 538 of the hinge shaft 530. Since the projections 524a,524b,524c formed at the outer circumference surface of the skirt part are slideably disposed in the sliding groove 512d formed at the inner circumference surface of the housing 512, the cam disc 520 does not rotate together with the hinge shaft 530. Instead, the cam disc 520 moves along the longitudinal axis of the housing 512 toward the close end 512b.

When the folder 5200 is rotated in the horizontal direction due to continuous application of an outer force to the folder 5200, the driving cam 538 of the hinge shaft 530 moves to the cam receiving groove formed between the apexes of the driven cam 522a of the cam disc 520. Under this state, the folder 5200 has been rotated against the main body 5100 at 180°.

At this time, the projection 512c formed at the housing 512 of the first hinge 510 rotating together with the folder 5200 is contacted against the projection 537a of the stopper ring 537 disposed in the sliding groove 532c of the cylindrical wall of the hinge shaft 530. As a result, the projection 512c pushed the projection 537a toward in the rotational direction.

After moving along the sliding groove 532c at a predetermined distance by means of the projection 512c formed at the housing 512 of the first hinge 510, the projection 537a stops to move due to operation of the wall for defining the sliding groove 532c.

Accordingly, the housing 512 having the projection 512c contacting against the projection 537a of the stopper ring 537 also stops to rotate. As a result, the folder 5200 engaged with the housing 512 of the first hinge 510 by means of the coupling member 540 also stops to rotate.

If a user wants to close the open folder 5200 by rotating the folder 5200 in the horizontal direction, it is required to apply an external force to the folder 5200 in the forward or the reward directions so as to obviate the driving cam 538 of the hinge shaft 530 from the grooves between apexes of the driven cam 522a.

Thereafter, if additional force is applied to the folder 5200, the driving cam 538 of the hinge shaft 530 slides along the driven cam 522a of the cam disc 520 toward the lower surface of the cylindrical part 322.

At this time, since the driven cam 522a is tightly contacted with the driving cam 538 due to the elastic force of the coil springs 514a,514b,514c, the driving cam 538 smoothly slides along the driven cam 522a, and thereby the folder 5200 on which the housing 512 having the driven cam 522a is engaged smoothly is closed.

In the meantime, since the driven cam 522a is formed to be symmetrical with the axis line of the cylindrical part of the cam disc 520, it is possible to open or close the folder 5200 during rotation of the folder 5200 in the clockwise or counterclockwise direction.

When a user opens the folder 5200 by vertically pivoting with the centering on the central axis line of the projections 542a,542b of the coupling member 540 of the folder 5200, the housing 522 of the second hinge 550 mounted to the folder 5200 moves in the rotational direction of the folder 5200.

Accordingly, the driven cam 556 slideably disposed in the housing 552 of the second hinge 550 also rotates together with the folder 5200.

The compressed block of the driven cam 556 slides along the bulging block of the driving cam 552 during the rotation of the driving cam 556 and the housing 552. At this time, the driven cam 556 is pushed toward the close end of the housing 552 by means of the driving cam 554.

If the folder 5200 is continuously rotated with the centering on the central axis line of the projections 542a,542b of the coupling member 540, the apex of the compressed block of the driven cam 556 is contacted against the apex of the bulging block of the driving cam 554 and thereby the driven cam 556 is pushed toward the close end of the housing 552 to the maximum. Accordingly, the coil springs 558a,558b for supporting the driven cam 556 are compressed to the maximum.

If the folder 5200 is further rotated so as to fully open it, the compressed block of the driven cam 556 slides along the bulging block of the driving cam 554 and thereby the compressed portion of the driven cam 556 is contacted against the bulging portion of the driving cam 554.

If a user wants to close the folder 5200, it is required to rotate the folder 5200 in the reverse direction with centering on the central axis line extending between the projections 542a,542b of the coupling member 540. At this point, the driving cam 554 and the driven cam 557 of the second hinge 550 operate in the opposite order to when the folder 5200 is opened.

As stated above, the hinge assembly (500) according to the fifth working example of the present invention and the portable terminal (5000) having the same, have the merits of rotating the folder horizontally with respect to the body in the clockwise direction or counterclockwise direction and becoming enable to rotate centering around the axis which is extended passing the center of the two projections of the coupling member. Further, this invention has the merit of rotating easily the folder with respect to the body in the horizontal direction and closing smoothly the folder without applying the exterior force thereto in its open state.

Also, it has the merit of rotating the folder with respect to the body in the horizontal direction.

Hereinafter, based on the attached drawings, we are explaining about the hinge assembly (600) according to the sixth working example of the present invention.

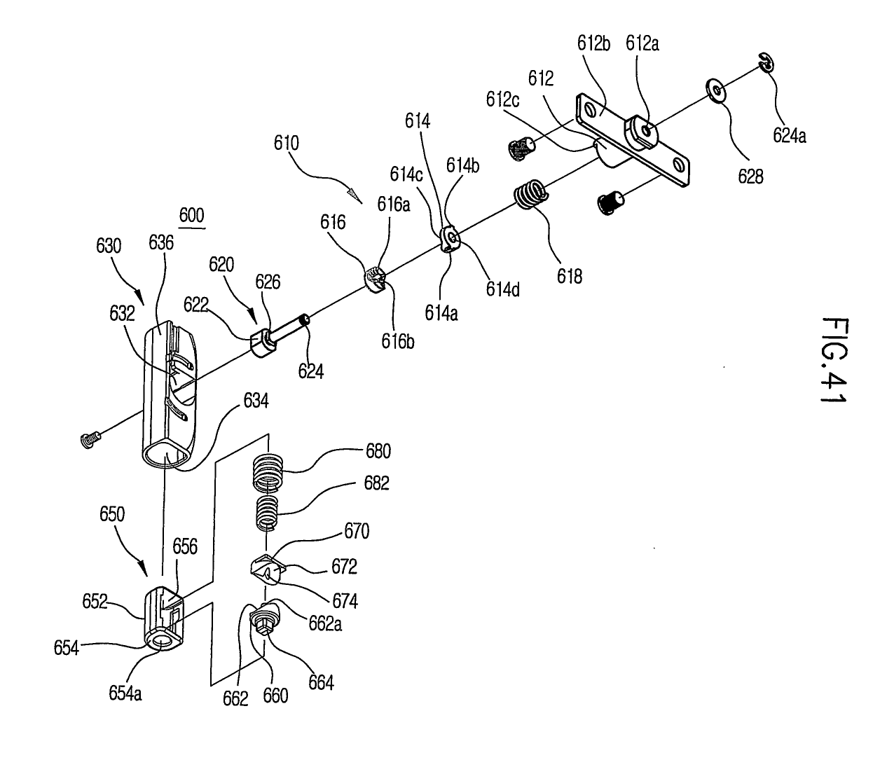

FIG. 41 is an exploded perspective view of the hinge assembly according to the sixth embodiment of the present invention.

As shown in FIG. 41, the hinge assembly according to the sixth embodiment of the present invention comprises: a first hinge 610 mounts on one article (not shown) to horizontally rotate with respect to the other article: a coupling member 650 coupling with the first hinge 610 and connecting to an end of the other article to support the one other article: and a second hinge 670 disposed inside of the coupling member 650 to rotate centering around an axis which is vertical against the rotating axis of the coupling member 650.

The first hinge 610 comprises a housing 612 mounted on one article, a driven cam 614 arranged in the housing 612 to be capable of moving sliding inside of the housing 612, a driving cam 616 disposed to face the driving cam 616 inside of the housing 612, a elastic members 618 disposed between the driven cam 614 and a closed end of the housing 612 in the housing 612 and supporting the driven cam 614 elastically, a hinge shaft 620 one end of which is fixed to the coupling member 630 and the other end of which extends through the driving cam 616, the driven cam 614, the elastic member 618 and the closed end of the housing 612.

The housing 612 has an open end and a closed end with through holes 612a. One end of the hinge shaft 620 extends through the through hole 612a.

A flange 612b is formed on an outer peripheral surface of one end of the housing 612 to couple and fix the housing 612 with the other article. A through hole is formed on the flange 612a. A screw is formed through the flange 612a to fix the housing 162.

An inner peripheral surface of the housing 612 has guide recesses (not shown) opposing each other in a longitudinal direction. A projections 614a, 614b of the driven cam 614 is arranged the guide recess so that the projections can be moved slidingly.

Also, a projection 612c is axially formed at an open end of the housing 612.

The driving cam 616 comprises a cam block 616a. A one side of the cam block 616a has a concaved shape and another side of which has a flat shape. Through hole 616b is longitudinally formed in the center thereof.

The driving cam 614 comprises a cam block 614c. A one side of the cam block 614c has a concaved shape and another side of which has a flat shape. Through hole 614d is longitudinally formed in the center thereof.

The projections 6114a, 614b formed at the outer peripheral surface of the driven cam 614. The projections 614a, 614b are received in guide groove formed at an inner peripheral surface of the housing 612 so that the driven cam 614 can smoothly move within the housing 612 in the horizontal direction.

The elastic member comprises a coil spring 618, which has predetermined elastic force and different diameter.

The hinge shaft 620 is a shaft, which has predetermined diameter. A head part 622 is formed on the one end and a ring-shaped groove 624 is formed on the other end thereof. The head part 622 has the front side and the rear side of a flat shape. Both of sides for connecting the front side and the rear side of thereof are a curved side that is formed in a predetermined curvature. A screw hole is formed at the head portion 622.

Meanwhile, a rectangular flange 626 is formed at the hinge shaft 620 adjacent to the head part 622. The flange 626 has a size corresponding to the rectangular recess that is formed at a one side of thereof. The flange 626 is positioned within the rectangular recess. Thus, the hinge shaft 620 is rotated, the driving 616 is rotated together with the hinge shaft 620.

The hinge shaft 620 is disposed to the head portion 622 in a third groove 638 of the coupling member 630, which is mentioned later.

Meanwhile, an annular groove 628 is formed at the other end of the hinge shaft 620 passing through the closed end of the housing 612. A snap ring 624a is mounted in the annular groove 624 of the hinge shaft 620.

The snap ring 624a prevents the hinge shaft 620, the driving cam 616 and the driven cam, which are mounted on the hinge shaft 620, deviating from the housing 612 by means of an elastic force of the coil spring 618.

An annular ring 628 that is arranged between the closed end of the housing 612 and the snap ring 624a to reduce the friction between the closed end and the snap ring.

The second hinge 650 includes a housing 652 disposed to the coupling member 630, a driving cam 660 disposed to the inside of the housing 652 and connected to the other article passing through the a wall of the housing 652, a driven cam 670 disposed to the inside of the housing 652 and engaged with the driving cam 660, and elastic member disposed between the driven cam and one wall of the housing in the housing and supporting the driven cam elastically.

The housing 612 of the second hinge 650 comprises an open end 654 and a closed end 656. The housing 612 comprises side walls and an arc ceiling wall.

The driving cam 660 has a circle-shaped section. The cam block 662 is formed on the one side and the cam shaft 664, which has a rectangular section, is formed an the other side thereof. Meanwhile, projections 662a are formed at the center of the concaved cam block 662 in a predetermined length. The driving cam 670 has a rectangular section. The circle and concaved cam block 672 is formed on the one side and a flat side of thereof is formed at the other side thereof. A through hole 674 is longitudinally formed at the center of the driven cam 670.

The elastic member 680, 682 of the second hinge 650 comprises a number of coil springs. The coil springs have different diameters and elasticity.

The elastic member is arranged between the driven cam 670 and the closed end 656 of the housing 652, so an end is adjacent to the driven cam 670 and the other end is adjacent to the closed end of the housing and supported.

A circular groove 632 is vertically formed at the center of the coupling member 630 with respect to the cross-axial line of the coupling member 630.

The housing 612 of the first hinge 610 is inserted and disposed into the circular groove 632.

Also, the first groove 634 for receiving the second hinge 650 with respect to the circular groove 632 and the second groove 636 for receiving a coupling projection (not shown) of the other article are formed at the coupling member 630 opposing to each other.

The circular groove 632, the first groove 634 and the second groove 636 of the coupling member 630 are divided by a partition.

The third groove 638 is formed within the circular groove 632 of the coupling member 630. A through hole is formed at the ceiling wall defining the third groove 638. Meanwhile, as assembling, the head portion 622 of the hinge shaft 620 of the first hinge 610 is received.

The hinge assembly 600 according to the first embodiment of the present invention constituted, as the above, is assembled with the following steps.

First, the hinge shaft 620 is disposed within the circular groove 632 of the coupling member 630 so that the head portion 622 of the hinge shaft 620 is positioned within the third groove 638 of the coupling member 630.

Next, the screw is inserted into the screw hole that is formed at the head portion 622 of the hinge shaft 620 by extending the screw passing through the through hole. Thus, the hinge shaft 620 is fixed to the coupling member 630.

After, the driving cam 616 is mounted on the hinge shaft 620. At this time, the rectangular groove, which is formed at one side of the driving cam 616, is engaged with the rectangular flange 626 of the hinge shaft 620 so that the driving cam 616 is not rotated on the hinge shaft 620 independently.

And then, the driven cam 614 is mounted on the hinge shaft 620 so that the concaved cam block 614c, which is formed at one side the driven cam 614, is engaged with the concaved cam block 616a, which is formed at one side the driving shaft 616.

Thereafter, the coil spring 618 is disposed within the housing 612.

And then, the hinge shaft is inserted into the housing 612 so that the other end of the hinge shaft mounted on the driving cam 616 and the driven cam 614 is passing through the coil spring 618 disposing within the housing 612 and the through hole 612a forming at the closed end of housing 612.

At this time, the projections 614a, 614b, which are formed on the circumstance surface of the driven 614, is arranged with the driven cam 614 for movably receiving the guide groove forming the inner circumstance surface of the housing 612.

Also, when the hinge shaft 620 is extended into the housing 612, the housing 612 is inserted into the circular groom 632 of the coupling member 630.

Next, the annular ring 628 is mounted on the other end of the hinge shaft 620 extending from the through hole 612a, which is formed at the closed end of the housing. And the snap ring 624a is mounted within the annular groove 624, which is formed at the other end of the hinge shaft 620.

Thereafter, the driving cam 660 is disposed in the housing 652 so that the cam shaft 664 is extends from the through hole 654a, which is formed at the open end of the housing of the second hinge 650.

And then, the projection part 674 of the driving cam 660 is inserted into the through hole 674 of the driven cam 670. And the driven cam 670 is disposed within the housing so that the cam block 672 forming at an one end of the driven cam 670 is engaged with the concaved cam block 662 formed at the one end of the driving cam 660,

Finally, the coil springs 680, 682 is disposed between the driven cam 670 and the closed end 658 of the housing 652.

The second hinge 650 is disposed within the first groove 634 of the coupling member 640 as assembled above.

The hinge assembly 600 according to the sixth embodiment of the present invention constituted as the above, other article coupling with the second hinge 650 and the coupling member 630 can rotate horizontally and vertically with respect to the one article.

Hereinafter, the portable terminal (6000) having the hinge assembly 600 according to the sixth embodiment of the present invention will be explained in more detail with reference to the accompanying drawings.

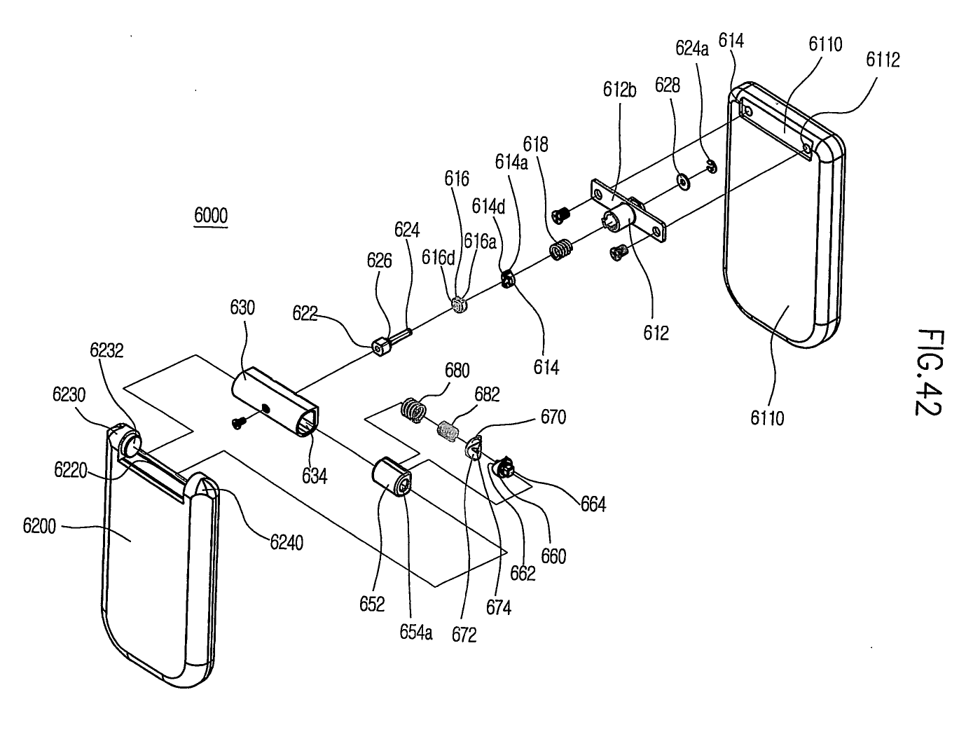

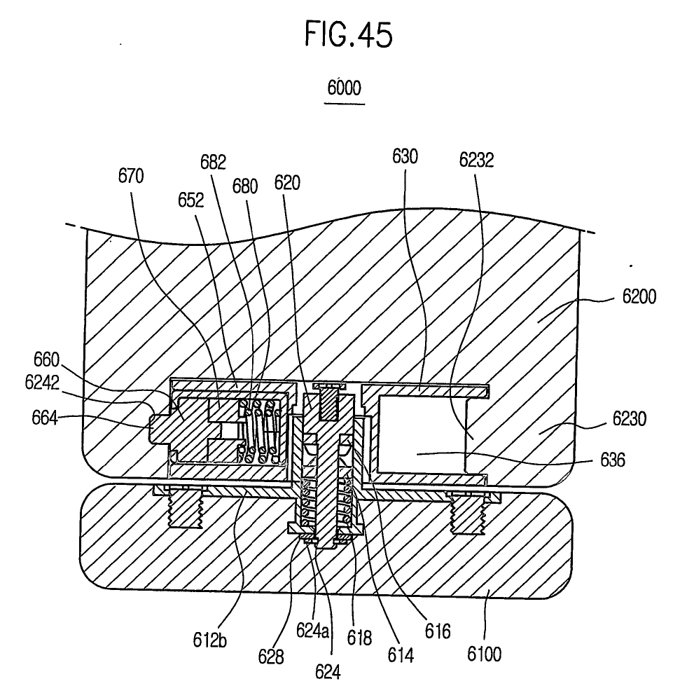

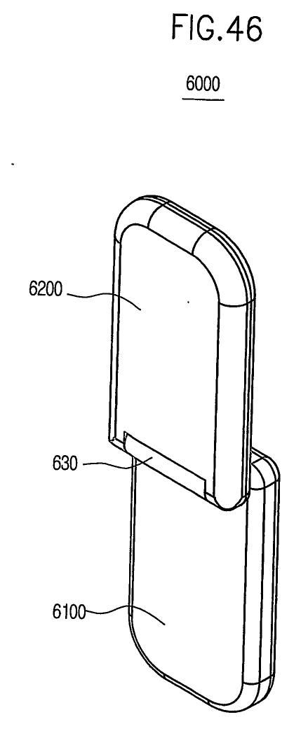

FIGS. 42 through 47 are a view showing the portable terminal (6000) having the hinge assembly 600 according to the sixth embodiment of the present invention.

By referring to FIGS. 42 to 47, the portable terminal 6000 comprises: a body 6100 mounted with a key pad (not illustrated), a mike phone (not illustrated) and a battery (not shown); a folder 6200 mounted to be rotatable with respect to the body horizontally and vertically and having a speaker phone (not illustrated) and a display panel (not illustrated); and a hinge assembly 6100 to rotate the folder 6200 with respect to the body 6100 horizontally and vertically, the hinge assembly 600.

A receiving groove 1110 for receiving the housing 612 of the first hinge 610 of the hinge assembly 612 is formed at a one side of the body 6100. Screw holes 6112, 6114 are formed at the bottom side of the receiving groove 1110.

A receiving groove 6220 for receiving the coupling member 630 is formed at the one side of the folder 6200. And, a coupling projection 6232 for coupling the second groove 636 of the coupling member 630 is formed at one of the ends 6230, 6240 defining the receiving groove 6220.

Also, a mounting groove 6242, which the cam shaft 664 of the driving cam 660 disposed in the second hinge 650 mounted to the coupling member 630 is inserted into, is provided with the other of the ends 6230, 6240 defining the receiving groove 6220.

After arranging the housing 612 in the receiving groove 6110 of the main body 6100, by extending a screw via the through hole 612a formed in the flange 612b of the housing 612 and screwing the screw into the screwing hole formed in the receiving groove 6110, the first hinge 610 of the hinge assembly 600 assembled as stated above is fixed to the main body 6110.

Afterward, the driving cam shaft 664 of the second hinge 650 which is mounted to the coupling member 630, is firmly engaged by forcing to be fit into the mounting groove 6242 formed in the one end 6140 of the ends 6230, 6240 defining the receiving groove 6110 of the folder 6200. At the same time, the coupling member 630 and the folder 6200 are connected by inserting the coupled projection 6232, which is provided with the other end 6130 of the ends 6230, 6240 defining the receiving groove 6110 of the folder 6200, into the second groove 636 of the coupling member 630.

Hereinafter, based on the attached drawings, the function and the working effect of the hinge assembly 600 according to the sixth embodiment of the present invention and the portable terminal 6000 having the same will be described.

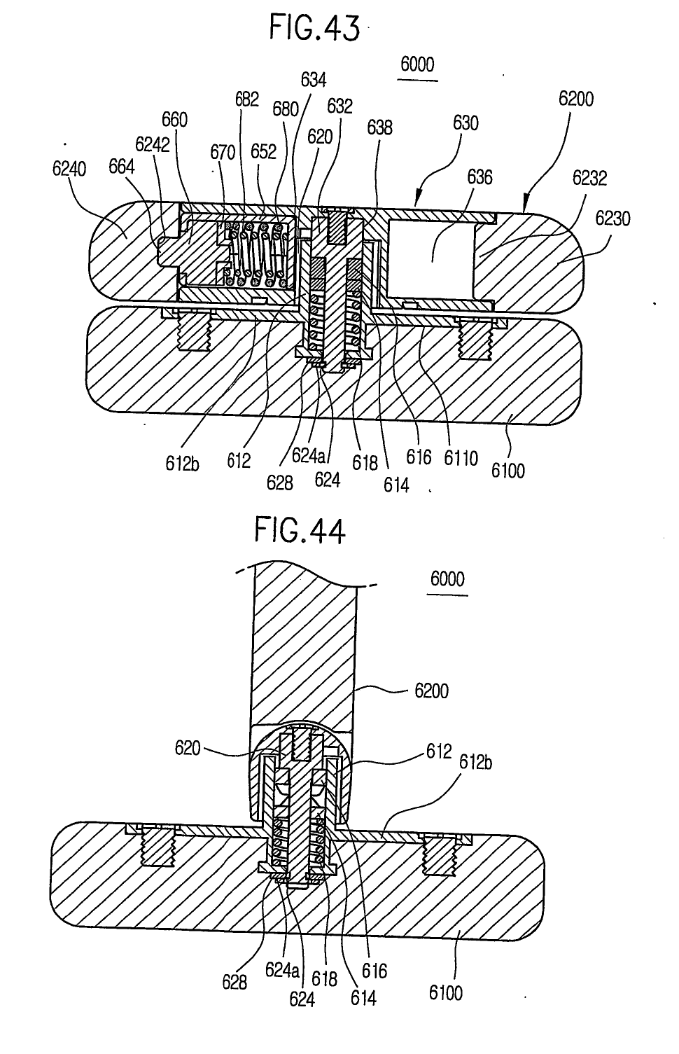

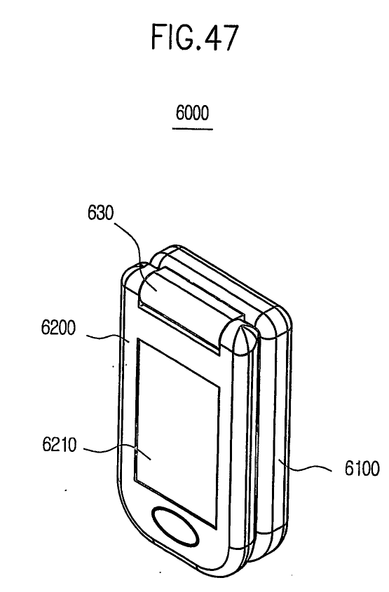

By referring to FIGS. 43 and 47, in the open state of the folder 6200, the driven cam 614 of the first hinge 610 is engaged with the driving cam 616 of the first hinge 610 and the elastic member 618 is elongated to the maximum.

Firstly, the opening stage of the folder 6200 in which the folder is rotated against the main body 6100 will be explained

If the folder 6200 is rotated by force against the main body 6100, the hinge shaft 620 of the first hinge 610 shole be rotated as a result of the connection of the coupling member 630. Therefore, the driving cam 616 fixed to the hinge shaft 620 can be rotated with the hinge shaft 620.

As a result of the rotation of the driving cam 616, the concave surface of the concave cam block 614c of the driven cam 614 is sliding along to the convex surface of the convex cam block 616a of the driving cam 616. Therefore, the driven cam 614 is driven to the closed end of the housing 612 by the driving cam 616.

The driven cam 614 is moved into the closed end of the housing 612 along to the axis of the housing 612 because the projections 614a, 614b on the outer peripheral surface of the driven cam 614 are disposed to be capable of sliding in the guide groove formed on the inner surface of the housing 612. As a result of the movement of the driven cam 614, the coil spring 618, which is arranged in the housing to support the driven cam 614, shole be compressed.

On the open state of the folder 6200 by rotating the folder at an angle of 180°, the driving cam 616 and the driven cam 614 of the first hinge 610 are each other engaged as the initial closed state of the folder. The concave cam block 614c of the driven cam 614 is engaged with the convex cam block 616a of the driving cam 616.

As stated above, on the open state of the folder 6200 at the angle of 180°, if an additional force is not applied to the folder 6200, the folder can not any more horizontally rotate with respect to the main body 6100.

In the case of opening the folder by horizontal rotating, the folder can be opened not only in a clockwise rotation, but also in a counterclockwise rotation.

Meanwhile, the second hinge 650 is operated when the folder 6200 is opened on rotating the folder 6200 about the longitudinal axis of the coupling member 630.

On rotating the folder 6200 about the longitudinal axis of the coupling member 630 by the application of the external force, the driving cam shaft 664 of the second hinge 650, which is combined with the folder 6200, shole rotate with the direction of the rotation of the folder 6200.

And then, the driven cam 670 engaged with the driving cam 660 of the second hinge 650 is driven to the closed end 650 of the housing 652, therefore the driving cam 660 can be smoothly moved. Accordingly, the folder combined with the cam shaft 664 of the driving cam 660 also can be smoothly rotate.

More specifically, if the folder 6200 is rotated, the driven cam 670 is driven against the driving cam 660 to the closed end 650 of the housing 652 during the concave cam block 672 of the driven cam 670 is moved along to the convex cam block 662 of the driven cam 660. The reason of the movement of the driven cam 670 is that the driving cam 660 can be rotated with the folder 6200, but the driven cam 670 can not be rotated with the folder 6200.

Hereinbefore, the horizontal opening process and the vertical opening process of the folder 6200 is respectively stated. Furthermore, the folder 6200 can be horizontally rotated at the vertical rotation state of the folder 6200.

At this time, the folder 6200 can be rotated to the maximum angle of 180° on the rotation of the folder 6200 about the longitudinal axis of the coupling member 630, and the folder 6200 can be rotated to the maximum angle of 360° in a clockwise direction or a counter clockwise direction on the horizontal rotation of the folder 6200 against the main body 6100.

Referring to the attached drawings, the hinge assembly 700 according to the seventh embodiment of the present invention will be described.

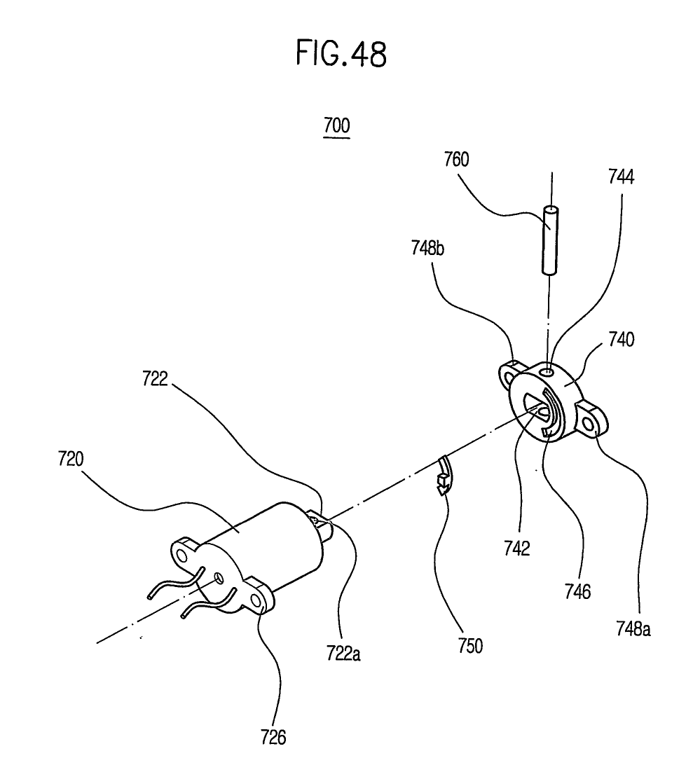

FIG. 48 is a perspective view of the hinge assembly 700 according to the seventh embodiment of the present invention.

As shown in FIG. 48, the hinge assembly 700 according to the seventh embodiment of the present invention comprises:

a driving member 720 mounted on one article to rotate horizontally another article with respect to the one article; and a driven member 740 mounted on another article and rotating together with another article by the rotating force of the driving member 720.

The driving member 720 comprises a geared motor having a reduction gear. Alternatively, stepping motor can be used for the driving member 720

The rotating shaft 722 of the driving member 720 has a rectangular section, and a through hole 722a is provided with it in a vertical direction with regard to longitudinal axis.

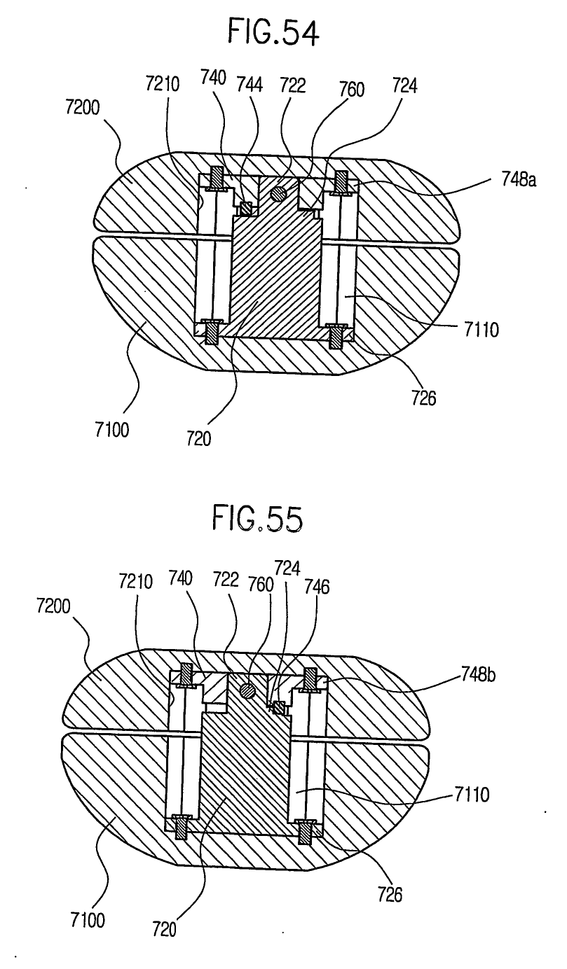

Referring to FIGS. 54 and 55, projection 724 is provided adjacent to the rotating shaft 722 in one end of the driving member 720 which the rotating shaft 722 extends to.

Meanwhile, a flange 726 for fixing the driving member 720 to the one article is provided with the other end of the driving member 720, and then a through hole is provided with the flange 726.

Furthermore, an electrical wire is extended through the other end of the driving member 720.

The driven member 740 has a cylindrical shape with the predetermined height and a cross section of the inner space 742 of the cylindrical shape is identical to the cross section of the rotating shaft 722 of the driving member 720.

Also, a through hole 744 extending in a vertical direction to the longitudinal axis of the driven member 740 is provided with the driven member 740, and the diameter of the through hole 744 is the same as the through hole 722a in the rotating shaft 722 of the driving member 720.

Meanwhile, an arc-shaped groove, sliding groove 746 is provided with the one side of the driven member 740. The sliding groove 746 is arranged against to the projection 724 formed in the opposite side of the driving member 720 for the engagement of the driving member 720 and the driven member 740. A stopper 750 is disposed to be capable of sliding in the sliding groove 746.

Furthermore, on the peripheral surface of the driven member 740, flanges 748a, 748b for fixing the driven member 740 to the other article are formed in one body. And a through hole is provided with the flanges 748a, 748b for the screw to be inserted through.

Hereinafter, the assembling process of the hinge assemble 700 according to the seventh embodiment will be specifically described.

The stopper 750 is disposed to be capable of sliding in the sliding groove 746 formed in the one side of the driven member 740. And then, the driven member 740 is mounted on the rotating shaft 722 of the driving member 720.

At this time, the driven member 740 is mounted on the rotating shaft 722, for the through hole 722a of the rotating shaft 722 to be co-axial with the through hole 744 of the driven member 740 and for the stopper 750 disposed in the sliding groove 746 to be opposite to the projection 724 about the longitudinal axis of the rotating shaft 722.

Next, a pin 760 is inserted into the through hole 744 of the driven member 740 and then the pin 760 is extended via the through hole 722a of the rotating shaft 722 combined together with the driven member 740. Therefore, the driven member 740 is fixed to the rotating shaft 722 of the driving member 720.

Referring to the attached drawings, a portable terminal 7000 having the hinge assembly 700 according to the seventh embodiment of the present invention will be described.

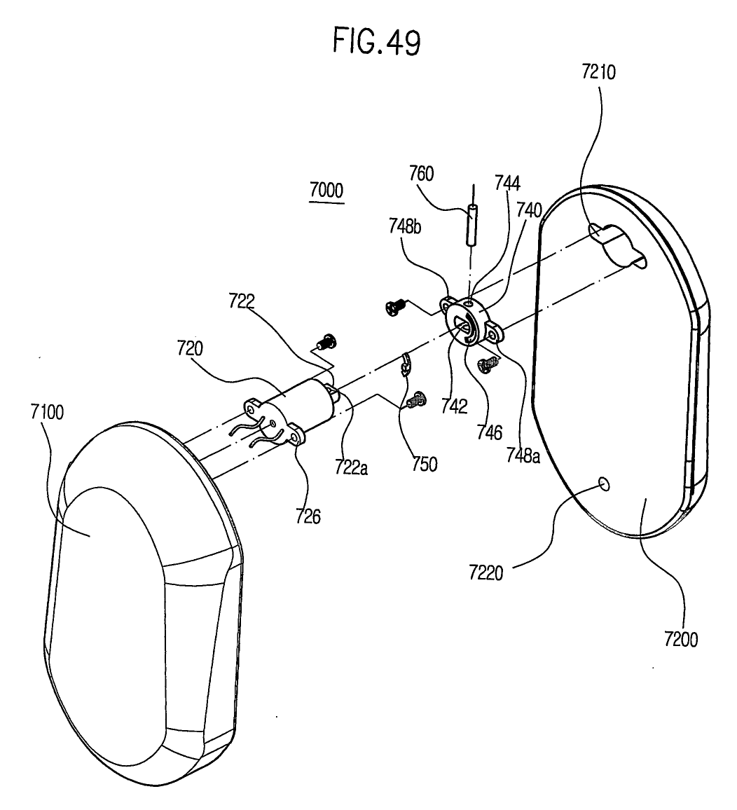

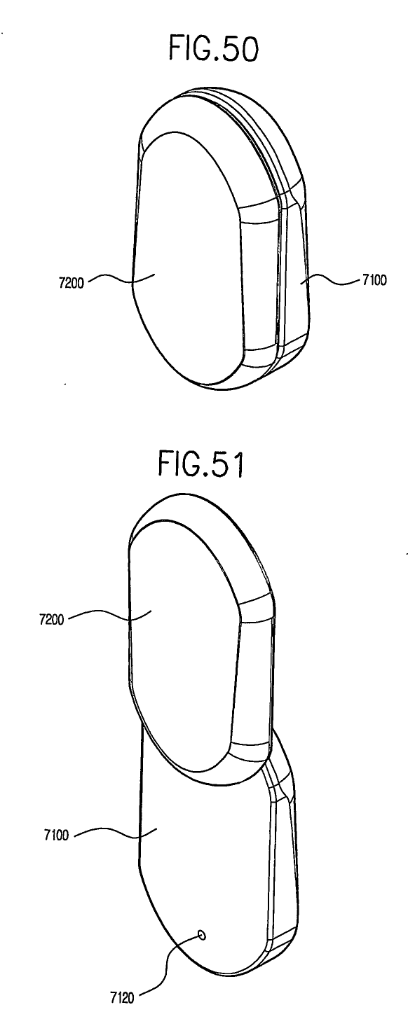

As shown in FIGS. 49 to 54, the portable terminal 7000 comprises: a main body 7100 mounted with a key pad (not illustrated), a mike phone (not illustrated) and a battery (not shown); a folder 7200 mounted to be capable of rotating with respect to the main body 7100 horizontally and vertically and having a speaker phone (not shown) and a display panel (not shown); and a hinge assembly 700 disposed between the folder 7200 and the main body 7100 to rotate the folder 7200 with respect to the main body 7100 horizontally and vertically.

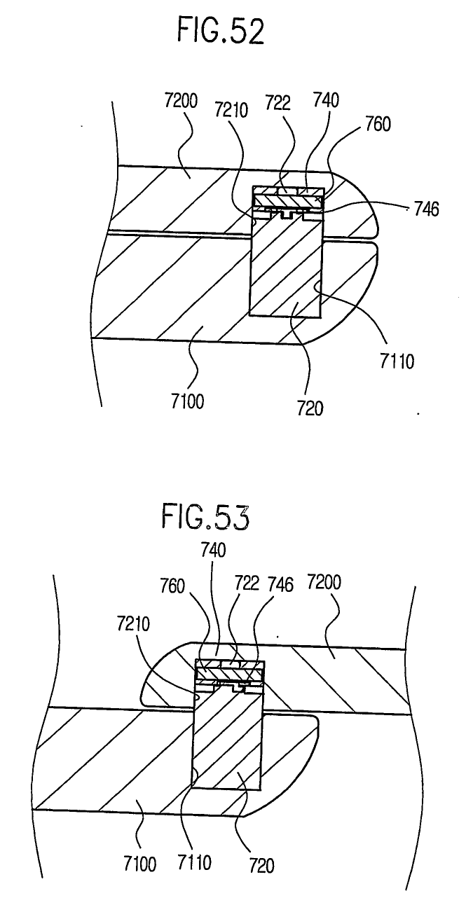

As shown in FIGS. 52 to 54, a groove 7110 for receiving and fixing the driving member 720 of the hinge assembly 700 is provided with the one side of the main body 7100. And, in the bottom of the groove 7110, screwing hole is provided with the same position of the through hole in the flange 726 of the driving member 720.

On the side surface of the main body, a switch (not shown) is mounted to control the driving member 720. In addition, in the main body 7100, a sensor (not shown) to retrieve a rotation angle of the folder 7200 with regard to the main body 7100 and also can be mounted. The sensor can be used to stop the driving operation of the driving member 720 when the folder 7200 has been rotated to the predetermined angle such as 180°.

Meanwhile, stepping motor can be used for the driving member 720 mounted in the main body 7100, and then the rotation angle of the folder would be controlled step by step at a small predetermined angle.

With the folder 7200, a groove 7210 for receiving and fixing the driven member 740 is provided. And, with the bottom of the groove 7210, screwing hole is provided at the same position of the through hole in the flange 748a, 748b of the driven member 740.

When the driving member 720 of the hinge assembly 700 is inserted and mounted into the main body 7100 of the portable terminal 7000, the one end of the driving member 720 is projected from the groove 7110 of the main body 7100.

Furthermore, the driven member 740 of the hinge assembly 700 is inserted and mounted into the folder 7200 of the portable terminal 7000, and the driven member 720 is positioned in the folder 7200.

In the portable terminal 7000, after fixing the driving member 720 to the main body 7100 by screw, the driven member 720 is mounted to the rotating shaft 722 of the driving member 720.

At this time, the driven member 740 is mounted on the rotating shaft 722, for the through hole 744 of the driven member 740 to be arranged co-axial with the through hole 722a of the rotating shaft 722 and for the stopper 750 disposed to be capable of sliding in the one side of the driven member 740 to be opposite to the projection 724 about the longitudinal axis of the rotating shaft 722.

And then, a pin 760 is inserted into the through hole 744 formed on the peripheral surface of the driven member 740 and then the pin 760 is extended via the through hole 744, 722a of the driven member 740 and the rotating shaft 722 engaged together with the driven member 740, respectively. In result, the driven member 740 is fixed to the rotating shaft 722 of the driving member 720.

Referring to the attached drawings, the function and the working effect of the hinge assembly 700 according to the seventh embodiment of the present invention and the portable terminal 7000 having the same will be described.

In the above portable terminal 7000, when the switch is turned on in the closed state of the folder 7200, then the driving member 720 mounted in the main body 7100 is operated by the application of electrical power.

Then, the driving member 720 rotates the rotating shaft 722 in a clockwise direction or a counter clockwise direction, and the driven member 740 is also rotated together with the rotating shaft 722. Therefore, the folder 7200 combined with the driven member 740 is also rotated in a clockwise direction or a counter clockwise direction.

On the rotation of the folder 7200 at a predetermined angle such as 180°, the sensor in the main body 7100 will retrieve the rotation angle of the folder 7200 and will transfer the rotation angle to a microprocessor.

Meanwhile, when the folder's rotation angle approach to 180°, the stopper 750 disposed to be capable of sliding in the one side of the driven member 740 will be abutted into the projection 724 formed in the driving member 720. And then, the stopper 750 will slide in the opposite direction to the rotation direction of the folder with driven by the projection 724.

Furthermore, when the folder 7200 fully rotate at angle of 180°, the sliding movement of the stopper 750 will be stopped by the wall of the sliding groove 746. Therefore, with pressed by the projection 724, the rotation of the folder 7200 is resisted.

In result, the folder 7200 will remain to be opened state without additional rotation of the folder 7200.

In order to close the folder 7200 in the open state, the switch of the main body 7100 is turned to operate the driving member 720.

And then, the driving member 720 rotates the rotating shaft 722 in a reverse direction of the opening process. Therefore, the driven member 740 fixed to the rotating shaft 722 is rotated in the reverse direction, and the folder 7200 fixed to the driven member 740 is also rotated in the reverse direction.

Meanwhile, when the folder 7200 rotates at a angle of 180° in the reverse direction and the folder 7200 is closed with regard to the main body 7100, the sensor will perceive the closed state and transfer the related information to a microprocessor. Then, the microprocessor will stop the driving member 720, and the folder 7200 will not rotate any more.

As stated above, the hinge assembly 700 according to the seventh embodiment of the present invention and the portable terminal 7000 comprising thereof, have the merits of providing the automatic rotation of the folder 7200 by using the rotational force of the driving member 720, without the application of external force by user.

Referring to the attached drawings, the hinge assembly 800 according to the eighth embodiment of the present invention will be described.

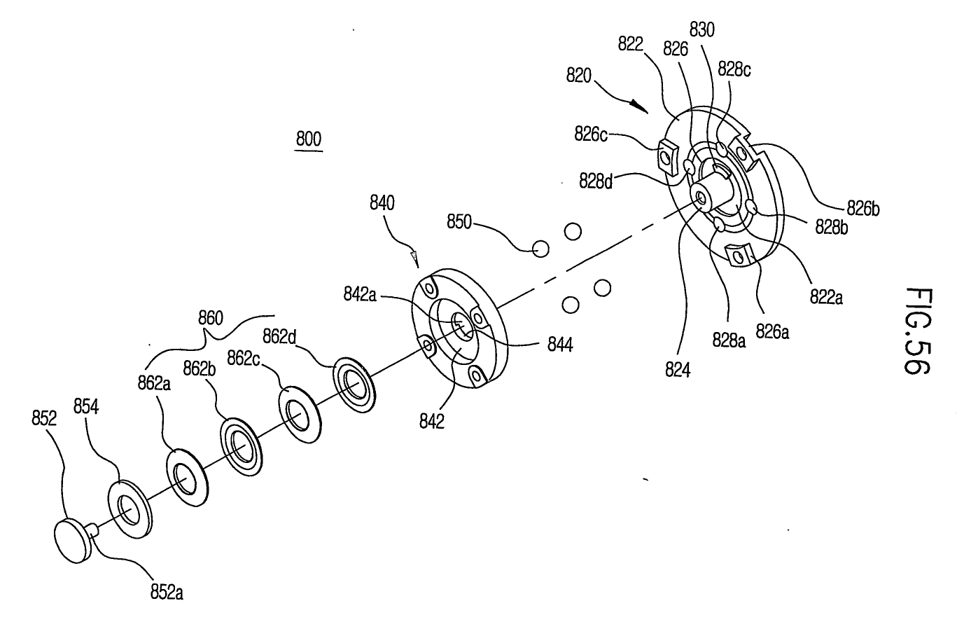

FIG. 56 is an exploded perspective view of the hinge assembly 800 according to the eighth embodiment of the present invention.

As shown in FIG. 56, the hinge assembly 800 according to the eighth embodiment of the present invention comprises:

a first member 820 combined with the one side of one article (not shown) and supporting the one article for it to rotate horizontally with respect to another article (not shown); a second member 840 combined with the one side of the other article and supporting the other article for it to rotate horizontally with respect to the one article; and a third member 860 to provide an elastic force with the second member 840 for the first member 820 to firmly engage with the second member 840.

The first member 820 comprises a disc-shaped body 822 and a cylindrical shaft 824 vertically extended from the one side of the first member 820, for a driving cam. Annular step portion 826 is provided at a predetermined radial distance from the central axis with the disc-shaped body 822.

In the body 822, a circular groove 822a is provided with a predetermined diameter about the central axis by the step portion 826.

In addition, a plurality of protrusion 826a, 826b, and 826c are provided with the circumferential part of the body 822, and a through hole is provided with the protrusion, respectively.

The protrusion 826a, 826b, 826c defines the engage groove for receiving the projection formed in the one article on combination into the one article.

Meanwhile, a plurality of semi-sphere shaped grooves 828a, 828b, 828c, and 828d are provided with the step portion 826 of the body 822 at a predetermined distance around the central axis. The number of semi-sphere shaped grooves 828a, 828b, 828c, and 828d is preferably four.

In addition, a stopper 830 is provided with the end portion of the shaft 824, which is in contact with the body 822.

The second member 840 preferably comprises a disc-shaped driven cam, which has a depression 842 having a predetermined diameter in the central portion of the one side of it. And a through hole 842a is provided with the central portion of the depression 842 for the shaft 824 to pass through.

In addition, a plurality of through holes is provided with the circumferential part of the second member 840. A screw is extended via the through hole to fix the second member 840 into the other article.

A semi-circular projection 844 is provided at a predetermined distance with the other side of the second member 840. The projection 844 is received in the circular groove 822a of the first member 820.

Hemispherical grooves 846a, 846b, 846c, 846d, also, are spaced at the other side of the second member 840 with respect to the center axial line of the second member 840. Preferably, the number of the hemispherical grooves 846a, 846b, 846c, 846d are four, which corresponds to the hemispherical grooves 828a, 828b, 828c, 828d of the body 822 of the first member 820.

The hemispherical grooves 828a, 828b, 828c, 828d, 846a, 846b, 846c, 846d of the first member 820 and the second member 840 are arranged at 90° and formed the same curvature.

The second member 840 comprises a plurality of balls 850, preferably, four balls 850.

The ball 850 is the same radius curvature as that of the hemispherical grooves 828a, 828b, 828c, 828d, 846a, 846b, 846c, 846d of the first member 820 and the second member 840.

The ball 850 is arranged at the hemispherical grooves 846a, 846b, 846c, 846d, respectively, which is formed at the other side of the second member 840, and attached to the hemispherical grooves 846a, 846b, 846c, 846d by an adhesive member, et. al.

Meanwhile, the second member 840 includes a coupler 852 for elastically supporting the third member 860, which is screwed at the shaft 824 of the first member 820 and arranged between the depressed portion 842 of the second member 840.

The third member 860 includes a plurality of disc springs 862a, 862b, 862c, 862d. Through hole is formed at the center portion of the disc springs 862a, 862b, 862c, 862d, and has a rising shape above the center of thereof.

A pair of the disc springs 862a, 862b, 862c, 862d are arranged at opposing to the rising center thereof. The disc springs 862a, 862b, 862c, 862d are received the depressed portion 842 of the second member 840.

The hinge assembly 800 includes an annular ring 854, which is arranged between the disc spring 862a and a one wall of the other article so as to reduce a friction between the one wall and the disc spring 862a.

The annular ring 854 can be replaced with a washer.

The hinge assembly 800 according to the eighth embodiment of the present invention constituted, as the above, is assembled with the following steps.

First, the screw is passed through the through hole, which is formed at adjacent position of the body 822 of the first member 820 and fixed to the one article of the first member 820.

Thereafter, the second member 840 is fixed to the one wall of the other article by means of the screw. At this time, the depressed portion 84 is to be concentric circle to the through hole, which is formed at the one wall of the other article.

And then, the second member 840 is mounted on the shaft 824 of the first member 820. At this time, semi-circle shaped projection 844 formed at the one side of the second member 840 is arranged at the annular groove 822a formed at the body 822 of the first member 820. Also, the ball attached to the one side of the second member 840 is engaged with the hemispherical grooves 828a, 828b, 828c, 828d.

After, the disc springs 862a, 862b, 862c, 862d are inserted into the depressed groove 842 of the second member 840 through the through hole, which is formed at the one wall of the other article. At this time, the disc springs 862a, 862b, 862c, 862d are arranged with the depressed portion 842 of the second member 840 so that the shaft 824 of the first member 820 can be pass through the disc springs 862a, 862b, 862c, 862d.

Finally, the annular ring 854 is inserted into the shaft 852a of the coupler 852. And the shaft 852a of the coupler 852 is coupled to the screw hole formed at the shaft 852a of the first member 820 and thus the coupler 852 is coupled to the first member 820.

Therefore, the one article is rotatably coupled to and the other article by the first member 820 and the second member 840.

Hereinafter, based on the attached drawings, we are explaining about the portable terminal 8000 on which the hinge assembly 800 according to the eight embodiment of the present invention is mounted.

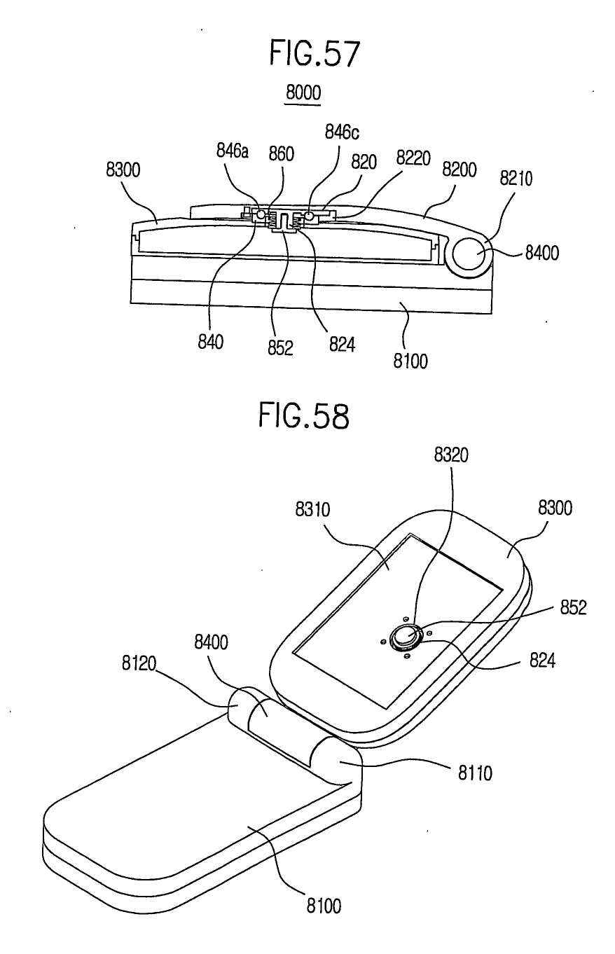

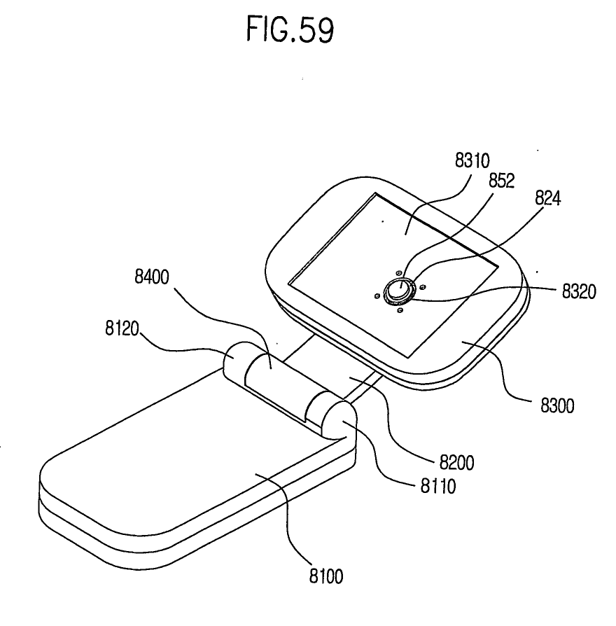

As shown in FIGS. 57 to 59, the portable terminal 8000 mounted with the hinge assembly 800 according to the eight embodiment of the present invention comprises: a main body 8100 mounted with a key pad (not illustrated), a mike phone (not illustrated) and a battery (not shown); a folder 8200 mounted to be rotatable with respect to the main body 8100 horizontally and vertically and having a speaker phone (not illustrated) and a display panel (not illustrated); a first hinge assembly 8400 to rotate the folder 8200 with respect to the main body 8100 horizontally and vertically; and a second hinge assembly 800 to rotate the display panel 8300 with respect to the folder 8200 horizontally and vertically, the second hinge assembly 800 for combining the display panel 8300 with the folder 8200.

A pair of posts 8110,8120 for combining the folder 8200 are formed at one side of the main body 8100. An engaging hole is formed at one of the posts 8110,8120. The driving cam shaft of the fist hinge shaft 8400 may be inserted into the engaging hole, which will be explained herein below.

On end of the folder 8200, a mounting portion 8210 for receiving the first hinge assembly 8400 is formed. On an inner surface of the folder 8200, a groove 8220 for receiving a shaft 824 of the first member 820 of the second hinge assembly 800, that is, the hinge assembly 800 according to the eighth embodiment of the present invention is formed.

Pluralities projections (not shown) are radially formed in the groove 8220 at a predetermined distance with centering on the central axis thereof. A screw hole for fixing the first member 820 of the second hinge assembly 800, that is, the driving cam is formed at the projections.

In the meantime, the display panel 8300 is combined to the folder 8200 so that it can horizontally rotate with respect to the folder 8200 by means of the second hinge assembly 800. A through hole 8320 is formed through one wall 8310 of the display panel 8300. At this time, the driven cam 840 is disposed at the one wall 8310 and is fixed thereto by using a screw so that a depressed portion 842 formed at the driven cam 840 of the second hinge assembly 800 is coaxially aligned with the through hole 8320.

The first hinge assembly 8400 comprises a can-type hinge, a nude-type hinge, etc.

Since the general constitution of the first hinge assembly 8400 is similar to that of the second hinge employed in the fourth and the fifth hinge assemblies according to the present invention, the detailed description thereof will be omitted.

Hereinafter, we are briefly explaining about the basic constitutional element of the first hinge assembly 8400 applied to the portable terminal 8000.

The first hinge assembly 8400 comprises a housing mounted to the mounting portion 8210 formed at one end of the folder 8200; a driving cam disposed in the housing, of which one end is fixedly engaged with the main body 8100 and the other end has a cam; a driven cam being engaged with the driving cam; and a coil spring disposed between the driven cam and the one wall of the housing in the housing and supporting the driven cam elastically.

Accordingly, the folder 8200 can rotate with respect to the main body 8100 with respect to the first hinge assembly 8400

The second hinge assembly 800 is a hinge assembly according to the eight embodiment of the present invention.

The first member of the second hinge assembly 800, that is, the driving cam 820 is disposed at the groove 8220 formed at the one surface of the folder 8200 and is fixed thereto by using a screw.

When the driving cam 820 is fixed to the folder 8200, the driving cam 820 disposed so as to dispose the projection formed at the groove 8220 in the depressed portions 826a,826b,826c,826d of the driving cam 820. Thereafter, a screw is inserted through the through holes formed at the depressed portions 826a,826b,826c,826d of the driving cam 820 into the screw hole of the projection, and thereby the driving cam 820 is fixed to the folder 8200.

Next, the second member of the second hinge assembly 800, that is, the driven cam 840 is disposed at the one wall 8310 of the display panel 8300 and is fixed thereto by using a screw. The driven cam 840 is mounted to the shaft 824 of the driving cam 820 so that the ball 850 attached to the driven cam 840 is engaged with the hemisphere-shaped grooves 828a,828b,828c,828d of the driving cam 820.

Thereafter, the disc springs 862a,862b,862c,862d and the annular ring 854 are disposed in the depressed portion 842 of the driven cam 840. The combining fixture 852 is threadly engaged with the shaft 824 of the driving cam 820 so as to support the disc springs 862a,862b,862c,862d and the annular ring 854.

Hereinafter, based on the attached drawings, we are explaining about the function and the effect of the hinge assembly 800 according to the fifth embodiment of the present invention and the portable terminal 8000 having the same.

When the folder 8200 is open by rotating the folder 8200 with centering on the axis line of the fist hinge assembly 8400 under the stat that the folder 8200 is closed, the folder 8200 has been open by means of the first hinge assembly 8400 and it is aligned at 180° with respect to the main body 8100.

Under the state that the folder 8200 is open, if an exterior force is applied to the display panel 8300, the display panel 8300 can horizontally rotate with respect to the folder 8200.

Since the display panel 8300 is rotatably mounted to the folder 8200 and the hemisphere-shaped grooves 828a,828b,828c,828d formed at the driving cam 820 and the driven cam 840 of the second hinge assembly 800 are aligned at 90° with respect to the ball 850, it is possible to horizontally rotate the display panel 8300 with respect to the folder 8200 at 90° rotational angle.

If a user does not apply a force to the display panel 8300 rotated at 90° the display panel 8300 maintains its stop position.

If a user wants to close the folder 8200, he or she horizontally rotates the display panel 8300 in the direction opposite to the direction for opening it. As a result, the display panel 8300 returns its initial position. And then he or she applies a force to the folder 8200 in the direction opposite to the direction for opening it.

As stated above, the hinge assembly 800 according to the eight embodiment of the present invention and the portable terminal 8000 comprising the same, have the merits of rotating the folder 8200 with respect to the main body 8100 centering on the axis of the first hinge shaft 8400 thereby opening the folder and of horizontally rotating the display panel 8300 mounted to the folder 8200 with respect to the folder 8200.

Referring to the attached drawings, the hinge assembly 900 according to the ninth embodiment of the present invention will be described.

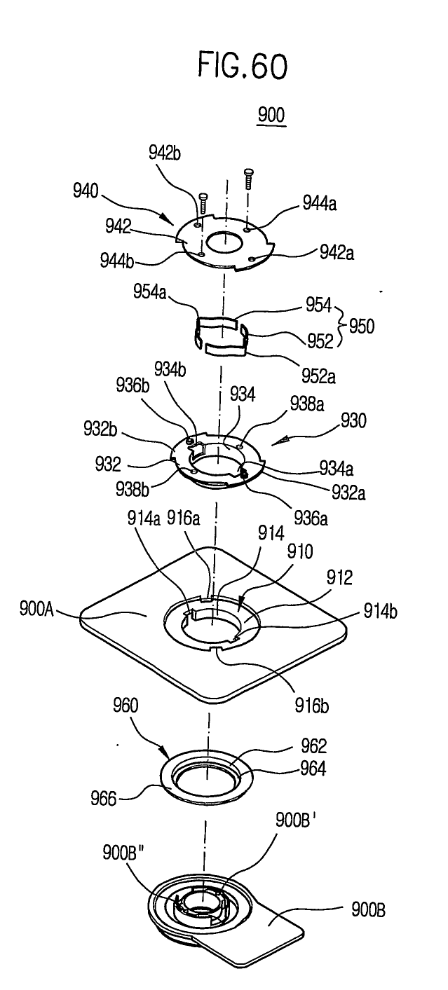

FIG. 60 is an exploded perspective view of the hinge assembly 900 according to the ninth embodiment of the present invention.

As shown in FIG. 60, the hinge assembly 900 according to the eighth embodiment of the present invention comprises: a first hinge portion 910 being formed at one wall of one article 900A and rotating the one article 900A for it to rotate horizontally with respect to another article 900B; a second hinge portion 930 combined with the first hinge portion 910 and supporting the one article 900A for it to rotate horizontally with respect to the other article 900B; and a third member 950 being mounted to the second hinge portion 930 and for elastically supporting the first hinge portion 910 so as to restrain the rotation of the first hinge portion 910.

The first hinge portion 910 comprises an annular flange portion 912 protruding from one wall of the one article 900A; a cylindrical portion 914 extending from the flange portion 912, of which guide grooves 914a,914b for receiving rounded portions 952a,954a of the third member 950; and stoppers 916a,916b formed at the one wall of the one article 900A.

The stoppers 916a,916b and the guide grooves 914a,914b of the cylindrical portion 914 are aligned with each other at a predetermined angle with centering on the longitudinal axis of the flange 912.

A predetermined gap is defined between the flange portion 912 and the stoppers 916a,916b.

The second hinge portion 930 for supporting the one article 900A comprises a guide plate 930 disposed between the flange portion 912 and the stoppers 916a,916b so that it is contacted with the one surface of the flange portion 912. The second hinge portion 930 further comprises a cover plate 940, which is contacted with one surface of the second hinge portion 930 and is fixed to the other article 900A together with it.

The guide plate 930 includes flange portions 932 and a cylindrical portion 934 extending between the flanges 932.

A part of the flange portion 932 has extension portions 932a,932b, which radially extend to the outside. Through holes 934a,934b are formed at a position in which the cylindrical portion 934 is contacted with the flange portions 932 having the extension portions 932a,932b. The third member 950 is partially inserted to the through holes 934a,934b.

Protrusion 936a, 936b are formed opposing with each other at the extension portions 932a,932b of the guide plate 932. When the one article 900A rotates at a predetermined rotational angle under the state that the guide plate 932 is disposed between the flange portion 912 and the stoppers 916a,916b of the first hinge portion 910, the protrusion 936a, 936b of the guide plate 932 operate in cooperation with the stoppers 916a,916b so as to stop the rotation of the one article 900A.

Through holes 938a,938b are provided with the flange portion 932 of the guide plate 930 at a position which is rotated at 90° with respect to the protrusion 936a, 936b of the extension portions 932a,932b.

The third member 950 comprises plate springs 952,954 on which rounded portions 952a,954a are formed at the center portions. The third member 950 is disposed at an inside of the cylindrical portion 934 of the guide plate 930.

When the guide plate 930 is engaged with the first hinge portion 910 under the state that the third member 950 is disposed at the guide plate 950, the rounded portions 952a,954a of the third member 950 is positioned in the guide grooves 914a,914b formed at the cylindrical portion 934 of the first hinge portion 910.

The total plan shape of the cover plate 940 is the same as that of the guide plate 930. Through holes 942a,942b are provided with the cover plate 940. The projections 936a,936b of the guide plate 930 pass through the through holes 942a,942b.

Also, through holes 944a,944b are provided with the cover plate 940. These through holes 942a,942b are coaxially with the through holes 938a,938b formed at the flange portion 932.

In the meantime, the hinge assembly 900 further comprises an annular bearing member 960. The bearing member 960 includes a cylindrical portion 962, an inner flange 964 inwardly extending from one opening of the cylindrical portion 962, and an outer flange 966 outwardly extending from one opening of the cylindrical portion 962.

The bearing member 960 is engaged with the first hinge portion 910 so that the cylindrical portion 962 encloses the cylindrical portion 914 of the first hinge portion 910 and the inner flange 964 covers one end of the cylindrical portion 914 of the first hinge portion 910 and the outer flange 966 covers one surface of the first hinge portion 910.

The bearing member 960 attenuates the friction between the first hinge portion 910 and the other article 900B.

The hinge assembly 900 according to the ninth embodiment of the present invention constituted, as the above, is assembled with the following steps.

First, the third member 950, that is, the plate springs 952,954 are disposed in the guide plate 930 of the second hinge portion. The plate springs 952,954 are positioned in the cylindrical portion 934 so that the rounded portions 952a,954a are inserted into the through holes 934a,934b formed at the cylindrical portion 934 of the guide plate 930.

Thereafter, the guide plate 930 is inserted into the first hinge portion 910. At this time, the cylindrical portion 934 of the guide plate 930 is inserted into the cylindrical portion 914 of the first hinge portion 910, the rounded portions 952a,954a inserted into the through holes 934a,934b formed at the cylindrical portion 934 of the guide plate 930 are positioned in the guide grooves 914a,914b formed at the cylindrical portion 934 of the hinge portion 910.

A predetermined gap is defined between the cylindrical portion 934 of the guide plate 930 and the cylindrical portion 914 of the first hinge portion 910.

Next, the cover plate 940 is tightly contacted with the guide plate 930 so that the projections 936a,936b formed at the extension portions 932a,932b of the guide plate 930 pass through the through holes 942a,942b.

A screw is inserted into the through holes 944a,944b,938a,938b formed at the flanges 942,932 of the cover plate 940 and the guide plate 930. Thereafter, it passes through the gap between the cylindrical portion 934 of the guide plate 930 and the cylindrical portion 914 of the first hinge 910. Finally, it is engaged in the through holes 900B′,900B″ of the other article 900B.

Accordingly, the cover plate 940 and the guide plate 930 are fixed to the other article 900B. In the meantime, the article 900A of which the first hinge portion 910 rotates centering on the guide plate 930 with respect to the other article 900B.

Referring to the attached drawings, a portable terminal 9000 having the hinge assembly 900 according to the ninth embodiment of the present invention will be described.

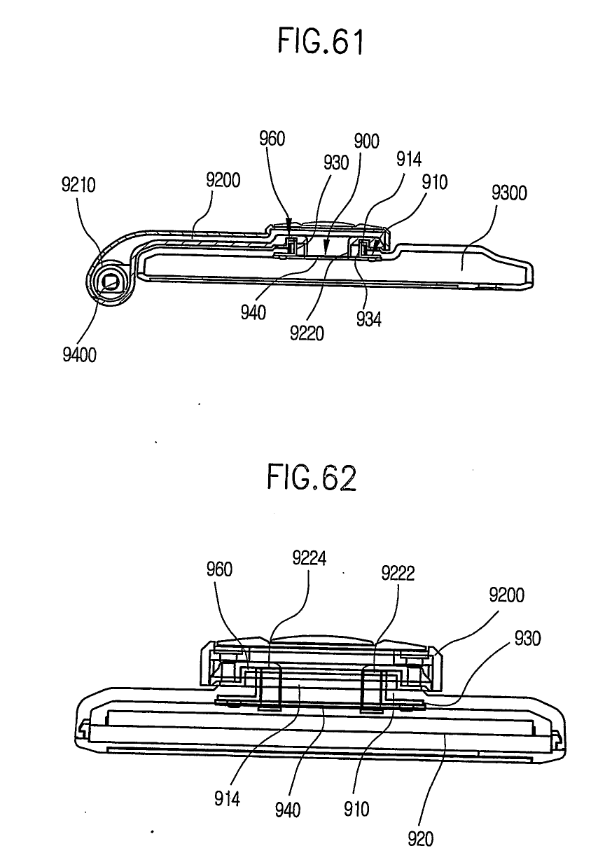

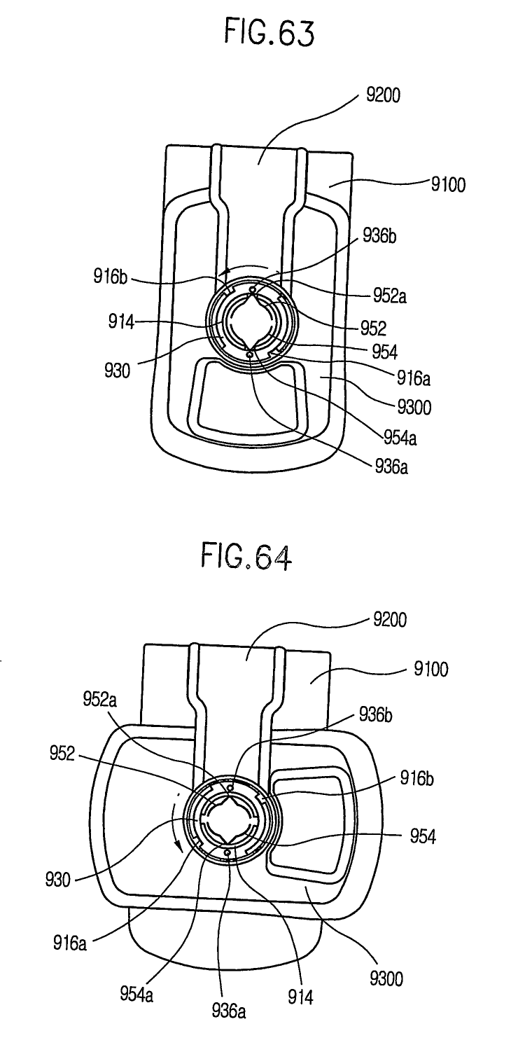

As shown in FIGS. 60 to 62, the portable terminal 9000 comprises: a main body 9100 mounted with a key pad (not illustrated), a mike phone (not illustrated) and a battery (not shown); a folder 9200 to support a display panel 9300 to be capable of horizontal rotating with respect to the main body 9100; a first hinge assembly 9400 to combine the folder 9200 with the main body 9100 to rotate the folder 9200 with respect to the main body 9100; and a second hinge assembly 900 to combine the display panel 9300 with the folder 9200 and to rotate the display panel 9300 horizontally with respect to the folder 9200.

A pair of posts are provided with the one side of the main body 9100 for the folder to be combined. For a driving cam shaft of the first hinge assembly 9400 mounted in the folder 9200 in order to be combined firmly, a engage groove is provided with one of the posts.

The folder 9200 has a mounting portion 921 for receiving the first hinge assembly 9400 in an end portion. And, a cylindrical portion 9220 is provided with one side of the folder 9200, to be inserted by a cylindrical portion 934 of a guide plate 930 of the second hinge assembly 900, i.e. hinge assembly according to the ninth embodiment of the present invention. Flange portion 9222, 9224, are provided with the peripheral surface of the cylindrical portion 9220, and screwing holes are provided with the flange portion 9222, 9224 for the flange portion 932 of the guide plate 930 to be fixed.

Meanwhile, the display panel 9300 is combined with the folder 9200 so that the display panel 9300 may rotate horizontally with regard to the folder 9200. A first hinge portion 910 is provided with a wall portion of the display panel 9300, and a cylindrical portion 934 of the guide plate 930 of the second hinge portion is inserted into the first hinge portion 910.

The guide plate 930 of the second hinge portion is fixed into the folder 9200, and is capable of rotating by the first hinge portion 910 formed in the display panel 9300.

For the first hinge assembly 9400, a can-type hinge or nude-type hinge is preferable.

The general structure of the first hinge assembly 9400 is similar to the structure of the second hinge used for the hinge assembly according to the forth or fifth embodiment of the present invention. Therefore, a specific description will be abbreviated.

However, the fundamental constituents for the first hinge assembly 9400 used for a portable terminal 9000 is simply explained.

As stated above, the first hinge assembly 9400 comprises:

a housing to be combined with a mounting portion formed in the one end of the folder 9200; a driving cam disposed in the housing, combined with body 9100 by the one end, and provided a cam with the other end; a driven cam engaged with the driving cam; and a coil spring, disposed between the driven cam and the a wall portion of the housing, to support elastically the driven cam.

Therefore, the folder 9200 is capable of rotating with regard to the main body 9100 by the first hinge assembly 9400.

The second hinge assembly 900 is the ninth embodiment according to the present invention. The first hinge portion 910 of the second hinge assembly 900 is provided with one side of the folder 9200. The second hinge portion 930 is combined elastically with the first hinge portion 910 by plate spring 952, 954 and supports the first hinge portion 910 to be capable of rotating. The second hinge portion 930 is fixed to the folder 9200.

Accordingly, the display panel 9300 having the first hinge portion 910 rotates with respect to the folder 9200 between the folder 9200 and the second hinge portion 930 for rotatably supporting the first hinge portion 910.

Hereinafter, an operation and effect of the hinge assembly 900 according to the ninth embodiment of the present invention and a portable terminal 9000 having the same will be described in detail with reference to the accompanying drawings.

In the closing of the folder 9200, when the folder 9200 is rotated around an axis of the first hinge assembly 9400, the floder 9200 is opened by means of the first hinge assembly 9400 at an angle of 180 degrees with relation to the body 9100.

In the opening of the folder 9200, the display pannel 9300 can be horizontally rotated with respect to the folder 9200 by applying outer force to the display pannel 9300.

When the display pannel 9300 is rotated, the first hinge portion 910 can be rotated around the cylindrical portion 934 of the guide plate 930 of the second hinge portion. As the first hinge 910 is rotated, the bending portions 952a and 954a of the leaf springs 952 and 954 which respectively are inserted in the guide grooves 914a and 914b of the cylindrical portion 914 of the first hinge portion 910, are pushed into the cylindrical portion 914 to come in close contact with an inner periphery of the cylindrical portion 914 in the state of being mounted on the guide plate 930.

When the display pannel 9300 is rotated, continuously, the bending portions 952a and 954a of the leaf springs 952 and 954 slidably moves along the inner periphery of the cylindrical portion 914 of the first hinge portion 910.

When the display pannel 9300 is rotated at an angle of 90 degrees, the stoppers 916a and 916b formed at the first hinge portion 910 come in contact with the projections 936a and 936b which are formed on the guide plate 930. Thus, the display pannel 9300 can stop its rotation by means of the stoppers 916a and 916b of the first hinge portion 910 and the projections 936a and 936b of the guide plate 930.

The display pannel 9300 is still held in stopped state unless the outer force is applied to the display pannel 9300.

When the folder 9200 is closed, meanwhile, the display pannel 9300 is horizontally rotated in a direction opposite to that of the outer force applying to the display pannel 9300 at opening thereof so that the display pannel 9300 is returned to an initial position. Then, the outer force is applied to the folder 920 in the direction opposite to that of opening the folder so as to close the folder 9200.

In the portable terminal having the hinge assembly 900 according to the ninth embodiment of the present invention as described above, there is an advantage in that not only the folder is rotated around the axis of the first hinge shaft in order to open and close the folder, but also the display pannel mounted on the folder can be horizontally rotated with respect to the folder.

### INDUSTRIAL APPLICABILITY

In the hinge assembly according to the embodiments of the present invention as described above, there is an advantage in that not only the folder is rotated around the axis of the first hinge shaft in order to open and close the folder, but also the display pannel mounted on the folder can be horizontally rotated with respect to the folder.

Furthermore, it is possible to rotate the folder with respect to the main body without applying a large force to the folder.

While the present invention has been particularly shown and described with reference to particular embodiments thereof, it will be understood by those skilled in the art that various changes in form and details may be effected therein without departing from the spirit and scope of the invention as defined by the appended claims.

1. A hinge assembly comprising:
a first means for horizontally rotating a second article with respect to a first article, the first means being coupled with an end of the first article;
a second means for horizontally rotating the first article with respect to the second article, the second means being coupled with an end of the second article and engaged with the first means; and
a third means providing the second means with an elastic force so that the first means is firmly engaged with the second means.

2. The hinge assembly as claimed in claim 1, further comprising a housing for receiving the second member and the third member, the housing being inserted into a side of the second article.

3. The hinge assembly as claimed in claim 2, wherein the first means includes a cylindrical hinge shaft, on the outer peripheral surface of which projections are formed opposing each other.

4. The hinge assembly as claimed in claim 3, wherein the second means includes a cylindrical cam, on the outer peripheral surface of which projections are formed longitudinally opposing each other.

5. The hinge assembly as claimed in claim 3, wherein the third means is a coil spring.

6. The hinge assembly as claimed in claim 5, wherein the housing includes a guide recess for receiving the projection of the cylindrical cam so that the cylindrical cam can be moved glidingly along an axis of the housing.

7. The hinge assembly as claimed in claim 6, wherein the cam and the coil spring are disposed on the outer peripheral surface of the cylindrical hinge shaft, and the cylindrical hinge shaft having the cam and the coil spring extends through the housing for the cam to be moved glidingly.

8. The hinge assembly as claimed in claim 7, an end of the cylindrical hinge shaft has an annular ring for supporting the coil spring and a snap ring for preventing the coil spring and the annular ring from deviating from the hinge shaft.

9. The hinge assembly as claimed in claim 2, wherein a stopper for limiting the rotation of the cylindrical hinge shaft is movably installed at an end of the housing.

10. The hinge shaft as claimed in claim 2, further comprising a rotation shaft extending through the first means, the second means, the third means and the housing, an end thereof being fixed with the first means to be rotated together with the first means.

11. The hinge assembly as claimed in claim 10, wherein the first means includes a cylindrical hinge shaft, on one end surface of which a driving cam is formed.

12. The hinge assembly as claimed in claim 11, wherein the second means includes an annular ring, on one surface of which a driven cam is formed, and on outer peripheral surface of which projections are formed opposing each other.

13. The hinge assembly as claimed in claim 12, the third means is a torsion spring.

14. The hinge assembly as claimed in claim 13, an inner peripheral surface of the housing has a guide recess for receiving the projection of the annular ring so that the annular ring can be moved glidingly.

15. The hinge assembly as claimed in claim 14, wherein the end of the rotation shaft extending through the first means, the second means, the third means and the housing includes a plurality of rings and snap rings for preventing the second means and the third means from deviating from the housing, the snap rings being fixed at the rotation shaft.

16. The hinge assembly as claimed in claim 11, wherein the cylindrical hinge shaft has a flange for coupling the hinge shaft with one article, on one side of which a stopper is provided to limit the rotation of the hinge shaft.

17. The hinge assembly as claimed in claim 16, wherein a flange is formed on an outer peripheral surface of one end of the housing to couple and fix the housing with the other article, and a step part is provided at an edge of the flange to guide the stopper of the hinge shaft.

18. The hinge assembly as claimed in claim 1, further comprising a housing for receiving the first means, the second means, and the third means, and having an open end and a close end with through holes, on an outer peripheral surface of the open end has a guide recess.

19. The hinge assembly as claimed in claim 18, wherein the first means includes a solid hinge shaft, which extends through the second means, the third means and the housing.

20. The hinge assembly as claimed in claim 19, wherein the hinge shaft includes a disc-shaped body, a flange formed on a circumferential surface of the body for fixing the hinge shaft to one article, a shaft part extending from one side of the body, and a driving cam formed on an outer peripheral surface of the shaft which contacts with the body.

21. The hinge assembly as claimed in claim 20, wherein the second means is a disc with a predetermined thickness, on one side of which a driven cam is provided, on the center of which a through hole is formed for the shaft part of the hinge shaft to extend through, and on an outer peripheral surface of which projections are formed opposing each other.

22. The hinge assembly as claimed in claim 21, wherein the third means includes a first coil spring, a second coil spring, and a third coil spring, all of which are disposed between the driven cam disc and the close end of the housing.

23. The hinge assembly as claimed in claim 22, wherein the first coil spring has a larger diameter than the second coil spring and the second coil spring has a larger diameter than the third coil spring.

24. The hinge assembly as claimed in claim 23, wherein on an inner peripheral surface of the housing, guide recesses for receiving the projections of the driven cam disc are formed opposing to each other so that the driven cam disc can be moved glidingly.

25. The hinge assembly as claimed in claim 24, wherein the open end of the housing has a groove at which a stopper is disposed to restrict the rotation of the hinge shaft.

26. The hinge assembly as claimed in claim 25, wherein at an end of the shaft part of the hinge shaft which extends through the through hole formed at the close end of the housing, a snap ring is provided to rotatably fix the hinge shaft to the housing.

27. A hinge assembly comprising:
a first means for supporting a second article, the first means being assembled with a first article to be horizontally rotated with respect to one side of the first article; and
a second means for rotating the second article with respect to the first article on an axis, which is vertical with respect to a rotating axis of the first means assembled with the first article, the second means being assembled with the second article to be rotated centering on the axis.

28. The hinge assembly as claimed in claim 27, wherein the first means includes a cylindrical rotating body, on an outer peripheral surface of which hollow projections are formed opposing each other, one of the projections being rotatably connected to the second means.

29. The hinge assembly as claimed in claim 28, wherein the second means includes a housing, a driving cam disposed inside of the housing and firmly assembled with the one projection of the rotating body, a driven cam disposed to face the driving cam inside of the housing, a plurality of balls provided between the driving cam and the driven cam for the driving cam to be rotated with respect to the driven cam, one or more coil spring for elastically supporting the driven cam in the housing, and a cover for preventing the above elements from deviating from the inside of the housing.

30. The hinge assembly as claimed in claim 29, wherein the pluralities of balls are fixed to the driven cam.

31. The hinge assembly as claimed in claim 30, wherein a cam surface of the driving cam has a hemisphere-shaped groove with a curvature corresponding to the spherical surface of the ball fixed to the driven cam.

32. The hinge assembly as claimed in claim 27, further comprising a coupling member coupled with the first hinge to connect the first article to the second article.

33. The hinge assembly as claimed in claim 32, wherein the first hinge includes a housing, a plurality of elastic members accommodated by the housing, a cam disc disposed inside of the housing to be moved glidingly inside of the housing, and a hinge shaft fixed to the first article and extending through the cam disc, the elastic member, and the housing, a driving cam being formed at the hinge shaft.

34. The hinge assembly as claimed in claim 33, wherein the coupling member is formed in the shape of a cylinder, one end of which is closed, and an outer peripheral surface thereof has projections opposing each other to be inserted into the second article to connect the first article with the second article.

35. The hinge assembly as claimed in claim 34, wherein the coupling member is coupled with the housing of the first hinge by means of a screw.

36. The hinge assembly as claimed in 35, wherein the elastic member of the first hinge includes a first coil spring, a second coil spring, and a third coil spring.

37. The hinge assembly as claimed in claim 36, wherein the second coil spring has a diameter smaller than the first coil spring and larger than the third coil spring.

38. The hinge assembly as claimed in claim 27, wherein the second means includes a second hinge, and the second hinge includes a housing assembled to the second article, a driving cam disposed inside of the housing and having one end firmly fixed to one of the projections of the coupling member and the other end with a cam, a driven cam disposed inside of the housing and engaged with the driving cam, and one or more elastic member disposed between the driven cam and one wall of the housing in the housing and supporting the driven cam elastically.

39. A hinge assembly comprising:
a first means for horizontally rotating a second article with respect to a first article, the first means being fixed to the first article;
a coupling member for supporting the second article, the coupling member being coupled with the first means to be connected with the second article; and
a second means for rotating the second article with respect to the first article centering on a longitudinal axis of the coupling member, the second means being disposed in the coupling member.

40. The hinge assembly as claimed in claim 39, wherein the first means includes a housing fixed to the one article, a driven cam disposed inside of the housing to be moved glidingly, a driving cam disposed inside of the housing and engaged with the driven cam, an elastic member disposed between a close end of the housing and the driven cam and supporting the driven cam elastically, and a hinge shaft one end of which is fixed to the coupling member and the other end of which extends through the driving cam, the driven cam, the elastic member and the close end of the housing.

41. The hinge assembly as claimed in claim 40, wherein the second means includes a housing inserted into the coupling member, a driving cam disposed inside of the housing and perforating through one wall of the housing to be connected to the second article, a driven cam engaged with the driving cam in the housing, and an elastic member disposed between the driven cam and the other wall of the housing to elastically support the driven cam.

42. The hinge assembly as claimed in claim 41, the elastic member of the first means and the second means includes a coil spring, and the second means includes a plurality of coil springs.

43. The hinge assembly as claimed in claim 42, wherein the coupling member accommodates a part of the housing for part of the housing of the first means to be located inside thereof and is rotatable on an axis of the hinge shaft of the first means.

44. The hinge assembly as claimed in claim 40, wherein an outer peripheral surface of the driven cam of the first means has projections longitudinally formed opposing each other.

45. The hinge assembly as claimed in claim 44, wherein an inner peripheral surface of the housing of the first means has guide recesses opposing each other to receive the projections of the driven cam so that the projections can be moved longitudinally.

46. The hinge assembly as claimed in claim 45, wherein the hinge shaft of the first means has a combining projection, which is firmly combined with the driving cam to prevent the driving cam from being rotated on the hinge shaft.

47. A hinge assembly comprising:
a first means for horizontally rotating a second article with respect to a first article, the first means being fixed to the first article; and
a second means being fixed at the second article and coupled with the first means to be rotated together with the second article due to a rotational force of the first means.

48. The hinge assembly as claimed in claim 47, wherein the first means is a geared motor having a reduction gear therein.

49. The hinge assembly as claimed in claim 48, wherein an upper surface of the geared motor has a projection disposed adjacent to a rotating axis of the motor.

50. The hinge assembly as claimed in claim 49, wherein the second means is forcibly engaged with the rotating axis of the geared motor and one surface thereof meeting the upper surface of the motor has an arc-shaped groove with a predetermined curvature.

51. The hinge assembly as claimed in claim 50, wherein a stopper is slideably installed in the arc-shaped groove of the second means.

52. The hinge assembly as claimed in claim 1, wherein the first means includes a disc-shaped body and a driving cam including a cylinder-shaped shaft vertically extended from one side of the body.

53. The hinge assembly as claimed in claim 52, wherein the second means includes a disc-shaped driven cam that is provided at the cylinder-shaped shaft of the driving cam to face the disc-shaped body of the driving cam.

54. The hinge assembly as claimed in claim 53, further comprising a plurality of balls disposed between the driving cam and the driven cam to push the driven cam away from the driving cam.

55. The hinge assembly as claimed in claim 54, further comprising pluralities of elastic members for elastically supporting the driven cam against the other article.

56. The hinge assembly as claimed in claim 55, wherein the pluralities of elastic members comprise disc springs.

57. The hinge assembly as claimed in claim 56, further comprising a combining fixture extending through the elastic members and the driven cam and then it threadly engaged with the cylindrical shaft of the driving cam.

58. The hinge assembly as claimed in claim 53, wherein a stopper for restraining the rotation of the driven cam is formed at one end adjacent to the cylindrical shaft contacted with the body of the driving cam.

59. The hinge assembly as claimed in claim 53, wherein the cylindrical hinge shaft is slideably disposed in a circular groove of the driving cam on one surface of the driven cam contacting with the main body of the driving cam, in which the movement of the hinge shaft is limited by the stopper during rotation thereof at a predetermined rotational angle.

60. A hinge assembly comprising:
a first means for rotating one article against the other article, the first means being formed at one wall of the one article;
a second means for rotatably supporting the one article against the other article by engaging with the first means, the second means being fixed to the other article; and
a third means for elastically supporting the first means so at to restrain the rotation of the first means, the third means being mounted to the second means.

61. The hinge assembly as claimed in claim 60, wherein the first means comprises an annular flange laterally protruding from one wall of the one article, a cylindrical part extending from the flange and of which a guide groove for receiving a rounded portion of the elastic member is formed, and a stopper formed at the one wall of the one article and spaced from the flange at a predetermined distance.

62. The hinge assembly as claimed in claim 61, wherein the second means comprises a guide plate for supporting the one article being disposed between the flange and the stopper so that it is contacted with one surface of the flange, and a cover plate being contacted with one surface of the guide plate and being fixed to the other article together with the guide plate.

63. The hinge assembly as claimed in claim 62, wherein the guide plate includes flange portions and a cylindrical portion extending from the flange portions, in which a part of the flange portions have an opposing extending portion, a through hole for partially receiving the third means is formed at a position at which the flange portion having the cylindrical portion and the extending portion is contacted.

64. The hinge assembly as claimed in claim 63, wherein the third means comprises a plate spring of which a rounded portion is formed at the center thereof, the third means disposed in the cylindrical portion of the guide plate so that the rounded portion is inserted into the through hole formed at the position at which the flange portion having the cylindrical portion and the extending portion is contacted.

65. The hinge assembly as claimed in claim 64, wherein the rounded portion of the plate spring is received in the guide groove formed at the cylindrical portion of the first means, when the other article is rotated against the one article, the rounded portion of the plate spring is released from the guide groove and then it pressed against an inner peripheral surface of the cylindrical portion of the first means.

66. The hinge assembly as claimed in claim 65, wherein the guide plate and the cover are fixed to the other article by passing the screw through the guide plate and the cover and continuously passing it through the cylindrical portion of the first means.

67. The hinge assembly as claimed in claim 66, wherein a bearing means for smoothly rotating the one article is disposed between the first means and the other article.

68. The hinge assembly as claimed in claim 67, wherein a screw is engaged with the guide plate and the flange of the cover, when the one article rotates, the screw is contacted with the stopper of the first means so as to restrain the rotation of the one article.

69. A portable terminal comprising:
a main body mounted with a key pad, a mike phone and a battery;
a folder mounted to be rotatable with respect to the main body horizontally and vertically and having a speaker phone and a display panel; and
a hinge assembly to rotate the folder with respect to the main body horizontally and vertically, the hinge assembly.

70. The portable terminal as claimed in claim 69, wherein the hinge assembly includes a first means for horizontally rotating a folder against a main body, the first means being engaged with a one side of the folder; a second means for rotatably supporting the folder against the main body by engaging with the first means, the second means being engaged with a one side of the main body; and a third means for providing the second means with an elastic force so that the first means is firmly engaged with the second means.

71. The portable terminal as claimed in claim 70, further comprising a housing for receiving the first and the third means, the housing being inserted into the one side of the main body.

72. The portable terminal as claimed in claim 71, wherein the first means includes a cylindrical hinge shaft of which projections are formed at an outer peripheral surface of the hinge shaft with opposing with each other.

73. The portable terminal as claimed in claim 72, wherein the second means includes a cylindrical cam of which projections are formed at an outer peripheral surface of the cylindrical cam with opposing with each other in the longitudinal direction.

74. The portable terminal as claimed in claim 73, wherein the third means comprises a coil spring.

75. The portable terminal as claimed in claim 74, wherein guide grooves for receiving the cylindrical projections are formed at an inner peripheral surface of the housing so that the cylindrical projections can slideably move along the axis line of the housing.

76. The portable terminal as claimed in claim 75, wherein the cam and the coil spring are disposed at the outer peripheral surface of the cylindrical hinge shaft, in which the cylindrical hinge shaft having the cam and the coil spring passes through the housing so that the cam is slideably disposed therein.

77. The portable terminal as claimed in claim 76, wherein an annular ring for supporting the coil spring and a snap ring for preventing the coil spring and the annular ring from deviating from the hinge shaft are mounted to a end of the cylindrical hinge shaft.

78. The portable terminal as claimed in claim 71, wherein a stopper for restraining the rotation of the cylindrical hinge shaft is moveably installed at one end of the housing.

79. The portable terminal as claimed in claim 71, further comprising a rotation shaft passes through the first, the second and the third means and the housing, of which one end is fixed to the first means so that it rotates together with the first means.

80. The portable terminal as claimed in claim 79, wherein the fist means comprises a cylindrical hinge shaft of which a driving cam is formed at one end surface thereof.

81. The portable terminal as claimed in claim 80, wherein the second means comprises an annular ring, in which a driven cam is formed at one surface of the annular ring, and projections are formed opposing with each other at an outer peripheral surface of the driven cam.

82. The portable terminal as claimed in claim 81, wherein the third means comprises a torsion spring.

83. The portable terminal as claimed in claim 82, wherein guide grooves for receiving the projections of the annular ring are formed at an inner peripheral surface of the housing so that the annular ring can slide in the guide grooves.

84. The portable terminal as claimed in claim 83, further comprising pluralities rings and a snap ring for preventing the second and the third means from being deviating from the housing are mounted to a end of the cylindrical hinge shaft passing through the first, the second and the third means and the housing, in which the snap ring is mounted and fixed to the rotation shaft.

85. The portable terminal as claimed in claim 80, wherein a flange for combining the hinge shaft to one article is formed at the cylindrical hinge shaft, and a stopper for restraining the rotation of the cylindrical hinge shaft is formed at one surface of the flange.

86. The portable terminal as claimed in claim 85, wherein a flange for combining the housing to the other article is formed at an outer peripheral surface of one end of the housing, and a staged portion for guiding the stopper of the hinge shaft is formed at an outer peripheral surface of the flange.

87. The portable terminal as claimed in claim 70, further comprising a housing for receiving the first, the second and the third means, the housing including an open end and a close end, in which a guide groove is formed at an outer peripheral surface of the open end and a through hole is formed through the close end.

88. The portable terminal as claimed in claim 87, wherein the first means includes a hinge shaft having an actual axis, in which the hinge shaft passes through the second and the third means and the housing.

89. The portable terminal as claimed in claim 88, wherein the hinge shaft includes a circular body, a flange portion for fixing on article being formed at the circular body, and a driving cam being formed at an outer peripheral surface of the shaft portion that is contacted with the circular body.

90. The portable terminal as claimed in claim 89, wherein the second means comprises a disc having a predetermined thickness, in which a driven cam is formed at a one surface of the disc, a through hole is formed at the center of the disc and projections are formed opposing with each other at the outer peripheral surface of the disc.

91. The portable terminal as claimed in claim 90, wherein the third means includes a first coil spring, a second coil spring and a third coil spring, in which the first coil spring, the second coil spring and the third coil spring are disposed between the driven cam disc and the close end of the housing.

92. The portable terminal as claimed in claim 91, wherein the diameter of the first coil spring is greater than that of the second coil spring, and the diameter of the second coil spring is greater than that of the third coil spring.

93. The portable terminal as claimed in claim 92, wherein guide grooves for receiving the projections of the driven cam are formed opposing with each other at an inner peripheral surface of the housing so that the driven cam can slideably move along the housing.

94. The portable terminal as claimed in claim 93, wherein a groove is formed at a open end of the housing, a stopper for restraining the rotation of the hinge shaft is disposed in the groove.

95. The portable terminal as claimed in claim 94, wherein a snap ring for rotatably fixing the hinge shaft to the housing is mounted to a distal end of the shaft portion of the hinge shaft passing through the through hole formed the close end of the housing.

96. A portable terminal comprising:
a main body mounted with a key pad, a mike phone and a battery;
a folder mounted to be rotatable with respect to the main body horizontally and vertically and having a speaker phone and a display panel; and
a hinge assembly to rotate the folder with respect to the body horizontally and vertically, the hinge assembly.

97. The portable terminal as claimed in claim 96, wherein the hinge assembly includes a first means for supporting a folder, the first means being mounted to the main body so that it can rotate against one surface of the main body in the horizontal direction; and a second means for rotating the folder against the main body with centering on an axial line that is perpendicular to a rotational axis of the first means mounted to the main body, the second means being mounted to the folder so that it can rotate with centering on the axial line that is perpendicular to the rotational axis of the first means.

98. The portable terminal as claimed in claim 97, wherein the first means includes a cylindrical rotation body of which hollow projections are formed opposite with each other at an outer peripheral surface of the rotation body, in which the second means is rotatably coupled to one projection among the projections.

99. The portable terminal as claimed in claim 98, wherein the second means comprises a housing, a driving cam arranged inside of the housing, which its one end is firmly coupled with the hollow projection of the body, a driven cam, which is arranged inside of the housing, and engaged with the driving cam, pluralities balls disposed between the driving cam and the driven cam so as to make the driving cam to rotate against the driven cam, at least coil springs for elastically supporting the driven cam within the housing, and a cover for preventing the above elements from being obviated from the housing.

100. The portable terminal as claimed in claim 99, wherein the pluralities balls are fixedly and attached to the driven cam.

101. The portable terminal as claimed in claim 100, wherein a semi-sphere shaped groove having a radius of curvature that is corresponding to a rounded surface of the balls attached to the driven cam.

102. The portable terminal as claimed in claim 97, wherein the hinge assembly further comprises a coupling member for coupling the main body with the folder by engaging with the first hinge.

103. The portable terminal as claimed in claim 102, wherein the first hinge comprises a housing, a plurality of elastic members stored in the housing, a cam disc arranged in the housing to be capable of moving sliding inside of the housing, and a hinge shaft fixed said one article, extended penetrating the cam disc, the elastic members and the housing, and having the driving cam.

104. The portable terminal as claimed in claim 103, wherein the coupling member has a cylindrical shape of which one end is closed, in which projections for coupling the main body with the folder by being inserted into the folder are formed at an outer peripheral surface of the coupling member.

105. The portable terminal as claimed in claim 104, wherein the coupling member is engaged with the housing of the first hinge by means of the screw.

106. The portable terminal as claimed in claim 105, wherein the elastic member of the fist hinge includes a first coil spring, a second coil spring and a third coil spring.

107. The portable terminal as claimed in claim 106, wherein the diameter of the second coil spring is smaller than that of the fist coil spring and the diameter of the second coil spring is greater than that of the third coil spring.

108. The portable terminal as claimed in claim 104, wherein the second means comprises a second hinge, in which the second hinge includes a housing, which is mounted to the folder, a driving cam, which is arranged inside of the housing, which its one end is firmly coupled with one of the projections of the coupling member and it's the other end is provided with a cam, a driven cam, which is arranged inside of the housing and engaged with the driving cam, and at least one elastic members for elastically supporting the driven cam within the housing, the elastic members being disposed between the driving cam and one wall of the housing.

109. The portable terminal as claimed in claim 96, wherein the hinge assembly includes a first means for supporting a folder, the first means being mounted to the main body so that it can rotate against one surface of the main body in the horizontal direction;
a coupling member for supporting the folder, the coupling member being coupled to the folder; and
a second means for rotating the folder against the main body with centering on an axial line of the coupling member, the second means being disposed in the coupling member.

110. The portable terminal as claimed in claim 109, wherein the first means includes a housing fixed to one article, a driven cam slideably disposed in the housing, a driving cam disposed inside of the housing and being engaged with the driven cam, an elastic member disposed between the driven cam and the other wall of the housing to elastically support the driven cam, and a hinge shaft of which one end is fixed to the coupling member and the other end passes through the driving cam, the driven cam, the elastic member and the close end.

111. The portable terminal as claimed in claim 110, wherein the second means includes a housing inserted into the coupling member, a driving cam disposed inside of the housing and perforating through one wall of the housing to be connected to the other article, a driven cam engaged with the driving cam in the housing, and an elastic member disposed between the driven cam and the other wall of the housing to elastically support the driven cam.

112. The portable terminal as claimed in claim 111, wherein the first and the second means include a coil spring, in which the second means comprises pluralities coil springs.

113. The portable terminal as claimed in claim 112, wherein the coupling member receives a part of the housing of the first means so that the part of the housing is positioned in the housing and it rotates with the axis of the hinge shaft of the first means.

114. The portable terminal as claimed in claim 110, wherein projections are formed opposing with each other at an outer peripheral surface of the driving cam of the first means in the longitudinal direction.

115. The portable terminal as claimed in claim 114, wherein guide grooves for receiving the projections are formed at an inner peripheral surface of the first means so that the projections of the driven cam can slideably move in the longitudinal direction of the housing.

116. The portable terminal as claimed in claim 115, wherein a combining projection for preventing the driving cam from being rotated on the hinge shaft by firmly engaged with the driving cam is formed at the hinge shaft of the first means.

117. The portable terminal as claimed in claim 69, wherein the hinge assembly comprises a first means for rotating the folder against the main body, the first means being mounted to the main body; a second means rotating together the folder due to the rotational force of the first means by engaging with the first means, the second means being mounted to the folder.

118. The portable terminal as claimed in claim 117, wherein the first means comprises a geared motor having a reduction gear therein.

119. The portable terminal as claimed in claim 118, wherein a projection is formed at a position adjacent to a rotational shaft of the motor on an upper surface of the geared motor.

120. The portable terminal as claimed in claim 129, wherein the second means is forcibly fitted into the rotational shaft of the geared motor, in which an arc-shaped groove having a predetermined radius of curvature on one surface at which the upper surface of the motor is contacted.

121. The portable terminal as claimed in claim 120, wherein a stopper is slidealby mounted in the arc-shaped groove of the second means.

122. A portable terminal comprising:
a main body mounted with a key pad, a mike phone and a battery;
a folder for horizontally rotatably supporting a display panel, the folder being rotatably mounted to the main body;
a first hinge assembly to rotate the folder with respect to the main body; and
a second hinge assembly for coupling the display panel to the folder, and for horizontally rotatably supporting the display panel with respect to the folder.

123. The portable terminal as claimed in claim 122, wherein the hinge assembly includes a housing mounted to the folder, a driving cam disposed inside of the housing and having one end firmly fixed to the main body and the other end with a cam, a driven cam disposed inside of the housing and engaged with the driving cam, and one or more elastic member disposed between the driven cam and one wall of the housing in the housing and supporting the driven cam elastically.

124. The portable terminal as claimed in claim 123, wherein the elastic member comprises a coil spring.

125. The portable terminal as claimed in claim 122, wherein the second hinge assembly includes a first means for horizontally rotating a display panel against a folder, the first means being engaged with a one side of the folder; a second means for rotatably supporting the display panel against the folder by engaging with the first means, the second means being engaged with the display panel; and a third means for providing the second means with an elastic force so that the first means is firmly engaged with the second means.

126. The portable terminal as claimed in claim 125, wherein the first means includes the driving cam having a circular plate shaped body and a cylindrical shaft vertically extending from one surface of the body.

127. The portable terminal as claimed in claim 126, wherein the second means includes a circular plate shape driven cam and a fixing shaft fixedly coupled to the display panel, in which the fixing shaft passes through the driven cam and is threadly engaged with the cylindrical shaft of the driving cam, and the driven cam is mounted to the with the cylindrical shaft of the driving cam so that it is opposing to the circular plate shape body of the driving cam.

128. The portable terminal as claimed in claim 127, further comprising pluralities balls for pushing the driven cam to a distance with the respect to the driving cam, the pluralities balls being disposed between the driving cam and the driven cam.

129. The portable terminal as claimed in claim 128, further comprising pluralities elastic members for elastically the driven cam with respect to the display panel.

130. The portable terminal as claimed in claim 129, wherein the pluralities elastic members comprise disc spring.

131. The portable terminal as claimed in claim 127, wherein a stopper for restraining the rotation of the driven cam is formed at one end adjacent to the cylindrical shaft contacted with the body of the driving cam.

132. The portable terminal as claimed in claim 131, wherein a guide groove for receiving the stopper is formed at one surface of the driven cam so that the stopper formed at the cylindrical shaft of the driving cam can slideably move along the guide groove.

133. The portable terminal as claimed in claim 123, wherein the second hinge assembly comprises a first means for rotating the display panel with respect to the folder, the fist means being formed at one wall of the display panel; a second means for rotating the display panel with respect to the folder by engaging with the first means; and a third means for elastically supporting the first means so as to restrain the rotation of the first means, the third means being mounted to the second means.

134. The portable terminal as claimed in claim 133, wherein the first means comprises an annular flange laterally protruding from one wall of the display panel, a cylindrical part extending from the flange and of which a guide groove for receiving a part of the third means is formed, and a stopper formed at the one wall of the one article and spaced from the flange at a predetermined distance.

135. The portable terminal as claimed in claim 134, wherein the second means comprises a guide plate for supporting the display panel being disposed between the flange and the stopper so that it is contacted with one surface of the flange, and a cover plate being contacted with one surface of the guide plate and being fixed to the other article together with the guide plate.

136. The portable terminal as claimed in claim 135, wherein the guide plate the guide plate includes flange portions and a cylindrical portion extending from the flange portions, in which a part of the flange portions have an opposing extending portion, a through hole for partially receiving the third means is formed at a position at which the flange portion having the cylindrical portion and the extending portion is contacted.

137. The portable terminal as claimed in claim 136, wherein the third means comprises a semicircular plate spring of which a rounded portion is formed at the center thereof, the third means disposed in the cylindrical portion of the guide plate so that the rounded portion is inserted into the through hole formed at the position at which the flange portion having the cylindrical portion and the extending portion is contacted

138. The portable terminal as claimed in claim 137, wherein the rounded portion of the plate spring is received in the guide groove formed at the cylindrical portion of the first means, when the folder is rotated against the display panel, the rounded portion of the plate spring is released from the guide groove and then it pressed against an inner peripheral surface of the cylindrical portion of the first means.

139. The portable terminal as claimed in claim 138, wherein the guide plate and the cover are fixed to the folder by passing the screw through the guide plate and the cover and continuously passing it through the cylindrical portion of the first means.

140. The portable terminal as claimed in claim 139, wherein a bearing member for smoothly rotating the display panel is disposed between the flange portion of the first means and the folder.

141. The portable terminal as claimed in claim 140, wherein a screw is engaged with the guide plate and the flange of the cover, when the one article rotates, the screw is contacted with the stopper of the first means so as to restrain the rotation of the one article.
